(19) United States
(12) Patent Application Publication
(10) Pub. No.: US 2022/0055721 A1
(43) Pub. Date: Feb. 24, 2022

(54) BIOFOULING PROTECTIVE ENCLOSURES

(71) Applicant: BioFouling Technologies, Inc., Aberdeen, NC (US)

(72) Inventors: Brian McMurray, Aberdeen, NC (US); Abe Stephens, Melbourne, FL (US); Emily Ralston, Melbourne, FL (US); Mike Termini, Palm Beach, FL (US); Cliff Sharpe, Aberdeen, NC (US); Lindsey Calcutt, Aberdeen, NC (US)

(21) Appl. No.: 17/472,456

(22) Filed: Sep. 10, 2021

Related U.S. Application Data
(63) Continuation of application No. PCT/US20/22782, filed on Mar. 13, 2020.
Application No. PCT/US20/22782 is a continuation-in-part of application No. PCT/US19/59546, filed on Nov. 1, 2019.
(60) Provisional application No. 62/817,873, filed on Mar. 13, 2019.

(51) Int. Cl. B63B 59/04; B08B 17/04

(52) U.S. Cl. CPC B63B 59/04; B08B 17/04

(57) ABSTRACT

Disclosed are devices, methods and/or systems for use in protecting items and/or structures that are exposed to, submerged and/or partially submerged in aquatic environments from contamination and/or fouling due to the incursion and/or colonization by specific types and/or kinds of biologic organisms and/or plants, including the protection from micro- and/or macro-fouling for extended periods of time of exposure to aquatic environments.

### CROSS-REFERENCE TO RELATED APPLICATIONS

This application is a continuation of Patent Cooperation Treaty (PCT) Patent Application No. PCT/US2020/022782 filed Mar. 13, 2020, titled “BIOFOULING PROTECTION,” which claims priority to and benefit thereof from U.S. Provisional Patent Application No. 62/817,873 filed Mar. 13, 2019, titled “BIOFOULING PROTECTIVE ENCLOSURES,” and Patent Cooperation Treaty (PCT) Patent Application No. PCT/US19/59546, filed Nov. 1, 2019 and entitled “DURABLE BIOFOULING PROTECTION,” the disclosures of which are each incorporated by reference herein in their entireties.

### TECHNICAL FIELD

The invention relates to improved devices, systems and methods for use in protecting items and/or structures that are exposed to, submerged in and/or partially submerged in aquatic environments from contamination and/or fouling due to the incursion and/or colonization by specific types and/or kinds of biologic organisms. More specifically, disclosed are improved methods, apparatus and/or systems for protecting structures and/or substrates from micro- and/or macro-fouling for extended periods of time of exposure to aquatic environments.

### BACKGROUND OF THE INVENTION

The growth and attachment of various marine organisms on structures in aquatic environments, known as biofouling, is a significant problem for numerous industries, including both the recreational and industrial boating and shipping industries, the oil and gas industry, power plants, water treatment plants, water management and control, irrigation industries, manufacturing, scientific research, the military (including the Corps of Engineers), and the fishing industry. Most surfaces, such as those associated with boat hulls, underwater cables, chains and pilings, oil rig platforms, buoys, containment boom systems, fishing nets, piers and docks which are exposed to coastal, harbor or ocean waters (as well as their fresh water counterparts) eventually become colonized by animal species, such as barnacles, mussels (as well as oysters and other bivalves), bryozoans, hydroids, tubeworms, sea squirts and/or other tunicates, and various plant species. Biofouling results from the interaction between various plant and/or animal species with aspects of the substrates to which they ultimately attach, leading to the formation of adhesives that firmly bond the biofouling organisms to substrates leading to biofouling. Despite the appearance of simplicity, the process of biofouling is a highly complex web of interactions effected by a myriad of micro-organisms, macro-organisms and the ever-changing characteristics of the aquatic environment.

The economic impacts of biofouling are of paramount concern for many industries. Large amounts of biofouling on ships can result in corrosion of various surfaces exposed to the aquatic environment, greatly reducing efficacy of the operation of the vessel, and often eventual deterioration of portions of the ship. Micro and macro organism build-up also causes increases in roughness of the ship's surface such that the ship experiences greater frictional resistance, decreased speed and maneuverability, and increased drag, resulting in increased fuel consumption. These increased costs are experienced by commercial and recreational boaters alike, as barnacles and other animals attach to propellers, drive system components, inlets and/or hull components submerged in water.

Another significant economic consequence of biofouling is the formation of biofouling and/or fouling induced scales on heat exchange surfaces and/or other wetted surfaces in many industrial facilities. For example, large scale cooling water systems are used in a wide variety of industrial processes, and at their most basic these systems rely on heat transfer from a hotter fluid or gas to a colder fluid or gas, with this heat typically travelling through a “heat transfer surface,” which is often the metallic walls of heat transfer tubing which separate the hot and cold substances. Often, the cooling fluid will comprise water, which in many cases may be salt water drawn from a bay, sea and/or the ocean, fresh water drawn from a river, lake or well/aquifer or wastewater from various sources. Water is a favorable environment for many life forms, and these fouling organisms will often colonize the wetted surfaces of heat transfer tubing, which can significantly reduce heat transfer rates of the cooling system. In many cases, even thin biofilms formed on a heat transfer surface will significantly insulate this surface, reducing its heat transfer efficiency and greatly increasing the overall operating costs for the cooling system.

Aside from increasing corrosion and other damage to structures, the weight and distribution of macro-fouling on objects can also dramatically alter the buoyancy or stresses and strains experienced by the object and/or support structures, which can lead to premature failure and/or sinking of the fouled objects. For example, navigational buoys, containment booms or pier posts containing surfaces with large amounts of biofouling are subjected to increased stress loads resulting from increased weight—and can even founder or sink under excessive amounts of macrofouling. This increased stress often results in decreasing the useful life of the structures and necessitating continuous cleaning and/or replacement. Similarly, submerged sensors (including tethered and/or free-floating sensors) will often fail and/or malfunction relatively quickly (often in less than 30 days) due to incursion of and/or colonization by marine organisms.

Biofouling also creates substantial ecological problems by distributing plant and animal species to non-native environments as they “ride along” on the fouled object, and significant legislative and financial resources are allocated to combat the commercial and ecological impacts of biofouling.

Various methods have been used in attempts to halt and/or reduce biofouling build-up. One of the more common methods, particularly in the boating and shipping industry, is biofouling removal by scraping. However, scraping is labor intensive and can damage fouled surfaces, and environmental issues have been raised over the concerns that scraping results in the increased spread of invasive species, along with negative environmental effects on local fauna. Therefore, there exists a need for devices that eliminate or reduce the amount of biofouling on surfaces exposed to an aquatic environment.

One strategy for protecting objects in contact with water and preventing aquatic biofouling includes the use of physical coverings. These coverings desirably act as protective devices by shielding or separating the structures from the water. For example, U.S. Pat. No. 3,220,374 discloses a marine protective device. The invention is directed towards a unique means and method of protecting marine equipment from the corrosive action of the water and/or marine growth when the boat is not in use.

U.S. Pat. No. 3,587,508 discloses an outdrive protective apparatus for easy attachment to a boat. The apparatus protects the outdrive of an inboard-outboard motor from marine growth when the boat is not in use. A bag is placed around the outdrive unit for easy attachment to the transom of a boat in a manner which provides a watertight seal between the bag and the transom and around the outdrive unit.

U.S. Pat. No. 4,998,496 discloses a shroud for a marine propulsion system which includes a waterproof shroud body that can be fastened to the transom of a boat to surround the outboard portion of the propulsion system. Locking and sealing mechanisms secure the shroud to the boat transom in water-tight engagement and a submersible pump is operable to remove water from the shroud body so that the propulsion system is effectively in “dry dock” when not in use.

U.S. Pat. No. 5,072,683 discloses a drainable protective boat motor bag apparatus including a boot defining a bag for fitting over the propeller and stem of an outdrive of a motor mounted on the stern of a boat. The bag includes a channel extending from the mouth to the closed end of the bag for receipt of an open-ended hose such that, once the bag has been positioned over the stem, a hose may be inserted for pumping of residue from such bag. A tie string may be incorporated around the mouth of the bag for tying it to the stem and, if desirable, a separate protective sack may be included for covering the propeller blades to protect them from direct exposure to the bag itself.

U.S. Pat. No. 5,315,949 discloses an apparatus for protectively covering a motor prop of a boat. The cover includes an adjustable collar, a flexible, opaque bag, and an adjustable collar draw line. The bag has an open top end attached to the collar. A closed bottom end of the bag is opposed to the top end, and has a weight attached thereto. The adjustable collar draw line of the collar is such that with the bag placed over the outcropping, the open end of the bag may be closed around the outcropping by pulling the adjustable collar draw line. The collar includes a locking slot for locking the adjustable collar draw line in place around the outcropping. A manipulation handle removably attaches to the collar for facilitating the placement and removal of the cover onto and off of the outcropping. With the cover in place over the outcropping, water and light are desirably prevented from entering the interior of the bag, whereby water borne life forms such as filter feeding creatures and plant life desirably cannot thrive within the cover.

U.S. Pat. No. 6,152,064 discloses a protective propeller cover. The cover includes a flexible sleeve into which buoyant material is placed to provide a buoyant enclosure. A flexible propeller cover portion is secured to the flexible sleeve, and the end of the cover is releasably secured about the propeller. The buoyant enclosure is positioned adjacent to the propeller and extends above the water line when the propeller is positioned beneath the water line. The buoyant enclosure also serves to protect swimmers from direct contact with the propeller when swimming in proximity to the boat. The protective propeller cover apparatus further serves to protect the propeller during transport or storage. The protective propeller cover apparatus further serves as an anchor cover when the boat is underway. The protective propeller cover apparatus further serves as an emergency flotation device.

U.S. Pat. No. 6,609,938 discloses a propeller protector slipper which is used on inboard and outboard motors of boats that are anchored, drifting, aground, docked, in storage, or out of water in transit. The propeller protector slipper ensures protection for the propeller from elements that cause pitting and damage to the propeller, as well as minimizing propeller related injuries. The protector propeller slipper also provides a gage for projecting the distance of the propeller of a trailered boat from a following vehicle.

U.S. Publication No. 2008/0020657 discloses an apparatus for protecting the out-drive of a watercraft. The apparatus comprises a locating member adapted for attachment to the underside of the marlin board of the watercraft and a shroud engageable with the locating member to provide an enclosure about the outdrive. The shroud is buoyant and can be floated into sliding engagement with the locating member. The shroud has an opening which is closed upon engagement of the shroud with the transom of the watercraft to desirably prevent ingress of water into the interior of the shroud. A connection means and the locking means are provided for releasably connecting the shroud to the locating member.

In addition to the use of physical coverings as illustrated above, other strategies have been employed in efforts to reduce biofouling. U.S. Publication No. 2009/0185867 discloses a system and method for reducing vortex-induced vibration and drag about a marine element. The system includes, but is not limited to, a shell rotatably mounted about the marine element, the shell having opposing edges defining a longitudinal gap configured to allow the shell to snap around at least a portion of the marine element. A fin can be positioned along each opposing edge of the longitudinal gap, wherein each fin can extend outwardly from the shell. The fins can be positioned on the shell so as to desirably reduce vortex-induced vibration and minimize drag on the marine element. One or more antifouling agents can be disposed on, in, or about at least a portion of the shell, the fins, or a combination thereof.

U.S. Pat. No. 7,390,560 discloses a coating system for defouling a substrate. The system includes a ship hull, immersed in water or seawater for long periods of time. The system comprises a conductive layer, an antifouling layer and a means for providing an energy pulse to the conductive layer. The conductive layer comprises polymers, such as carbon filled polyethylene, which are electrically conductive. The antifouling layer comprises polymers, such as polydimethylsiloxane, which have a low surface free energy. The layers are designed such that, when the conductive layer is exposed to a pulse of electrical, acoustic or microwave energy or combinations thereof, said conductive layer separates from said antifouling layer.

U.S. Pat. No. 6,303,078 discloses an antifouling structure for protecting objects in contact with seawater, which can include a water-permeable fibrous material which incorporates a molded thermoplastic resin or woven fabric containing large amounts of an antifouling agent, with the antifouling agent leaching into the seawater from the structure. According to this reference, it is important that the leaching agent maintains high concentrations of the anti-fouling agent in the vicinity of the object to prevent the attachment of aquatic organisms. In addition, many of the enclosure embodiments disclosed by this reference create environments with extremely low dissolved oxygen levels (i.e., 8.3% or less), which tend to be highly anoxic and promote excessive microbial corrosion and degradation of the protected object.

A wide variety of surface coatings, paints and/or other materials are also known in the art for application to the exterior surfaces of underwater objects, in an attempt to directly shield and/or sequester these objects from the effects of biofouling. Many of these coatings and/or other materials rely upon biocidal additives and/or metallic additives (i.e., copper) that desirably leach into the surrounding aqueous environment over time and interfere with various aspects of the biofouling organisms. For example, bivalent Cu² interferes with enzymes on cell membranes and prevents cell division of various biofouling organisms, while tributyltin (TBT) biocide (now banned from use as a marine biocide in many developed countries) and/or other organotin compounds kills or retards the growth of many marine organisms, and many of these substances may also function as endocrine disruptors. However, the process of preparing the underwater surface(s) of objects and then applying and/or bonding such paints/coatings directly to such surface(s) is often an expensive and time-consuming process (which can even require removal of an object from the aqueous environment and/or even drydocking of a vessel), and all of these coatings have a limited duration, typically lose effectiveness over time, and often have a deleterious (and unwanted) effect on organisms in the surrounding aqueous environment. Similar difficulties exist with systems which rely upon ablative and/or surface characteristics such as hydrophobicity, super-hydrophobicity and/or non-adhesive (i.e., non-stick and/or super-ciliated) surfaces.

More recently, systems that rely upon the release or creation of active caustic agents such as chlorine (i.e., electrochlorination systems which generate hypochlorite compounds from seawater) released into the aqueous environment have been used in an attempt to reduce and/or prevent biofouling, especially in cooling and/or filtration water systems for large industrial facilities. In addition to the high cost of purchasing and/or operating such systems, such caustic substances (which may be strong oxidizing agents in the case of chlorine) can cause deleterious effects far beyond their intended environment of use (i.e., once released they can damage organisms in the surrounding aquatic environment), and many of these substances can enhance corrosion and/or degradation of the very items or related system components they are meant to protect.

There have also been various attempts in the art to completely isolate objects from biofouling elements in the aqueous environment, such as by creating a fully sealed environment about an object meant to be protected from biofouling. In these cases, however, the liquid contained within the sealed environment (which is also in direct contact with the protected object) typically becomes stagnant and/or anoxic quite quickly, leading to high levels of anaerobic corrosion of various materials, and especially high levels of corrosion in anoxic sulfate-rich environments such as anoxic seawater.

### SUMMARY OF THE INVENTION

The various inventions disclosed herein include the realization of a need for improved methods, apparatus and/or systems for protecting structures and/or substrates from micro- and/or macro-fouling for extended periods of time of exposure to aquatic environments, including in situations where it may be impracticable, impossible and/or inconvenient for a fully sealed “enclosure” or other types of outer covering to be utilized around an exposed substrate structure on a continuous basis. This could include situations where a substrate or other object is extremely large and/or may have an extensive underwater support structure, where the substrate or other object is moving through an aqueous environment or is providing some form of propulsive power (i.e., ship propellers and/or boat hulls), where surrounding water in the aqueous environment is being circulated, consumed and/or being utilized (i.e., for cooling water and/or distilled for fresh water), and/or situations where a sensor or other device is being utilized to record and/or sample the surrounding aqueous environment.

The various inventions disclosed herein further include the realization that a completely sealed enclosure which fully isolates a substrate from the surrounding aqueous environment may not adequately protect a substrate from a variety of negative effects of the aqueous environment, in that the “protected” substrate might suffer corrosion or other effects stemming from anoxic, acidic and/or other conditions (and/or other conditions relating to such surroundings, such as the actions of microbially induced corrosion) that may develop within a fully sealed enclosure and/or in proximity to the substrate. Accordingly, optimal protection of the substrate can be provided by an enclosure which at least partially (but not fully) separates the substrate from various features and/or aspects of the surrounding aqueous environment.

In various embodiments, an anti-biofouling “enclosure” or “barrier” is described which can be positioned around, against and/or otherwise in the proximity of a substrate or other object to filter, segregate, separate, insulate, protect and/or shield the substrate from one or more features or characteristics of the surrounding aqueous environment, including the employment of various of the embodiments described in co-pending U.S. Patent Application Ser. No. 62/817,873, filed Mar. 13, 2019 and entitled “BIOFOULING PROTECTIVE ENCLOSURES, and co-pending Patent Cooperation Treaty (PCT) Patent Application No. PCT/US19/59546, filed Nov. 1, 2019 and entitled “DURABLE BIOFOULING PROTECTION,” the disclosures of which are each incorporated by reference herein in their entireties. More specifically, various embodiments of an enclosure will desirably create a “bounded,” at least partially enclosed and/or differentiated aqueous environment in the immediate vicinity of the substrate, which can serve to filter or screen the substrate from direct biofouling by some varieties of micro and/or macro agents as well as, in at least some instances, promote the formation of a relatively durable surface biofilm, coating or layer on the substrate and/or enclosure walls which can potentially inhibit, hinder, avoid and/or prevent the subsequent settling, recruitment and/or colonization of the substrate surface by unwanted types of biofouling organisms for extended periods of time, even in the absence of the enclosure. In many instances, openings, voids and/or fenestrations of the enclosure walls may allow a controlled amount of water exchange between the aqueous environment within the enclosure and the aqueous environment outside of the enclosure, and possibly even alter the water chemistry and/or turbidity of the liquid contained within the enclosure, potentially leading to differing levels of clay, silt, finely divided inorganic and organic matter, algae, soluble colored organic compounds, chemicals and compounds, plankton and/or other microscopic organisms suspended in the differentiated liquid as compared to those of the surrounding open aqueous environment—levels of which might contribute in various ways to fouling and/or corrosion (or lack of fouling and/or corrosion) of the substrate contained within the enclosure.

In various embodiments, the enclosures described herein act to produce at least a partially “enclosed,” “local,” “contained” and/or “differentiated” aquatic environment, adjacent to a submerged and/or partially submerged portion of a substrate or surface to be protected, that is or becomes unfavorable for settlement and/or recruitment of aquatic organisms that contribute to various types of biofouling (which may include surfaces that create “negative” settlement cues as well as surfaces that may be devoid of and/or present a reduced level of “positive” settlement cues for one or more types of biofouling organisms). The enclosure(s) and/or other constructs in various embodiments can also desirably filter, reduce and/or prevent many marine organisms that contribute to biofouling from entering the enclosure and/or from contacting the submerged and/or partially submerged surface of the substrate.

In various embodiments, an enclosure can include a permeable, formable matrix and/or fabric material, which in at least one exemplary embodiment can comprise a woven polyester fabric made from spun polyester yarn. In at least one further embodiment, the employment of a spun polyester yarn could desirably increase the effective surface area and/or fibrillation of the fabric material on a minute and/or microscopic scale, which can desirably (1) lead to a significant decrease in the “effective” or average size of natural and/or artificial openings extending through the fabric, (2) decrease the amount and/or breadth of “free space” within openings through and/or within the fabric, thereby potentially reducing the separation distance between microorganisms (within the inflowing/outflowing liquids) with surfaces of the fabric, and/or (3) alter and/or induce changes in the water quality within the enclosure in various ways. The decreased average opening size of the fabric will desirably increase “filtration” of the liquid to reduce and/or prevent various biologic organisms and/or other materials from entering the enclosed or bounded environment, while the reduced “free space” within the opening(s) will desirably reduce the chances for organisms to pass freely through the fabric and/or reduce the speed and/or quantity of “total water exchange” between the enclosed or bounded environment and the open aqueous environment. These factors will desirably result in significant reductions or metering in the size and/or viability of micro- and macro-organisms (as well as various organic and/or inorganic foulants and/or other compounds) passing into/out of the walls of the enclosure. Moreover, these aspects will also desirably reduce the quantity, extent and/or speed of biofouling or other degradation that may occur on the enclosure material itself and/or within the opening(s) therein, desirably preserving the flexibility, permeability and/or other properties of the fabric of the enclosure for an extended period of time.

In some embodiments, at least a portion of the fabric walls of the enclosure can be fenestrated and/or perforated to a sufficient degree to allow some amount of liquid and/or other substance(s) to pass and/or “filter” through the walls of the enclosure in a relatively controlled and/or metered manner (i.e., from the external or “open” aqueous environment to the differentiated aqueous environment and/or from the differentiated aqueous environment to the external or open aqueous environment), which desirably provides for a certain level, amount and/or percentage of “mass liquid flow” and/or “total liquid exchange” to occur through the enclosure walls between the differentiated environment (within the enclosure) and the surrounding open aqueous environment (outside of the enclosure), as well as the potential for various materials and/or compositions to diffuse or otherwise pass through the enclosure walls and/or pores thereof. These movements of liquid and/or other compositions, in combination with various natural and/or artificial processes, desirably induce, facilitate and/or create a relatively “different” or dynamic “artificial” environment within the enclosure, specifically having different characteristics in many ways from the dynamic characteristics of the surrounding aqueous environment, which desirably renders the differentiated environment “undesirable” for many biofouling organisms and thereby reducing and/or eliminating biofouling from occurring within and/or immediately outside of the enclosure. In addition, the presence of numerous small perforations in the walls of the enclosure can desirably provide for various levels of filtration of the intake and/or exchange liquid(s), which can potentially reduce the number and/or viability of organisms entering the enclosure via wall pores as well as negatively affect organisms within and/or outside of the enclosure that may pass proximate to the enclosure walls.

In various embodiments, the presence of the enclosure and any optional openings and/or perforation(s) therethrough may create an “enclosed” or “partially enclosed” aqueous environment that may be less conducive to micro and/or macro fouling of the substrate than the surrounding aqueous environment, which might include the existence and/or presence of biofilm local settlement cues within the enclosed environment that are at a lower positive level than the biofilm local settlement cues of the surrounding aqueous environment. Desirably, the enclosure will create “differences” in the composition and distribution of various environment factors and/or compounds within the enclosed aqueous environment as compared to similar factors and/or compounds within the surrounding open aqueous environment, with these “differences” inhibiting and/or preventing significant amounts of biofouling from occurring (1) on the surface of the protected substrate, (2) on the inner wall surfaces of the enclosure, (3) within the interstices of openings and/or perforations in the walls of the enclosure and/or (4) on the outer wall surfaces of the enclosure. In some embodiments, the enclosure may create a gradient of settlement cues within the enclosure that induces and/or impels some and/or all of the micro and/or macro fouling organisms to be located somewhat distal to the substrate, while in other embodiments the enclosure may create a microenvironment proximate to the substrate which is not conducive to biofouling and/other degradation of the substrate. In still other embodiments, the enclosure may be positioned proximate to and/or in direct contact with the substrate, such as being directly wrapped around the substrate, and still provide various of the protections described herein.

In various embodiments, the structure may comprise a plurality of smaller openings, perforations and/or pores in the fabric, as well as one or more larger openings such as an open bottom and/or top (or portions thereof) as well as various openings on the sides of the enclosure. In various embodiments, a “large” opening can be defined as an opening in the enclosure that comprises as least 10% or greater of the surface area of the external surface area of the enclosure walls, while in other embodiments a large opening may comprise areas that are 2% or greater, 5% or greater, 15% or greater, 20% or greater, 25% or greater, 30% or greater, 35% or greater and/or 40% or greater than the surface area of the external surface area of the enclosure walls. In various other embodiments, a plurality of relatively smaller openings (i.e., 0.25% to 2% of the surface area of the external surface area of the enclosure walls) may be somewhat equivalent in function and/or structure to one or more of the larger openings described herein.

As one example, the amount of dissolved oxygen in the liquid within the enclosure will desirably differ to a significant degree from the amount of dissolved oxygen in the liquid of the external aqueous environment, with changes in the dissolved oxygen in the differentiated liquid potentially mirroring, trailing and/or “lagging” (to varying amounts) the level of dissolved oxygen in the external aqueous environment. Desirably, this level of dissolved oxygen in the differentiated liquid will typically be less than that of the surrounding aqueous environment (although in various embodiments it may equal to and/or be more than that of the surround environment, including on a periodic and/or continuous basis), and in various embodiments the level of dissolved oxygen may fluctuate at values above levels conducive to the activity of sulfate-reducing or similar bacteria (i.e., microbially induced corrosion—“MIC”) and/or other anoxic degradation/corrosion, with the fluctuations themselves desirably helping to inhibit and/or control the predominance of any single undesirable type or group of micro- and/or macro-organisms within the enclosure or various sections or portions thereof.

In various embodiments, a gradient of dissolved oxygen and/or other water chemistry components may develop within the liquid of the enclosure between the inner wall of the enclosure and the outer surface of the protected substrate, with this gradient potentially creating a “more hospitable zone” proximate to the inner wall of the enclosure and/or a “less hospitable zone” proximate to the surface(s) of the substrate, which in some embodiments may induce various microorganisms to travel towards the inner enclosure wall and/or away from one or more surfaces of the substrate (which may be due to the increase dissolved oxygen percentage that may exist closer to the enclosure walls, as one example), as well as potentially impelling some microorganisms to not colonize, settle, thrive and/or grow on the surface(s) of the substrate. In various embodiments, this gradient may be due, at least in part, to the influx of water through and/or into the enclosure, and/or may be due, at least in part, to the outflow of water through and/or out of the enclosure. The resulting “exchange” of water into and/or out of the enclosure, and the various concentrations of chemicals and/or compounds contained therein, will desirably reduce the quantity, extent and/or speed of biofouling or other degradation that may occur to the substrate in its natural (i.e., unprotected) state.

In various embodiments, water or other aqueous media which enters and or leaves the enclosure will desirably accomplish this passage in primarily an “en masse” fashion, where localized variations in water velocity and/or “currents” within the enclosure will be minimized. The resulting relatively quiescent nature of the water within the enclosure will desirably reduce and or inhibit significant “mixing” of water within the enclosure, desirably leading to a greater level of stratification and/or differentiation within the enclosure, which can include stratification based on oxygenation levels (i.e., chemoclines) and/or other properties (i.e., salinity, density, temperature), potentially leading to the creation of localized regions of anoxia and/or euxinia within the enclosure (which regions may be suspended within the enclosure and/or separated from the surface of the substrate by other regions of water within the enclosure). Moreover, the water leaving the enclosure, which can comprise a variety of metabolic wastes and/or detrimental compounds (including various known and/or unknown microbial “toxins”) and/or other inhibiting compounds generated within the differentiated environment, will desirably “linger” within the pores of the enclosure and/or in the vicinity of the outer walls of the enclosure in a “cloud” of such wastes/compounds for varying lengths of time, which will desirably reduce and/or impeded colonization of the enclosure walls (including the externally facing walls) by fouling organisms.

In one exemplary embodiment, an enclosure may be utilized in proximity to a substrate to create an oxygen-depleted zone within the enclosure, with at least a portion of this oxygen-depleted zone in proximity to or in contact with the substrate, wherein in some embodiments the oxygen-depleted zone may comprise the entirety of the differentiated aqueous environment (i.e. within the enclosure) while in other embodiments the oxygen-depleted zone may comprise only a portion of the of the differentiated aqueous environment. Desirably, various aspects of the enclosure's unique design and arrangement will allow one or more natural processes to initially generate an oxygen depletion zone, although in some embodiments additional actions and/or activities may be undertaken to initiate, accelerate, maintain, delay, reduce and/or supplement the one or more natural process(es), which can affect the oxygen depletion region created thereby.

Desirably, the enclosure will provide a unique protected environment within the aqueous environment, wherein the quantity and/or diversity of bacteria and/or other microorganisms within the enclosure may differ from those located outside of the enclosure. Moreover, the enclosure may create a plurality of differentiated environments within the enclosure, which could include a first differentiated “environment” that could be quantified as “proximal to the inner wall of the enclosure” (i.e., within a few millimeters of the inner wall of the enclosure, for example) and at least a second differentiated “environment” that could be quantified as proximal to (i.e., within a few millimeters of) the outer surface of the substrate. In various exemplary embodiments, a given differentiated environment could induce or promote the formation of one or more biofilm(s) within the enclosure, which could include formation of a biofilm on the surface of the substrate which may differ in various aspects from a biofilm that might be formed on the substrate within the aqueous environment in the absence of the enclosure and/or a different biofilm on an inside surface or within the pores of the enclosure wall. For example, the substrate biofilm in the “enclosed” or differentiated environment might incorporate a lower/lesser diversity of bacteria or other micro-organisms, or may comprise a “thinner” layer of biofilm than would normally be formed on the surface of an unprotected equivalent substrate (which may promote heat transfer through the film and/or the adjacent surface(s) in a desired manner). In various instances, this differentiated biofilm may be advantageous for preventing and/or reducing micro- and/or macro-fouling of the substrate or for a variety of other reasons.

In some embodiments, the unique protected environment within the aqueous environment may induce a unique quantity and/or diversity of bacteria and/or other microorganisms within the enclosure that may induce or promote the formation of one or more biofilm(s) within the enclosure, wherein such biofilms may be “less tenaciously attached” to the substrate than biofilms normally encountered in unprotected environments. Such biofilms may facilitate the removal and/or “scraping off” of fouling organisms from the substrate and/or from intermediate biofilm layers. In such cases, the microflora and/or microfauna may comprise different phyla (i.e., different bacteria and/or cyanobacteria and/or diatoms) from those located outside of the enclosure.

In various embodiments, the presence of the enclosure and the various perforation(s) there through may create a “differentiated” aqueous environment that may be less conducive to micro and/or macro fouling of the substrate than the surrounding aqueous environment, which might include the existence and/or presence of biofilm local settlement cues within the differentiated environment that are at a lower positive level than the biofilm local settlement cues of the surrounding aqueous environment. Desirably, the enclosure will create “differences” in the composition and distribution of various environment factors and/or compounds within the differentiated aqueous environment as compared to similar factors and/or compounds within the surrounding open aqueous environment, with these “differences” inhibiting and/or preventing significant amounts of biofouling from occurring (1) on the surface of the protected substrate, (2) on the inner wall surfaces of the enclosure, (3) within the interstices of openings and/or perforations in the walls of the enclosure and/or (4) on the outer wall surfaces of the enclosure. In some embodiments, the enclosure will create a gradient of settlement cues within the enclosure that induces and/or impels some and/or all of the micro and/or macro fouling organisms to be located somewhat distal to the substrate, while in other embodiments the enclosure may create a microenvironment proximate to the substrate which is not conducive to biofouling and/other degradation of the substrate. In still other embodiments, the enclosure may be positioned proximate to and/or in direct contact with the substrate, such as being directly wrapped around the substrate, and still provide various of the protections described herein.

In various other embodiments, the presence of the perforated enclosure walls can similarly affect various water chemistry factors and/or the presence/absence of nutrients and/or wastes within the differentiated environment and/or portions thereof as compared to those of the surrounding aqueous environment. For example, the pH, total dissolved nitrogen, ammonium, nitrates, nitrites, orthophosphates, total dissolved phosphates and/or silica could vary between the differentiated environment and the surrounding open aqueous environment, and even within the differentiated environment the levels of such nutrients can vary across the enclosed or bounded aqueous region. In general, the water chemistry, nutrient levels and/or levels of waste metabolites in the liquid within the enclosure at a location proximate to at least a portion of the enclosure walls (i.e., an “upstream portion” based on a direction of mass water flow) might more closely approximate the levels of the liquid outside of the enclosure, with greater variation typically seen further within the enclosure and/or proximate to the substrate surface.

In various embodiments, the presence of an enclosure such as described herein might alter water chemistry such that fouling organisms that might land on the substrate may not settle or attach to the substrate and/or may be unable to thrive and/or colonize the substrate because of the various “inhospitable” conditions within the differentiated environment that render the organism unable to grow (including an inability to grow as quickly as comparable organisms situated outside of the enclosure), thrive and/or pass through one or more of the required natural processes and/or stages these organisms undergo in order to become fully functioning macrofouling organisms. For example, various chemistry changes could occur within the enclosure (as compared to the surrounding open aqueous environment), including lower dissolved oxygen levels, altered pH, different nutrient levels and/or concentrations, levels of waste products and/or lack of movement of the water within the enclosure, etc. In many cases, fouling organisms might even disconnect and/or “die off” from an already-fouled surface when the substrate is placed within the various enclosures described herein, which could potentially halt and/or reduce fouling of the substrate, as well as potentially loosen and/or detach some existing biofouling organisms and/or skeletal remains such as shells, skeletons, exoskeletons and/or related support structures from the fouled surface(s).

In various embodiments, the arrangement, small size and/or distribution of the perforations of the walls of the enclosure, as well as the presence of the various threads and/or thread portions (i.e., ciliation) positioned therein, could limit, prevent and/or regulate the presence and/or availability of sunlight or other light/heat energy (including man-made and/or bioluminescent energy sources) within the enclosure or various portions thereof, including limiting and/or preventing various energy sources (such as sunlight for photosynthesis, for example) from being readily available for use by various microorganisms and/or other degenerative processes, especially where the enclosure is being utilized nearer the surface of the aqueous environment or close to such other energy sources. If desired, the availability or existence of such energy sources proximate to the walls of the enclosure (i.e., through the perforations) may induce some motile organisms to congregate and/or collect proximal to the inner walls of the enclosure, desirably reducing their presence proximate to the substrate surface to be protected. In various alternative embodiments, a light or other energy source could be positioned in the surrounding aqueous environment proximate to the enclosure and/or could be positioned within the enclosure in various locations, including proximate to the protected substrate, thereby increasing the availability of such energy source proximate to and/or within the enclosure. Such embodiments might be particularly useful in limiting the presence and/or growth of biofouling organisms sensitive to the added energy source (i.e., such as providing a light source to inhibit zebra mussels—who typically prefer darker environments).

In various embodiments, the arrangement, small size and/or distribution of the perforations of the walls of the enclosure, as well as the presence of the various threads and/or thread portions therein, can limit, prevent and/or regulate the location and/or quantity of higher velocity mass flow(s) of water which may occur within the enclosure or various portions thereof, including limiting and/or preventing various types of laminar and/or turbulent flow(s) of liquid (i.e., localized streams or “jets” of water) within the enclosure and/or proximate to the substrate. In some embodiments, the relatively “slack” but somewhat less than completely “quiescent” nature of the water that can be attained within the enclosure can prevent significant numbers of non-sessile microorganisms from coming into contact with the substrate or a boundary layer proximate thereto. Moreover, the limited flow of liquid within the enclosure may allow a thinner/thicker aqueous liquid boundary layer to exist proximate to the protected substrate and/or the enclosure walls, which can further limit microorganism or other contact with the protected substrate as well as induce or allow the formation of a thinner/thicker biofilm layer on the substrate than normally exists in the more active flow situation(s) of the open aqueous environment.

In at least one alternative embodiment, various advantages of the present invention might be provided by a non-permeable enclosure (including plastic, wood and/or metal wall sheets or plates, etc.) which incorporates a supplemental and/or artificial water exchange mechanism, such as a powered pump or “check valve” arrangement, propeller system and/or petal system, that provides for a desirable level of water exchange between the differentiated aqueous environment and the surrounding open aqueous environment.

In some embodiments of the present invention, some or all of the biofouling protections and/or effectiveness described herein for a protected substrate can desirably be provided by the enclosure and its permeable, formable matrix, fibrous matrix and/or fabric wall materials without the use of various supplemental anti-biofouling agents, while in other embodiments the enclosure could comprise a permeable, formable fibrous matrix and/or fabric wall material which incorporates one or more biocidal and/or antifouling agents into some portion(s) of the wall structure and/or coatings thereof. In some embodiments, the biocidal and/or antifouling agent(s) could provide biofouling protection for the enclosure walls and/or components (with the enclosure itself providing a level of biofouling protection for the substrate), while in other embodiments the biocidal and/or antifouling agent(s) might provide some level of biofouling protection for the substrate itself, while in still other embodiments the biocidal and/or antifouling agent(s) could provide biofouling protection for both the enclosure and substrate, and/or various combinations thereof.

In some embodiments, the enclosure may provide biofouling protection to both the substrate and the enclosure walls to differing degrees, even in the absence of a supplemental biocide or other fouling protective substance, inhibitor and/or toxin that may be integrated into and/or supplementally provided to the enclosure structure. For example, when an enclosure such as described herein is placed around a substrate and creates the disclosed differentiated environment(s), the environment(s) may also develop increased concentrations of a variety of metabolic wastes, and the various processes and/or metabolic activities occurring within the enclosure may generate one or more substances (such as hydrogen sulfide or NH₃—N—Ammoniacal Nitrogen, for example) having detrimental, harmful, toxic and/or other negative effect on fouling organisms. For example, NH₃—N is the undissociated form of ammonia also known as free ammonia nitrogen (FAN) or ammoniacal nitrogen, which is found to be detrimental and/or toxic to microorganism since it can permeate the cell membrane. In some embodiments, a desired concentration of such detrimental compounds (including various known and/or unknown microbial “toxins”) and/or inhibiting compounds may develop within the enclosure (and these concentrations may then be continually “replenished” by the various processes occurring within the enclosure), where they can reside in the differentiated aqueous region within the enclosure and/or elute through the walls of the enclosure, potentially creating a localized “cloud” of detrimental chemicals that protects the outer walls of the enclosure from fouling organisms to some degree. However, once these compounds leave the enclosure, these detrimental and/or inhibitory compounds may quickly become diluted and/or broken down by various natural processes, thus obviating significant concerns about the longer-term effects of these substances on the environment at some distance from the enclosure. In addition, because the processes creating these compounds within the enclosure are continuous and/or periodic, the enclosure may constantly generate and/or elute these inhibitory compounds at a relatively constant level on an indefinite basis without requiring elution reservoirs and/or external replenishment or external power sources.

In at least one exemplary embodiment, an enclosure can comprise a permeable, formable fibrous matrix of polyester fabric made from spun polyester yarn, which can be coated on at least one side (such as an externally facing surface of the enclosure) with a biocidal compound or coating or paint containing a biocidal agent, wherein at least some of the biocide compound penetrates at least a portion of the way into the body of the fabric. In at least one further embodiment, the employment of a ring spun polyester yarn could desirably increase the effective surface area and/or fibrillation of the fabric material on a minute and/or microscopic scale, which can desirably (1) lead to a significant decrease in the average size of natural openings extending through the fabric and/or (2) decrease the amount and/or breadth of “free space” within openings through and/or within the fabric, thereby potentially reducing the separation distance between microorganisms (within the inflowing/outflowing liquids) and the biocide coating(s) resident on the fabric. The decreased average opening size of the fabric in such embodiments will desirably increase “filtration” of the liquid to reduce and/or prevent various biologic organisms and/or other materials from entering the enclosed or bounded environment, while the reduced “free space” within the opening(s) will desirably increase or amplify the effects of the biocide on organisms passing through the enclosure (including an increased potential for direct contact to occur between the biocide and various organisms) as they pass very close to the biocidal coating. These factors will desirably result in significant reductions in the size and/or viability of micro- and macro-organisms (as well as various organic and/or inorganic foulants) passing into the enclosure. Moreover, the presence of biocide coating(s) and/or paint(s) and/or additive(s) on and/or in the fabric of the enclosure will desirably significantly reduce the quantity, extent and/or speed of biofouling or other degradation that may occur on the enclosure material itself and/or within the opening(s) therein, desirably preserving the flexibility, permeability and/or other properties of the fabric of the enclosure for an extended period of time.

In some embodiments and/or some aqueous environments, the presence of an optional biocide coating on at least the outer surface of the flexible enclosure material will desirably reduce the thickness, density, weight and/or extent of biofouling and/or other degradation experienced on and/or within openings within the enclosure itself, which will optimally maintain a desired level of water exchange between the enclosure and the surrounding environment and/or extend the useful life of the enclosure in its desired position around the substrate. In many situations, biofouling of an enclosure significantly increases the weight and/or stiffness of the enclosure, which can damage the enclosure and/or structures attached to the enclosure (including the substrate itself), as well as adversely affect the buoyancy of the enclosure and/or any objects attached thereto. In addition, biofouling of the enclosure itself can reduce the flexibility and/or ductility of various fabric components, which can cause and/or contribute to premature ripping and/or failure of the fabric and/or related attachment mechanisms in the dynamic aqueous environment. Moreover, biofouling formation on/within the enclosure can potentially “clog” or diminish the size of and/or close openings through and/or within the enclosure fabric, which can potentially alter the permeability and/or liquid exchange rate between the differentiated environment and the surrounding dynamic and/or open aqueous environment, possibly resulting in undesirable conditions (i.e., low dissolved oxygen levels and/or anoxia) and/or corrosion or other issues occurring within the enclosure.

In at least one embodiment, an enclosure may include an initial biocide treatment that elutes and/or otherwise dispenses for a limited period of time after deployment of the enclosure, wherein this period of time is sufficient to allow other features of the enclosure to develop the differentiated environment, wherein the differentiated environment can generate various inhibitory substances to provide subsequent biofouling protection to the substrate and/or the enclosure after the initial biocide elution has dropped to lower and/or ineffective levels and/or has ceased eluting or dispensing.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings, in which:

FIG. 1 depicts one exemplary embodiment of an enclosure in the form of a kilt or skirt-type construction;

FIG. 2 depicts a partial cross-sectional view of the skirt enclosure system of FIG. 1;

FIG. 3A depicts a perspective view of one exemplary sheet or wall for use in the various biofouling protective systems described herein;

FIG. 3B depicts a perspective view of another embodiment of a peripheral ring or curtain biofouling protection system;

FIG. 3C depicts a perspective view of one exemplary embodiment of a filtration module or filter element for use in a biofouling protection system;

FIG. 3D depicts another exemplary embodiment of a peripheral ring or curtain biofouling protection system;

FIG. 4A depicts a cross-sectional of another embodiment of a skirt enclosure positioned at least partially around a floating object;

FIG. 4B depicts a cross-sectional of another exemplary embodiment of a skirt enclosure positioned at least partially around a floating object;

FIG. 5 depicts a side view of another exemplary embodiment of a skirt or peripheral enclosure biofouling protection system placed about an offshore oil platform;

FIG. 6 depicts another exemplary embodiment of a biofouling protection system having a plurality of enclosures and partial enclosures positioned around the various support legs of an oil drilling platform;

FIGS. 7A and 7B depict top plan and perspective views of a U-shaped biofouling protective enclosure positioned within a standard boat slip;

FIGS. 7C and 7D depict side and perspective views of another exemplary U-shaped biofouling protective enclosure which incorporates a hanging curtain closure;

FIGS. 8A and 8B depict components of a biofouling protective system that include a plurality of deployable roller sheets;

FIG. 9A depicts a perspective view of another exemplary embodiment of a fabric skirt section and buoyant float of a biofouling protective system;

FIGS. 9B and 9C depict a sliding or tongue-in-groove connection between adjacent floating boom sections of a biofouling protective system;

FIGS. 9D and 9E depict a closeable flap which can be engaged to protect the connection between adjacent floating boom sections of a biofouling protective system;

FIG. 10 depicts a side view of one exemplary embodiment of a fabric sheet and associated structures for attachment to a commercially available floating boom system;

FIG. 11 depicts a side view of another exemplary embodiment of a skirt-type biofouling protective enclosure;

FIGS. 12A and 12B depict views of another exemplary embodiment of an enclosure for reducing biofouling in the intake piping and related equipment of a manufacturing plant or other facility;

FIG. 13A depicts a simplified perspective view of one exemplary embodiment of a natural or artificial reservoir or pond;

FIGS. 13B and 13C depict one exemplary embodiment of a labyrinth or tortuous path biofouling protective enclosure;

FIG. 13D depicts an alternative embodiment of a labyrinth or tortuous path biofouling protective enclosure;

FIG. 14A depicts a scanning electron microscope (SEM) micrograph of an exemplary spun yarn for use in a biofouling protective enclosure;

FIG. 14B depicts a cross-sectional SEM micrograph of a central body portion of the yarn of FIG. 14A;

FIG. 14C depicts a SEM micrograph of a knit fabric comprising PET spun yarn;

FIG. 15A depicts an exemplary fabric material in rolled sheet form for use in a biofouling protective enclosure;

FIG. 15B depicts another exemplary fabric material in rolled sheet form for use in a biofouling protective enclosure;

FIG. 16 depicts a cross-sectional view of an exemplary permeable fabric showing various pore openings and simplified passages;

FIG. 17A depicts another exemplary embodiment of an uncoated polyester woven fabric;

FIG. 17B depicts the embodiment of 17A with a coating;

FIG. 18A depicts a natural uncoated burlap fabric;

FIGS. 18B and 18C depict the fabric of FIG. 18A coated with a solvent based biocidal coating and a water based biocidal coating;

FIG. 19A depicts an uncoated polyester fabric;

FIG. 19B depicts the fabric of FIG. 19A coated with a biocidal coating;

FIG. 19C depicts an uncoated spun polyester fabric

FIG. 19D depicts the fabric of FIG. 19C coated with a biocidal coating;

FIG. 19E depicts an uncoated spun polyester cloth;

FIG. 19F depicts an uncoated side of the spun polyester cloth of FIG. 18E after coating;

FIG. 20 depicts the detection of a rhodamine concentration in an exemplary enclosure over time;

FIG. 21 depicts various plankton types and conditions identified in various enclosure embodiments;

FIG. 22 depicts a perspective view of another exemplary embodiment of an enclosure for protecting a substrate from biofouling that incorporates a wall structure having a plurality of layers;

FIG. 23 depicts one exemplary embodiment of an aqueous flow mechanism of a supplemental pumping system for use with various embodiments of a biofouling protective enclosure; and

FIG. 24 depicts various distributions of bacterial phyla in biofilms formed on various substrates in seawater.

### DETAILED DESCRIPTION OF THE INVENTION

The disclosures of the various embodiments described herein are provided with sufficient specificity to meet statutory requirements, but these descriptions are not necessarily intended to limit the scope of the claims. The claimed subject matter may be embodied in a wide variety of other ways, may include different steps or elements, and may be used in conjunction with other technologies, including past, present and/or future developments. The descriptions provided herein should not be interpreted as implying any particular order or arrangement among or between various steps or elements except when the order of individual steps or arrangement of elements is explicitly described.

Disclosed herein are a variety of simple-to-assemble and/or use enclosures and/or other devices which may be placed in proximity to, around, within, on top of and/or below a substrate or other object that is located within (or that is placed within) an aqueous environment or aqueous holding tank that is susceptible to biofouling. In various embodiments, systems, devices and methods are disclosed that can protect a submerged and/or partially submerged substrate or other object (or portions thereof) from the effects of aqueous biofouling, including the creation and potential retention of biofouling resistance by the substrate for some extended period of time after the enclosure may be opened and/or removed.

In various embodiments, protective enclosures are disclosed that can be formed from relatively inexpensive and readily available materials such as polyester, nylon or rayon fabrics and/or natural materials such as cotton, linen or burlap fabrics (or various combinations thereof). In various embodiments, an enclosure could include disposal and/or biodegradability features that allow the enclosure or portions thereof to decouple from the substrate and/or support structure, decompose and/or otherwise deteriorate after a certain amount of exposure to the aqueous environment, which could include deterioration and/or detachment after formation of a desired biofilm or other layer on the substrate.

In various embodiments disclosed herein, the terms “differentiated aqueous environment” and/or “local aqueous environment” are meant to broadly encompass some and/or all of the aqueous area in which the water chemistry has been or will be altered due to the enclosure's impact and/or presence, which may include one or more of the following (and/or any combinations thereof): 1) any water inside of the inner wall of the enclosure (i.e., the “enclosed” or “differentiated” aqueous environment), 2) any water within any pores or spaces between the inner and outer surfaces of the enclosure (i.e., the “entrained” aqueous environment), and/or 3) any water immediately proximate to the outer surface of the enclosure (i.e., “proximate” aqueous environment).

While in some embodiments the enclosure may substantially surround and/or encompass an exterior surface of the substrate, in some alternative applications the enclosure may desirably be positioned and/or configured to protect substrates located adjacent to and/or outside of the enclosure, wherein the “open aqueous environment” might be considered to be located within the enclosure, and the “enclosed” or “differentiated” aqueous environment could be positioned between the exterior walls of the enclosure and the interior walls of the substrate. For example, in a water storage tank, the interior walls of the tank might constitute the “substrate” to be protected, and some or all of water being pumped into the tank (i.e., from an external environmental source such as a stream, lake, well, harbor or reservoir) might constitute the “open aqueous environment” from which the substrate is sought to be protected. In such a case, an enclosure such as described herein could be positioned around the water inlet (or the enclosure walls could be positioned at some point between the water inlet and the tank walls), with the enclosure desirably creating the “different” environmental condition(s) proximate to the tank walls and thereby protecting the tank walls from the various effects of biofouling such as described herein.

In a similar manner, for embodiments potentially involving “filtering” and/or “straining” of liquids using enclosures and/or portions thereof, the “open aqueous environment” might be considered the upstream source of aqueous water (or other liquids) prior to passing through the enclosure walls, and the “differentiated aqueous environment” might be considered the liquid after having passed through the enclosure portion(s). At least one alternative embodiment might include enclosure elements that could line the inner walls of a water tank, holding cell or dispensing unit, such as a biofouling protective “wind sock” or similar design that could be deployed within a flange of aqueous piping.

It should be understood that in various alternative embodiments, “enclosing” a substrate as described herein encompasses partially enclosing the substrate with an enclosure or other device to a sufficient degree to induce some and/or all of the desired filtration and/or water chemistry changes in proximity to the protected substrate, including enclosures that may not fully seal or isolate the substrate from the surrounding aqueous or other environments. For example, an enclosure that protects the hull or other submerged and/or partially submerged portions of a boat or ship may be considered to “enclose” the hull as described herein, even where the enclosure only encompasses some or all of the underwater portions of the hull and portions of the enclosure may be open to the surrounding air (i.e., including portions open to the “above water” environment), open to portions of the aqueous environment and/or open towards other objects such as wood structures, rock walls, solid metal sheets, etc. In a similar manner, an enclosure having various breaks, openings, seams, cracks, tears and/or missing wall elements therein may be considered to “enclose” the substrate as described herein where there is sufficient enclosure structure to desirably induce some and/or all of the desired water chemistry changes and/or filtering functions to occur in proximity to the enclosure and/or protected substrate, thereby protecting the enclosure and/or substrate from biofouling and/or reducing the amount of biofouling of the enclosure/substrate to an acceptable level and/or inducing the formation of a desired biofilm on the substrate as described herein.

In at least one embodiment, a partially-open or skirt-type enclosure is disclosed, such as one having a lower edge of the enclosure wall which is proximate to and/or touches the bottom surface of the harbor floor. In at least one possible embodiment, the enclosure may include features that partially and/or fully “seal” some portion(s) of the enclosure against other objects such as seawalls, hull portions, larger vessel hulls, submerged and/or partially submerged structures and/or the bottom surface/mud of the seafloor. In other embodiments, the enclosure may desirably include sufficient depth to provide the biofouling protections described herein, but will be shallow enough to avoid touching the bottom of the aqueous medium during low tide (i.e., lengths of 3 feet, 6 foot and/or 9 foot depths down into the water, for example). If desired, the bottom portion of the vertically oriented sheets can include fenestrations, slits, fringes and/or perforations that may inhibit, but not completely prevent, the flow of water into and/or out of a space between the bottom of the enclosure and the seafloor.

In some embodiments, a “partial” enclosure and/or “draping” of a natural water column in the vicinity of a submerged structure may provide significant biofouling protection and/or improvements in preventing and/or reducing biofouling of some or all of the submerged structure, especially where some “active” measures may be concurrently taken to desirably artificially induce and/or accelerate some portion of the various water chemistry changes described herein. In other embodiments, the design and/or positioning of a “partial” enclosure or similar structural elements may utilize water flow dynamics (i.e., creating artificial water flows such as pumping or redirecting of water and/or utilizing natural water flow such as currents, tides, etc.) to ameliorate and/or accommodate the presence of various openings in the enclosure, thereby preventing and/or reducing biofouling of some or all of the submerged structure protected thereby.

If desired, a “partially open” enclosure may be effectively utilized in some environments without significantly impeding the flow of water and/or other materials into and/or out of submerged intakes/exhausts of a fully or partially submerged structure, which could include the hulls of ships and/or water intakes/exhausts of factories, heat exchangers, power generating structures and/or water treatment plants.

In various embodiments, a skirt or kilt-type protection system can include individual elements for the enclosure or similar structure comprising a plurality of vertically oriented “sheets” or similar structures that can be deployed into the water around an object or portion thereof, with some portion of the sheets extending downward below the object to be protected and, in some embodiments, extending significantly below the upper edge of the skirt, the object and/or the water surface, including in some embodiments to extending within and/or beyond some portion of the euphotic zone (i.e., the sunlit zone) of a body of water, with the protection system desirably creating a partially or fully disphotic zone (i.e., a poorly lit zone) of water in the proximity of the object or creating a partially and/or fully bounded region of water which induces and/or maintains a desired chemistry change of the water proximate to the protected object that desirably inhibits biofouling. In various embodiments, the protection system desirably may further induces some level of permeability change to the sunlight passing therethrough, which in some embodiments may reduce and/or prevent the passage of large quantities of useable sunlight into this disphotic zone (i.e., useable by organisms for photosynthesis) via the top of the enclosure with the incorporation of barrier materials such as sheets, meshes, screens and/or other obstacles to reduce and/or eliminate sunlight passage (and/or various wavelengths and/or components thereof) between the object and the upper portion of the enclosure walls. In various embodiments, these barrier materials may also inhibit or prevent the physical mixing of oxygen with the water within the barrier by wave and/or wind action.

In other embodiments, a skirt or peripheral enclosure can be placed about an offshore oil platform that desirably reduces and/or eliminates biofouling around various portions of the support structures or “legs” of the platform. In such embodiments, the enclosure walls can be deployed around much of the perimeter of the entire support structure, and extend vertically downward into the water from drum-type dispensers or “floats” (or could be fixed to the platform directly and/or legs), wherein the depth of the enclosure wall(s) can be increased and/or decreased as desired. Desirably, the enclosure walls will fully and/or partially encircle the platform supports (which could include surrounding individual support legs with individual enclosures or the entire support structure in a single enclosure), and will be extended to a sufficient depth to induce desired water chemistry changes in portions of the enclosed or bounded water body, including proximate to the shallower portions and/or surface of the enclosed or bounded water body. If desired, one or more of the enclosure walls can be raised or lowered as desired, which can induce desired changes in the water chemistry if such chemistry is being monitored (i.e., about the rig or at a remote monitoring station, for example). In a similar manner, one or more openings, partitions and/or partitions in or between enclosure walls can be opened and/or closed, as desired, to desirably alter water chemistry in a desired manner.

If desired, an anti-fouling system can comprise a free-floating enclosure, wherein the enclosure walls may be supported by floating booms which can encircle or surround the protected vessel. In various embodiments, the disclosed structures and/or components thereof may be attached directly to and/or hung directly from a dock or boat slip. For example, a U-shaped enclosure can be positioned within a standard boat slip, with the enclosure walls connected to the adjacent dock(s) and/or other structures.

In various embodiment, an enclosure may be utilized to provide biofouling protection to a protected substrate on a periodic basis, which may include an interruption of biofouling protection on occasions when waterflow proximate to the protected substrate may be increased, decreased and/or some other waterflow changes are desired, with biofouling protection potentially resuming at time periods where waterflow proximate to the protected substrate has resumed at a “normal” or desired level (which may be the same or different from the pre-change waterflow level). For example, an enclosure may include one or more subsurface openings that can be automated and/or controlled by a user, which may be opened when increased waterflow into and/or out of the enclosure may be desirous. Such an occasion could include removal of the substrate from the enclosure, a need for sampling of outside environmental water quality and/or a need for substantial levels of cooling and/or other water (via submerged intakes and/or exhaust in a substrate hull, for example). In other embodiments, the enclosure may be designed to provide an increased flow of water through the enclosure walls at desired time periods, which may reduce and/or obviate some or all of the biofouling protection provided by the enclosure during the increased flow time period(s), but which may provide resumption of biofouling protection once the waterflow rate has reduced below a predetermined design threshold.

In at least one exemplary embodiment, an enclosure design can be provided having particular utility as an anti-biofouling and/or filtering system for systems that use sea and/or fresh water as a source of cooling water. In this embodiment, a floating or partially/fully submerged enclosure or “reservoir” in the aqueous environment can be provided, with the enclosure encompassing a larger amount of aqueous fluid than may be immediately required by the cooling system on a normal use basis. For example, if the cooling system demands 1000 gallons of water per minute during normal operations, then a “reservoir” (i.e., the body of water between the enclosure walls and an intake or inlet of the cooling water system within the enclosure) might desirably encompass at least 10,000 gallons, at least 20,000 gallons, at least 50,000 gallons, at least 100,000 gallons, at least 500,000 gallons and/or at least 1,000,000 gallons and/or more of water. In one exemplary embodiment, a water inlet for the cooling system may be near the top of the reservoir to desirably draw water having a relatively lower dissolved oxygen level into the inlet for use in the cooling equipment, with “replacement” water having a relatively higher dissolved oxygen level being drawn into the bottom and or any lower side openings or gaps of the reservoir. During the time it takes for the bulk water molecules and/or droplets to transit up the water column within the reservoir, natural and/or artificial oxygen scavengers within the water column may desirably reduce the dissolved oxygen level in the water, such that the dissolved oxygen level is somewhat depleted prior to traveling into the inlet. In at least one alternative embodiment, however, the water inlet may be near the bottom of the enclosure and/or the bottom surface of the reservoir, which may be particularly desirable as generally colder water within the enclosure/reservoir for use in cooling equipment.

In at least one exemplary embodiment, a method for determining an appropriate design, size, shape and/or other features of an enclosure can be utilized to determine a recommended minimum enclosed or bounded volume and/or water exchange rate to desirably reduce and/or eliminate biofouling within the enclosure. In some embodiments, such as in a membrane filter configuration, where the enclosure may be utilized to provide a cooling water source and/or other source water for a manufacturing plant (i.e., a power plant, a desalination plant, a refinery and/or other manufacturing facility), the disclosed methods can potentially be utilized to reduce and/or eliminate biofouling within the water and/or other conduits of the plant, and in some embodiments without the need for additional filtration and/or microfiltration of the water. In various embodiments, the enclosure can include a plurality of filters or modular filter panels, wherein one or more of the filters/panels can be replaced when desired. In some embodiments, the filter panels may be replaced while the system is in normal operation.

In various embodiments, the design and use of the enclosure, under certain conditions, can potentially promote, induce and/or impel the formation of a layer, biofilm and/or deposit of material on the substrate and/or the enclosure walls that reduces, repels, inhibits and/or prevents micro and/or macro organisms from subsequently attempting to colonize, recruit and/or foul some or all of the protected substrate. (i.e., providing some level of “biofouling inoculation” to the substrate). For example, various embodiments of the enclosures disclosed herein can cause the generation of a unique aqueous environment within the enclosure, resulting in the creation of a unique mixture of microbes and/or microflora within the environment, including within one or more aqueous layers proximate to the surface of the substrate. In many embodiments, the unique mix and/or distribution of microbes/microflora within the enclosure can induce and/or influence the creation of a microbial biofilm or other layer on the substrate which, in combination with various surface bacteria, may release compounds that affect the settlement, recruitment and/or colonization of fouling organisms on the substrate. In various embodiments, once the unique microbial biofilm layer is established, this layer may remain durable and/or self-replenishing which, in the absence of the enclosure (i.e., where the enclosure may be removed and/or damaged either temporarily and/or permanently) could continue to protect the substrate from certain types and/or amounts of biofouling for extended periods of time.

In various embodiments, chemicals and/or compounds that affect the settlement, recruitment and/or colonization of fouling organisms on the substrate could include toxins and/or biocides, as well as chemicals and/or compounds that deter such settlement, recruitment and/or colonization, as well as chemicals and/or compounds that may be void of positive settlement, recruitment and/or colonization cues, as well as chemicals and/or compounds that may produce a lower level of positive settlement, recruitment and/or colonization cues than those produced on surfaces within the surrounding aqueous environment and/or as compared to chemicals and/or compounds that produce positive settlement, recruitment and/or colonization cues for beneficial organisms (for example, organisms that may not be generally considered significant biofouling organisms). In some embodiments, it may be the lack of certain “welcoming cues” on the protected substrate and/or associated biofilm that may provide extended fouling protection for the substrate. In various embodiments, “welcoming cues” might encompass nutrients and/or chemicals that micro and/or macro flora require, desire and/or that facilitate settlement, recruitment, colonization, growth and/or replication on a given surface, and such “deterrence cues” may include waste metabolites and/or other chemicals that inhibit, deter and/or prevent micro and/or macro flora from settling, recruiting, colonizing, growing and/or replicating on a given surface.

A distinction can often be made among ‘microfouling’ (often referred to as ‘slime’) due to unicellular microorganisms such as bacteria, diatoms and protozoa, which form a complex biofilm; ‘soft macrofouling’ comprising macroscopically visible algae (seaweeds) and invertebrates such as soft corals, sponges, anemones, tunicates and hydroids; and ‘hard macrofouling’ from shelled invertebrates such as barnacles, mussels and tubeworms. Moreover, it is often possible that a given biocide or biocide dosing level may have differing effectiveness on juvenile and adult members of the same species, as well as differing effectiveness based on a host of water chemistry factors, including pH, dissolved oxygen levels, water temperature and/or many other factors.

In various embodiments, an inhibition of fouling can be represented by a reduction in total cover of the substrate and/or the enclosure surface(s)/interstices by fouling organisms, compared to the total fouling cover of a substantially similar substrate (without a protective enclosure) submerged and/or partially submerged in a substantially similar aquatic environment. This reduction in fouling could be a 10% reduction in fouling or greater, a 15% reduction in fouling or greater, a 25% reduction in fouling or greater, a 30% reduction in fouling or greater, a 40% reduction in fouling or greater, a 50% reduction in fouling or greater, a 60% reduction in fouling or greater, a 70% reduction in fouling or greater, an 80% reduction in fouling or greater, a 90% reduction in fouling or greater, a 95% reduction in fouling or greater, a 98% reduction in fouling or greater, a 99% reduction in fouling or greater, a 99.9% reduction in fouling or greater, and/or a 99.99% reduction in fouling or greater. Alternatively, the inhibition of fouling on the protected article(s) could be represented as a percentage of the amount of fouling cover and/or fouling mass (i.e. by volume and/or weight) formed on an equivalent unprotected substrate. For example, a protected article could develop less than 10% of the fouling cover of an unprotected substrate (such as where the protected substrate develops a fouling cover less than 0.1″ thick, and the unprotected equivalent substrate develops a 1″ thick or greater fouling cover), which would reflect a more than tenfold reduction in the fouling level of the protected substrate and/or enclosure walls as compared to the fouling level of the unprotected substrate. In other embodiments, the protected article could develop less than 1% fouling, or a more than one hundredfold reduction in the fouling level of the protected substrate and/or enclosure walls. In still other embodiments the protected article could develop less than 0.1% fouling, which is more than a thousand-fold reduction in the fouling level of the protected substrate and/or enclosure walls. In even other embodiments of the present invention, the protected substrate and/or enclosure walls may have no appreciable fouling in any affected area(s) of the substrate and/or enclosure walls, which could represent a 0.01% (or more) or even 0% fouling level of the protected substrate and/or enclosure as compared to an unprotected substrate (i.e., greater than a ten thousand fold reduction in the fouling level of the protected substrate and/or enclosure walls—or more). ASTM D6990 and the Navy Ship Technical Manual (NSTM) are known reference standards and methods used for measuring the amounts of fouling percent coverage and fouling thickness on a substrate.

In various additional embodiments, an inhibition of fouling can be represented by a reduction in total cover increase of both the substrate and the enclosure surface by fouling organisms, compared to the total increase in fouling cover of a substantially similar substrate (i.e., without a protective enclosure) submerged and/or partially submerged in a substantially similar aquatic environment, which could be measured by visual inspection, physical measurement and/or based on an increased weight and/or volume of the combined substrate and enclosure (i.e., with the increased weight due to the weight of the fouling organisms attached thereto) when removed from the aqueous medium. This reduction in fouling could be a 10% reduction in fouling or greater, a 15% reduction in fouling or greater, a 25% reduction in fouling or greater, a 30% reduction in fouling or greater, a 40% reduction in fouling or greater, a 50% reduction in fouling or greater, a 60% reduction in fouling or greater, a 70% reduction in fouling or greater, an 80% reduction in fouling or greater, a 90% reduction in fouling or greater, a 95% reduction in fouling or greater, a 98% reduction in fouling or greater, a 99% reduction in fouling or greater, a 99.9% reduction in fouling or greater, and/or a 99.99% reduction in fouling or greater.

Improved Heat Transfer Efficiencies

In various embodiments, the disclosed systems can significantly improve the efficiency, functionality and/or durability of heat exchangers in large-scale cooling water systems. Large scale cooling water systems are used in a wide variety of industrial processes, and at their most basic these systems rely on heat transfer from a hotter fluid or gas to a colder fluid or gas, with this heat typically travelling through a “heat transfer surface,” which is often the metallic walls of heat transfer tubing which separate the hot and cold substances. Often, the cooling fluid will comprise water, which in many cases may be salt water drawn from a bay, sea and/or the ocean, fresh water drawn from a river, lake or well/aquifer or wastewater from various sources. Some facilities utilize a one-through or single-pass cooling process, in which cooling water is drawn into the cooling system of the plant and utilized for a single pass through the heat exchangers, and then the heated cooling water is discharged to the environment, while other facilities use cooling water recirculating systems that include a cooling tower, cooling pond, air cooled chiller (if in a region where air cooling is cost effective) or similar heat removal apparatus that seeks to withdraw waste heat from the heated cooling water, allowing this cooling water to be passed back through the heat exchanger multiple times. While recirculating cooling water systems draw less water from outside sources as compared to single pass cooling systems, recirculating systems still typically require significant amounts of “make-up” or replacement water to replenish water lost to evaporation (for open recirculating systems) and “blow-down” or discharge of liquids containing concentrated dissolved solids.

In some cases, a once-through or single pass cooling system can utilize between 20 to 40 times more water to remove an equivalent heat load as a cooling tower system operating with 5 cycles of recirculation. For example, an electrical power generating plant using once-through cooling may withdraw 20,000 to 50,000 gal/MWh produced, while a comparable plant using recirculating cooling may draw only 500 to 1,200 gal/MWh. While the water load for a once-through plant is immense, on the order of 3,500,000 to 8,750,000 gallons per hour to supply a 175 MWh power plant, even recirculating plants still require significant amounts of water, on the order of 87,500 to 210,000 gallons per hour for an equivalent 175 MWh.

Water is a favorable environment for many life forms. In a single-pass cooling system, the water drawn into the cooling plant generally teems with adult and/or juvenile fouling organisms, many of whom will seek to colonize various submerged surfaces. Even for recirculating systems with reduced water intake (as compared to the single-pass systems), any replacement or “make-up” water entering the plant will typically contain numerous living organisms, and the flow characteristics of the recirculating cooling water systems often encourage colonization by sessile organisms to use the circulating supply of food, oxygen and nutrients, and cooling water temperatures may become high enough to support thermophilic populations in various parts of the cooling system. These organisms will often colonize the wetted surfaces of heat transfer tubing, which can significantly reduce heat transfer rates of the cooling system. In many cases, even thin biofilms formed on a heat transfer surface will significantly insulate this surface, reducing its heat transfer efficiency and greatly increasing the overall operating costs for the cooling system.

TABLE 2
Increased Operating Costs Due to Biofouling
Additional Energy Costs Per Year Due to Bio Fouling

| Tons of | Bio Film Thickness (mm) | | | |
|---|---|---|---|---|
| Chiller Capacity | 0.2 | 0.3 | 0.6 | 0.6 |
| 300 | $7,906 | $15,811 | $35,575 | $53,363 |
| 500 | $1,316 | $26,352 | $59,292 | $88,938 |
| 900 | $23,717 | $47,434 | $106,726 | $160,088 |
| 1200 | $31,622 | $63,245 | $142,301 | $213,451 |
| 2000 | $52,704 | $105,408 | $237,168 | $355,752 |

In addition to directly reducing heat transfer efficiency, biofouling also typically causes and/or leads to scaling and/or corrosion on wetted metallic surfaces because, as the biofilm thickens, less oxygen is accessible to the materials of and/or cells next to the tube wall. Bacteria such as sulfate-reducing strains can generate metabolites that attack the metal in a process called microbiologically influenced corrosion (MIC). In studies carried out in the 1980s and early 1990s, it was estimated that the costs of cleaning, fluid treatment, replacement of parts and loss of production due to heat exchanger fouling was approximately 0.25% of the GDP of all industrialized countries. For a process plant, the estimated cost for repairing heat exchangers and boilers was approximately 15% of the maintenance costs of the entire plant, with about half of this value due solely to fouling. In 2016, the Worldwide Corrosion Authority (NACE International) estimated that the global cost of corrosion was 2.5 trillion US Dollars.

In many cooling systems, heat exchanger components are typically overdesigned by at least 70% to 80%, which amount desirably includes compensation for anticipated efficiency reductions of 30% to 50% due to fouling of heat exchange surfaces. In addition to reducing heat transfer, the buildup of fouling can also reduce the cross-sectional area of the tubes or flow channels, which increases the resistance of cooling fluid passing over the heat transfer surfaces. Continued reduced flow can dramatically increase the pressure drop across the heat exchanger, further reducing flow rates and aggravating heat transfer problems (including eventual blocking of the heat exchanger tubing). By controlling and/or ameliorating the effects of biofouling in many of these systems, however, the present systems allow an operator to reduce this required “overdesign” by a significant level, which can result in substantial savings in capital equipment.

Similarly, biofouling which occurs in various elements of recirculating cooling systems, such as the cooling towers, can significantly alter flow distribution and dramatically reduce evaporative cooling rates. Biofouling in these systems may also create undesirable effects, such as oxygen concentrations that increase corrosion rates in the metallic walls of the cooling system, as well as facilitate the growth and distribution of potentially deadly organisms such as Legionella bacteria which live within amoebas.

In various embodiments, biofouling protective system embodiments are disclosed that can significantly reduce the thickness and/or extent of biofouling films formed on heat transfer surfaces of a cooling system, thereby reducing the insulating effects of biofouling and ensuring the maintenance of optimal heat transfer efficiency levels within the cooling system. In some embodiments, the biofouling protective systems described herein may provide fouling protection for the entirety and/or multiple portions of a cooling system, while other embodiments may provide “localized” or particularized protection for specific areas and/or “modules” of the cooling system, such as the wetted heat transfer surfaces of one or more heat exchangers in the cooling system.

In one exemplary embodiment, a biofouling protective system can include an optional biocide impregnated filtration media or “biocide filter” through which some or all of a cooling water flow may pass. Desirably, the filter media can inhibit and/or “filter out” some and/or all of various “larger” fouling organisms, including adult organisms of many fouling species, while the biocide in the filter media will desirably kill, injure and/or inactivate various “smaller” and/or immature fouling organisms. Such inhibition can desirably include inhibition against colonizing wetted surfaces for a limited period of time, such as, for example, the amount of time necessary for a targeted fouling organism to pass through heat exchange tubing and/or the entirety of a cooling water system (in a single-pass cooling system, for example). In various embodiments, the filtration and/or inhibition provided by the optional biocide impregnated filtration medium can induce the formation of a thin, minimal and/or thermo-conductive biofilm on wetted heat transfer surfaces, which will desirably provide an increase in thermal transfer efficiencies and/or the useful life of the heat transfer components as compared to the thermal transfer efficiencies/components of existing heat transfer systems which may be negatively impacted by biofouling. In various alternative embodiments, the filtration and/or inhibition provided by the optional biocide impregnated filtration medium can induce the formation of an easily removeable or reducible biofilm on wetted heat transfer surfaces, which may be removed using less expensive and/or less invasive cleaning methods as compared to existing biofilms.

In various embodiments, the biocide impregnated filtration media will desirably inhibit biofouling growth onto and/or within the filtration media itself, which will greatly enhance the performance, service life and/or serviceability of the filtration media in the disclosed systems. The presence of the biocide will desirably inhibit attachment, settling and/or growth of organisms on the outer and/or inner surfaces of the filter, which can maintain flexibility of the filtration media as well as significantly reduces the chance for ripping, tearing and/or other failure of the filter due to the presence and/or increase in gross weight caused by the fouling organisms. In addition, the presence and distribution of the biocide will further desirably prevent and/or inhibit fouling organisms (especially spores, propulgates, larvae and/or juvenile forms) from attaching, settling and/or growing within the openings and/or “pores” of the filtration media. In many cases, a biocide may have very different levels of effectiveness on adult and juvenile members of the same species, with a significantly higher dosage of a given biocide often required to prevent fouling activities by larger and/or mature organisms as compared to the dosages need to protect against smaller and/or juvenile organisms. By inhibiting the passage of larger organisms through the filtration media, and applying highly effective doses of biocide directly to the smaller organisms as they pass through the biocide coated pores of the filtration media, the present system provides for highly effective fouling protection without requiring highly toxic levels of biocide and/or other system components.

In various embodiments, a significant portion and/or all of the aqueous medium “downstream” of a disclosed biocide filtration device will have desirably passed through one or more biocide impregnated filtration media, while in other embodiments some portion of a fluid flow may have bypassed and/or not been subject to filtration through a biocide impregnated filtration media. For example, a “skirt” or other biofouling protective device may incorporate peripheral “walls” of a biocide impregnated filtration media, while various openings and/or the bottom of the device may be open to the surrounding environment. In such a case, biofouling may still be effective for any protected substrates, because the filtration media present and the effects thereof may still provide some reduction in fouling of protected substrate as compared to an unprotected substrate. In a similar manner, an aqueous flow of water or other liquid may benefit from partial “filtering” of the waterflow through the biofouling protective devices disclosed herein (i.e., which may incorporate one or more filtration units comprising biocide impregnated filtration media), as such filtration can desirably remove and/or inactivate both larger and/or smaller fouling organisms within the filtered water stream, while some amount of eluted biocide within the filtered water stream will mix with the remaining unfiltered water to potentially inhibit the activity of biofouling organisms within areas downstream of the filters. Such “partial filtration” filtration systems may have particular utility in recirculating water streams such as cooling towers and/or the like.

Distribution Mats and Filters

In various embodiments, disclosed are highly effective devices and/or systems for applying and/or “dosing” biocides into a fluid stream to desirably inhibit the attachment, settling and/or growth of biofouling organisms within fluid streams is disclosed herein. In various embodiments, a fabric filtration media is disclosed, the fabric filtration media having a top surface, a bottom surface and a plurality of pores extending through the fabric from the top surface to the bottom surface, with a coating or “paint” containing at least one biocidal or toxic agent applied thereto. In at least one exemplary embodiment, the coating can be applied to the top surface of the fabric, with some portion of the coating passing into and/or or through the pores. If desired, the coating application process can include the application of a suction or vacuum to the bottom surface of the fabric, which desirably can draw some portion of the coating into the pores while desirably maintaining patency (i.e., an “open” condition) of the pore openings through the fabric (i.e., the coating desirably will not “clog” a majority of the pores through the fabric after application thereto). Once the coating dries or otherwise cures to a desired state, the coated fabric can be formed into a desired shape and/or configuration, and then placed into a water stream wherein the fluid passes through the pores of the fabric, wherein amounts of the biocidal and/or toxic agent elutes or is otherwise dispensed into the individual fluid streams passing through the pores. Because the spores, propulgates, larvae and/or juvenile forms of fouling organisms are also passing though these individual pores, these organisms are exposed to a relatively higher dosage of the biocidal and/or toxic agent, which desirably inactivates and/or inhibits their abilities to attach, settle and/or grow within the pores of the filtration media and/or on wetted surfaces further downstream in the fluid flow.

Protective Systems, Filtration Media and Altered Water Regions

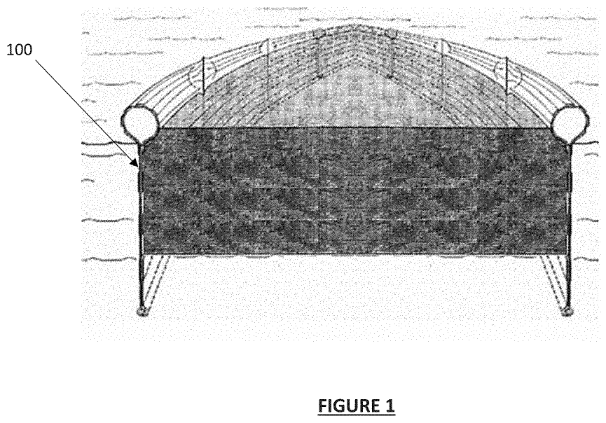

In various embodiments, the disclosed systems and/or system components will desirably alter the natural activity of biofouling organisms on “protected” wetted surfaces, thereby reducing, eliminating and/or altering natural biofouling of the surfaces. FIG. 1 depicts an exemplary kilt or “skirt” enclosure system 100 which can include individual elements for the enclosure such as a plurality of vertically oriented “sheets” or similar structures that can be deployed into the water around an object or portion thereof, with some portion of the sheets extending downward below the object to be protected. If desired, the protective sheets can extend significantly below the upper edge of the skirt, the object and/or the water surface, including in some embodiments to a considerable depth, including 5, 10, 20 or 100 times the depth of the object in the water or more.

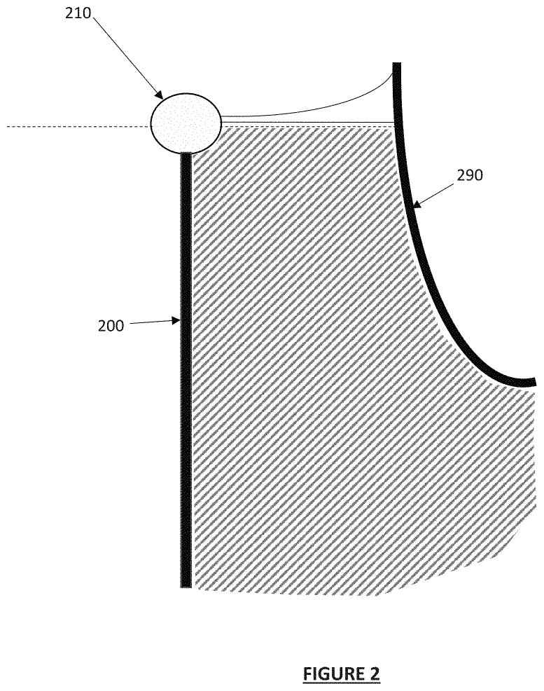

FIG. 2 depicts a partial cross-sectional view of the skirt enclosure system of FIG. 1, with a portion of a protected substrate 290 (i.e., a ship's hull). In this embodiment, a vertical enclosure sheet or wall 200 is shown, which incorporates a floating supporting structure or boom 210 from which it hangs downward into the water column. In various alternative embodiments, the disclosed enclosures and/or other components could be attached directly to one or more surfaces of the protected substrate, its support structure and/or any submerged portions thereof, while in other embodiments the enclosure component could form part of an independent free-flotation system such as oil protection booms and/or fenders (i.e., free floating between the boat hull and the docks and/or between the hull and other floating structures or around the perimeter of an object such as an oil rig, stationary vessel, or seawall).

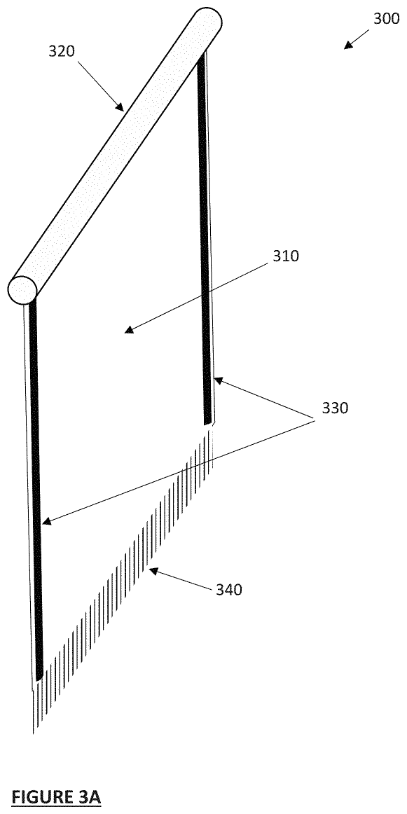

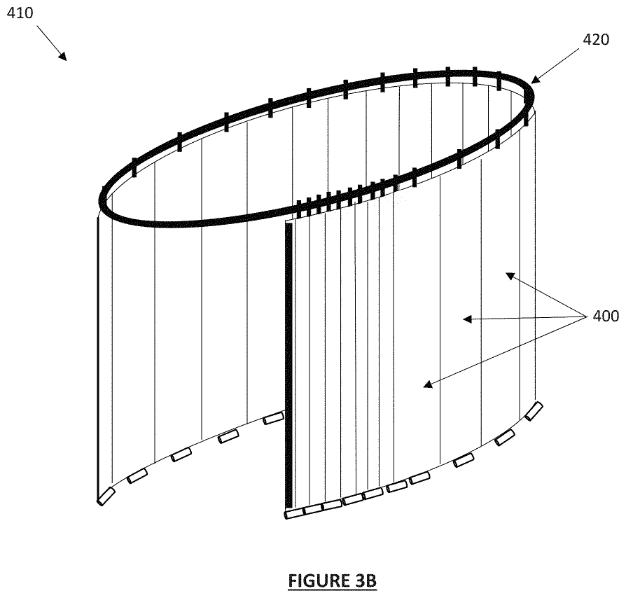

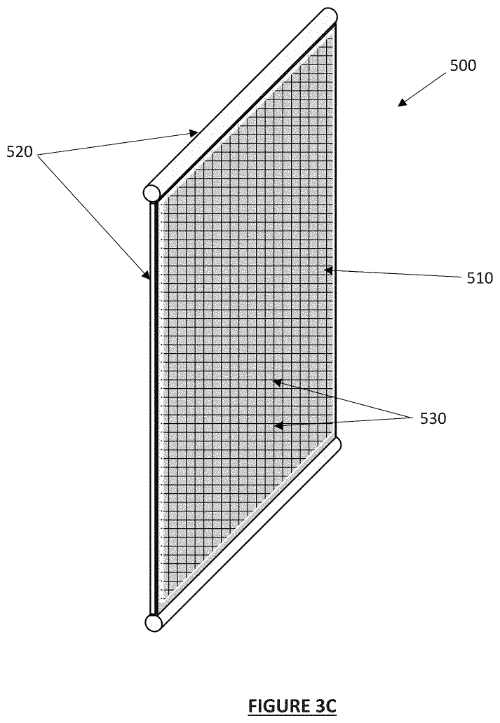

FIG. 3A depicts a perspective view of one exemplary sheet or wall 300, which can be used with the various systems disclosed herein. The sheet can comprise a fabric filtration media 310, which can be secured at a top edge to a support structure 320, which can comprise a flexible and/or rigid support beam. One or both of the sides of the media 310 can include a fastening device 330 such as a Velcro™ connection or hook and loop fasteners, or other fastening structures well known in the art. A bottom edge of the media 310 can include a flexible seal or fringe 340, which may be utilized as a “soft seal” against another object and/or a bottom/seafloor of the aqueous medium.

In various embodiments, a plurality of sheets 400, such as the sheets previously described, can be assembled into a peripheral ring or curtain 410 which surrounds or substantially surrounds a substrate to be protected, such the ring system depicted in FIG. 3B. In this embodiment, the ring 410 may be fully closed or, as depicted, may only be partially closed with one or more openings along the periphery. If desired, the sheets 400 may be slidably secured to a support structure 420, which can allow the ring 410 structure to be peripherally opened and/or closed as desired.

FIG. 3C depicts a perspective view of an exemplary filtration module 500, which can be used with the various systems disclosed herein. The module 500 can comprise a fabric filtration media 510, which can be secured at the outer edges by a support structure 520, which in this embodiment can comprise a flexible and/or rigid outer frame of support beams. In addition, this embodiment desirably can include a reinforcing material 530 which is positioned on a downstream face of the media 510 (which material can be secured to and/or into the frame, if desired), such as an expanded metal or wire mesh, which may stiffen and/or otherwise support the media 510 against the flow forces from the fluid passing therethrough. If desired, the module 500 can be sized and configured to fit into a receiver of a filtration unit, such as a fluid pipe and/or a submerged filtration unit, with said unit(s) optionally including a plurality of filter modules therein (not shown). In some embodiments, the filtration unit may include a plurality of filters in series and/or parallel to the fluid flow, including the use of multiple filters for a single flow of water, if desired.

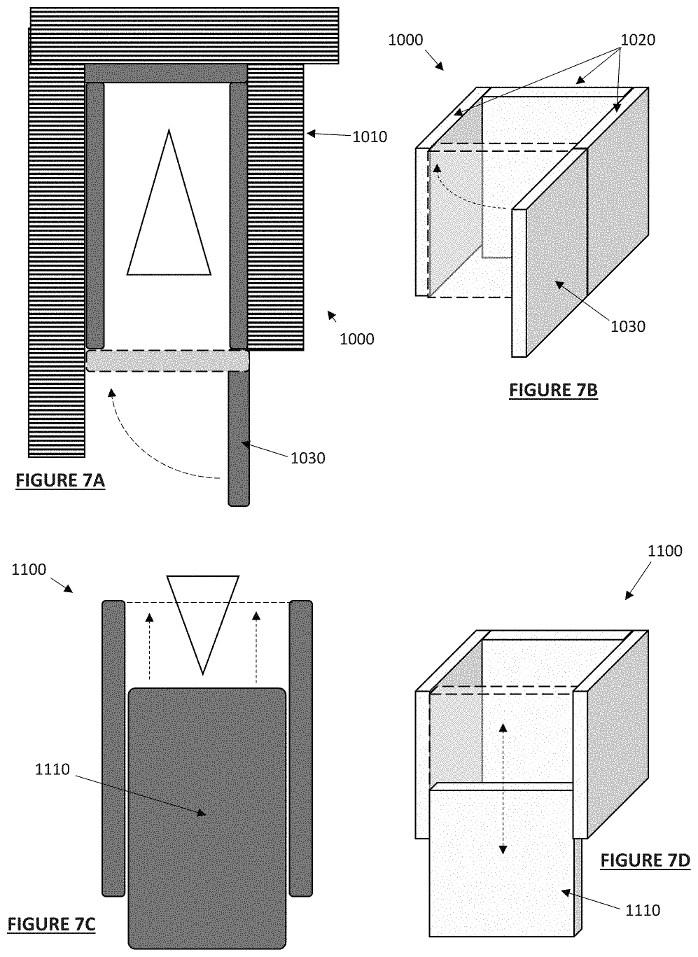

FIG. 3D depicts one exemplary embodiment of a free-floating enclosure 600, wherein the enclosure walls 610 may be supported by floating booms 620 which can encircle or surround the protected vessel (not shown). In various alternative embodiments, the disclosed structures and/or components thereof may be attached directly to and/or hung directly from a dock or boat slip. For example, FIGS. 7A and 7B depict top plan and perspective views of a U-shaped enclosure 1000 which can be positioned within a standard boat slip 1010, with the enclosure walls 1020 connected to the adjacent dock(s) and/or other structures. If desired, a submerged and/or partially submerged door 1030, hanging curtain or other movable wall structure can be provided proximate to the stern of a boat or other substrate to close the open “U” section, which can be opened and/or closed to allow the boat to enter or leave the dock and/or enclosure. If desired, the hanging curtain may comprise an underwater wall of the enclosure which can be swung or rotated away from and/or rotated towards the enclosure (i.e., in a manner similar to opening and/or closing a door), to open and/or close the enclosure to allow a boat or other floating structure to enter and/or leave the enclosure. Alternatively, FIGS. 7C and 7D depict side and perspective views of another U-shaped enclosure 1100 which incorporates a hanging curtain closure 1110, which can include feature that allow the curtain 1110 and/or portions thereof to be raised and/or lowered to allow vessel ingress/egress to/from the enclosure 1100 in a typical manner (i.e., when the curtain section is lowered a sufficient amount the vessel may float in and/or out of the enclosure over the lowered curtain section). As another alternative, one or more sections of an enclosure wall material and/or some or all of the supporting structure(s) (i.e., the support pipe or wire cable support) may be “slid aside” (in a manner similar to opening and/or closing a shower curtain or pulled upward to the surface similar to a venetian blind configuration) to allow entry and/or egress from the enclosure—see FIG. 3B.

In any of the disclosed embodiments, the upper edge of the enclosure walls might be suspended at least one or two feet above the water surface (with the enclosure desirably extending below the water surface a desired degree) such that water and/or wave action would desirably not encroach over the top of the enclosure walls. In various alternative embodiments, the hanging curtain and/or other structures could be mounted to a variety of surfaces, including mounting to the protected substrate itself, to floating structures, to fixed structures, to above-water surfaces, to underwater surfaces and/or on/into the bottom of the body of water and/or subsurface harbor structures and/or seafloor.

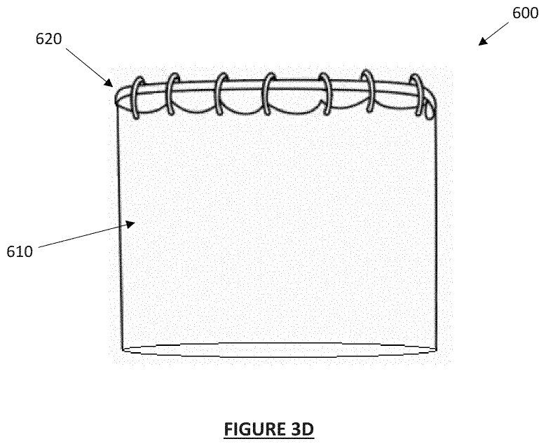

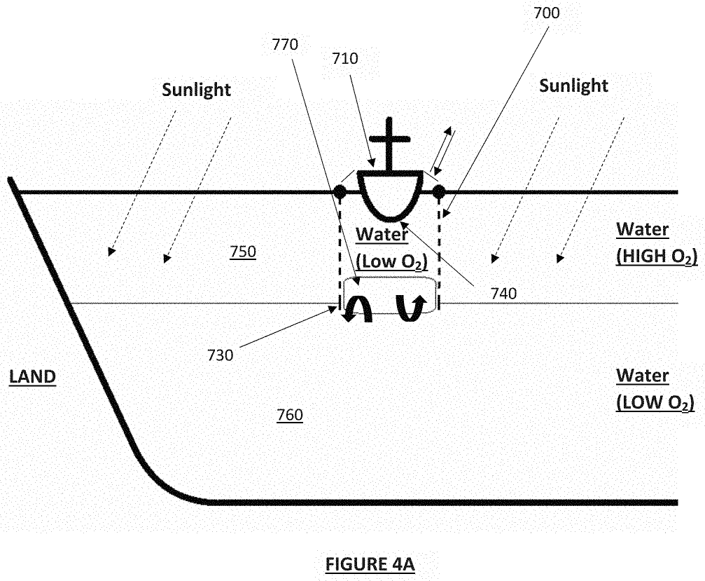

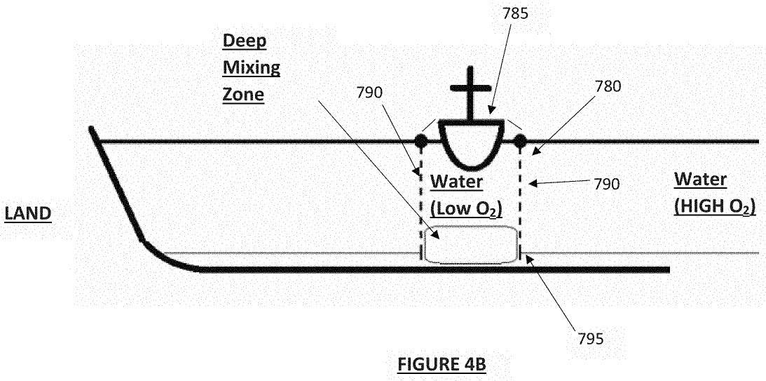

FIG. 4A depicts one exemplary embodiment of a skirt enclosure 700 which is positioned at least partially around a floating object 710 and/or other substrate, with a lower portion or bottom 730 of the enclosure walls 720 extending significantly below a lowest point 740 of the object 710. In this embodiment, the enclosure 700 encompasses an enclosed region of water, wherein the enclosed region is positioned within a first layer 750 of water having a relatively high level of dissolved oxygen or other chemistry factors, and the bottom 730 of the enclosure ending within and/or proximate to a second layer 760 of water, with the second layer having a significantly lower level of dissolved oxygen or other chemistry factors. Desirably, this arrangement can facilitate the creation of a zone of differential chemistry and/or water conditions within/near the enclosure and proximate to the floating object 710, such as an aqueous zone of lowered (but not fully depleted) oxygen levels. In various embodiments, the open bottom of the enclosure may allow some amount of mixing between the enclosed waters and the surrounding environment, but this mixing zone 770 will desirably not significantly affect the conditions of the water zone in proximity to the floating object 710.

FIG. 4B depicts another exemplary embodiment of a skirt enclosure 780 which is positioned at least partially around a floating object 785 and/or other substrate, with a lower portion or bottom 795 of the enclosure walls 790 extending near and/or in contact with a bottom of the body of water and/or subsurface harbor structures and/or seafloor. In some embodiments, this may minimize mixing of enclosure water to a desired level, although direct contact of the enclosure with the seafloor may be less desirable where stronger bottom currents and/or excessive silting may occur, or where undesirable life forms on the seafloor may invade and/or attempt to colonize the enclosure components, while in other embodiments a partial and/or full seal with a bottom surface (i.e., natural and/or artificial surface) maybe desired.

In some embodiments, the disclosed enclosures will desirably provide (1) a barrier to significant levels of oxygen transport through the enclosure sheets, (2) a potential reduction of available energy and/or nutrient supplies within the enclosure for organisms and/or chemical reactions, which may reduce and/or prevent natural photosynthesis or other metabolic processes of microorganisms and/or undesirably chemical reactions from occurring within the enclosure, and/or (3) reduces and/or prevents oxygen and/or other chemicals/elements from diffusing and/or mixing into the enclosed water at the top of the enclosure. Desirably, much of the outside liquid which enters the enclosure at the open and/or partially closed bottom will contain lower concentrations of dissolved oxygen (and/or varying levels of other chemistry constituents) than the unprotected surface liquid levels, with mixing of such waters primarily occurring at depths well below the bottom of the protected item and/or hull. Once the enclosure is in a desired position, the natural biological processes within the enclosure will desirably utilize much of the dissolved oxygen contained in the liquid within the enclosure, thereby significantly lowering the dissolved oxygen levels within the enclosure to levels that may approach anoxic levels, but which desirably do not exceed anoxic levels for extended periods of time (with some level of dissolved oxygen being replenished via the open bottom of the structure and/or through openings and/or perforations in or between the sheet walls of the enclosure).

In various embodiments, the enclosures described herein will desirably induce a differential in the dissolved oxygen levels and/or other water chemistry levels of the enclosed aqueous environment (i.e., within the enclosure as compared to dissolved oxygen levels—or other water chemistry constituent—outside of the enclosure) after a period of at least 1 or 2 hours by at least 10%, by at least 15%, by at least 20%, by at least 25% by at least 50% by at least 70% by at least 90% or greater.

In some embodiments, the vertically oriented sheets or similar structures can desirably extend a sufficient depth into the body of water to exceed the depth of the protected item and/or to reach a region of lower dissolved oxygen concentration and/or even exceed the natural depth of the euphotic zone or a pycnocline, which could include depths of 1 foot, 2 feet, 3 feet, 4 feet, 5 feet, 6 feet, 7 feet, 8 feet, 9 feet, 10, feet, 11 feet, 12 feet, 13 feet, 14 feet, 15 feet, 25 feet, 50 feet, 75 feet, 100 feet, 150 feet, 200 feet, 500 feet, 1,000 feet and/or greater depths, depending upon the relevant body of water or other aqueous medium. Alternatively, the vertically oriented sheets or similar structures may extend to a depth proximate to the floor of a harbor or other bottom feature (See FIG. 4B), or may even touch the bottom of the body of water, if desired. As another alternative, the vertically oriented sheets or similar structures may extend to a depth where the dissolved oxygen levels (i.e., in percentages and/or absolute dissolved oxygen levels) or other water chemistry component(s) are significantly lower than those near the surface of the water, such as reductions of 30%, 40%, 50%, 60%, 70%, 80% and/or 90% or greater of the dissolved oxygen or other components as compared to the dissolved oxygen levels or other components of shallower waters in the same vicinity. In various embodiments, the bottom portion of the vertically oriented sheets can include fenestrations, slits, fringes and/or perforations that may inhibit, but not completely prevent, the flow of water into and/or out of a space between the bottom of the enclosure and the seafloor.

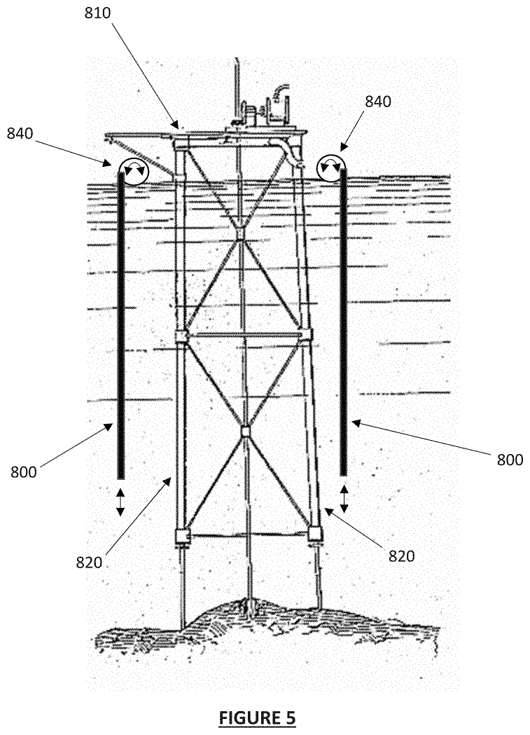

FIG. 5 depicts one exemplary embodiment of a skirt or peripheral enclosure placed about an offshore oil platform 810 that desirably reduces and/or eliminates biofouling around various portions of the support structures or “legs” 820 of the platform. In this embodiment, the enclosure walls 800 are deployed around much of the perimeter of the entire support structure, and extend vertically downward into the water from drum-type dispensers or “floats” 840 (or could be fixed to the platform directly and/or legs), wherein the depth of the enclosure wall(s) can be increased and/or decreased as desired. Desirably, the enclosure walls will fully and/or partially encircle the platform supports (which could include surrounding individual support legs with individual enclosures or the entire support structure in a single enclosure), and will be extended to a sufficient depth to induce desired water chemistry changes in portions of the enclosed water body, including proximate to the shallower portions and/or surface of the enclosed water body. If desired, one or more of the enclosure walls can be raised or lowered as desired, which can induce desired changes in the water chemistry if such chemistry is being monitored (i.e., about the rig or at a remote monitoring station, for example). In a similar manner, one or more openings, partitions and/or partitions in or between enclosure walls can be opened and/or closed, as desired, to desirably alter water chemistry in a desired manner.

In various embodiments, the enclosure can include features to partially and/or fully close the bottom and/or top of the enclosure, which could include closeable and/or openable features such as Velcro or hook and loop fastener components, zippers, magnetic closures and/or cross-stitched features. Similar connection types could be utilized to connect the side edges of individual sheets together around the protected object). In at least one possible embodiment, the enclosure may include features that partially and/or fully “seal” some portion(s) of the enclosure against other objects such as seawalls, hull components, larger vessel hulls, submerged structures and/or the bottom surface/mud of the seafloor. In other embodiments, the enclosure may desirably include sufficient depth to provide the biofouling protections described herein, but will be shallow enough to avoid touching the bottom of the aqueous medium during low tide (i.e., lengths of 3 feet, 6 foot, 9 foot, 12 foot and 17 foot depths down into the water, for example).

It should be understood that “enclosing” and/or “partially enclosing” a substrate as described herein may also include partially enclosing the substrate with an enclosure to a sufficient degree to induce some and/or all of the desired water chemistry changes in proximity to the protected substrate, including enclosures that may not fully seal or isolate the substrate from the surrounding aqueous or other environments. For example, an enclosure that protects the hull or other submerged portions of a boat or ship may be considered to “enclose” the hull as described herein, even where the enclosure only encompasses some or all of the underwater portions of the hull and portions of the enclosure may be open to the surrounding air (i.e., open to the “above water” environment) or open towards other objects such as wood structures, rock walls, solid metal sheets, etc. In a similar manner, an enclosure having various breaks, openings, seams, cracks, tears and/or missing wall elements therein may be considered to “enclose” the substrate as described herein where there is sufficient enclosure structure to desirably induce some and/or all of the desired water chemistry changes to occur in proximity to the enclosure and/or protected substrate (with such chemistry changes possibly occurring naturally within the enclosure, and/or due to some additive or modifier that may react, absorb and/or release something to alter the water chemistry artificially, or various combinations of both), thereby protecting the enclosure and/or substrate from biofouling and/or reducing the amount of biofouling of the enclosure/substrate to an acceptable level and/or inducing the formation of a desired biofilm on the substrate as described herein.

It at least one exemplary embodiment, an enclosure may desirably include an upper surface that is open to the surrounding atmospheric environment. In this embodiment, the aqueous medium may desirably freely mix with and/or evaporate into the atmosphere, which may be particularly useful in evaporative cooling applications such as cooling ponds and/or cooling towers.

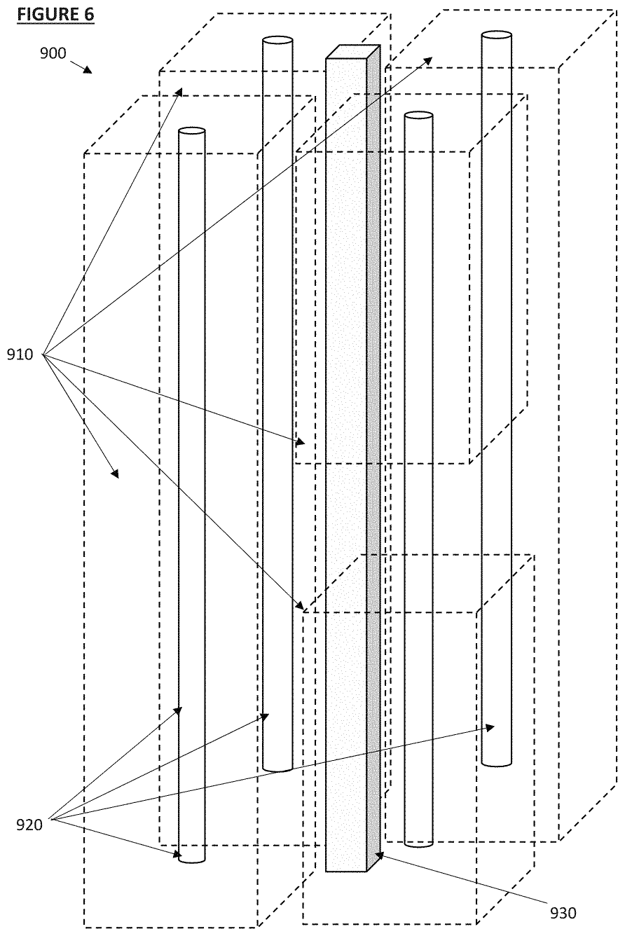

FIG. 6 depicts another exemplary embodiment of a biofouling protection system 900 wherein a plurality of enclosures and/or partial enclosures 910 can be positioned around the various support legs 920 of an oceanic oil drilling platform. In this embodiment there are enclosures shown positioned about each of the support legs, and these enclosures desirably protect the support legs from the effects of biofouling as described herein. In addition, the various enclosures may desirably provide some level of biofouling protection to the central drilling tube 930 (i.e., the centrally positioned square tube) which may not be directly protected by an enclosure, but wherein the combined effects of the various modular enclosures positioned in discrete areas of the platform, when combined, may provide protection to areas outside of the enclosures (i.e., a “Rubik's cube” protection system). This design can form a type of “tortuous path” protective system for substrates, will may desirably segment together a plurality of cubes, cylinders, squares and/or rectangles (or other shapes) to encompass some or all of the support structures and/or water underneath the structure, especially in situations where the structure may be too large or too widely distributed and/or where the environment is inhospitable for placement of a single protective enclosure protecting the entire structure (i.e., in the North Sea). Where a single enclosure may not be adequate and/or feasible, it may be desirable to “break” the enclosure into individual sections, wherein the individual sections may be better controlled and/or even spaced apart, to potentially allow for biofouling control of the larger areas the segments encompass (as well as potentially protect substrates positioned between sections that may not be located inside of any section). In some embodiments, natural and/or manmade features such shorelines, harbor bottoms, quay walls, piers and/or other submerged structures may form part of the tortuous or “maze-like” path in the biofouling protection system.

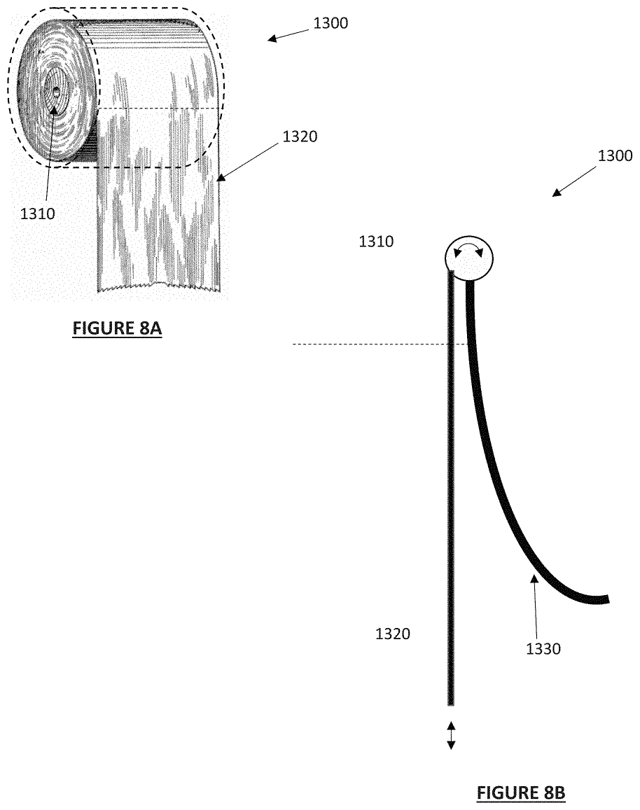

FIGS. 8A and 8B depict components of a biofouling protective system that include a plurality of deployable “roller” sheets 1300, each roller sheet including a storage roll 1310 and a deployable flexible sheet 1320, where the flexible sheet 1320 can be unrolled from the storage roll 1310 and extended downward (i.e., desirably under the force of gravity in some embodiments). In various embodiments, the storage roll 1310 can include a buoyant member (for example, a buoyant Styrofoam™ center tube) which desirably floats in the aqueous medium, while in other embodiments the storage roll 1310 may be attached to a support mechanism or similar structure (not shown). In various embodiments, a plurality of such deployable “roller” sheets could be provided around a periphery of a substrate 1330, with some or all of the flexible sheets deployed to create a partial and/or full skirt or biofouling protective enclosure, as described herein. If desired, the various roller sheets can be deployed to a desire depth below the water surface, which may include deployment of different sheets to differing depths for a variety of reasons, including to accommodate an irregular and/or uneven bottom surface, to accommodate changing water conditions and/or for any other reasons. If desired, the sheets could include attachment mechanisms to allow attachment of adjacent sheets to each other.

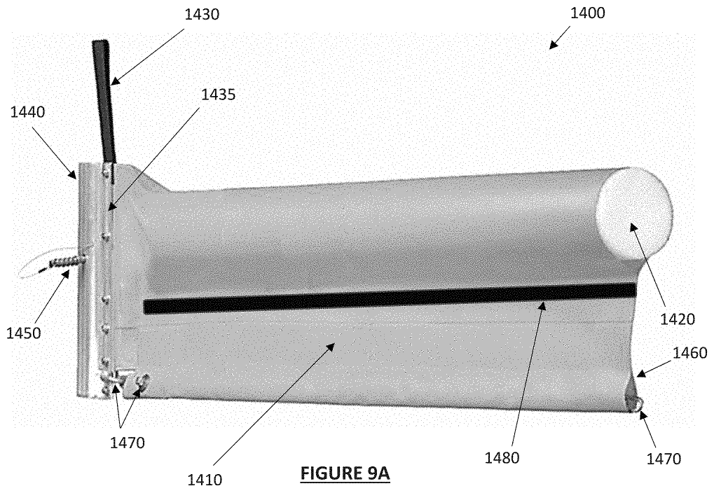

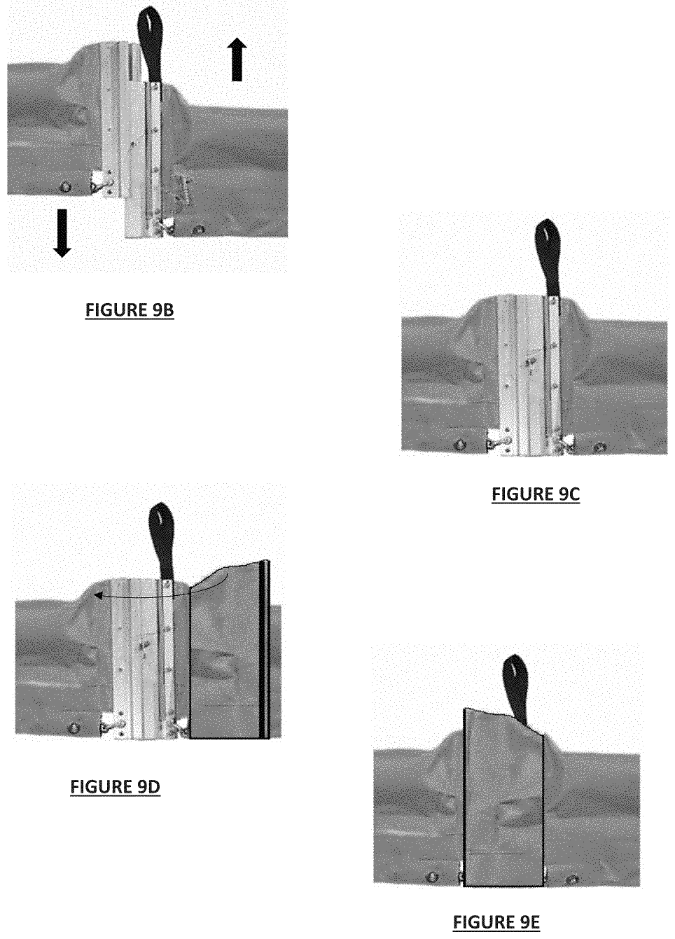

FIG. 9A depicts another exemplary embodiment of a biofouling protective system component 1400, comprising a fabric skirt section 1410 having an upper edge that substantially surrounds and attaches around a buoyant tube or float 1420. The fabric skirt section 1410 can further include a lift handle or anchor 1430, with a reinforcement strip 1435 and a slide connector 1440 on at least one side edge. The slide connector 1440 can desirably include an appropriate connector for connecting with adjacent skirt sections (see FIGS. 9B and 9C) such as a slidable tongue in groove arrangement, as known in the art The slide connector 1440 can also include a removeable and replaceable pin or stop 1450, allowing the slide connector to be locked in a desired position and/or prevent inadvertent dislodging of adjacent components by wind and/or wave action. Desirably, the skirt section 1410 can further include one or more tubular fabric sections 1460, which can accommodate connectors and/or weights 1470 such as rope or chain weights positioned below the float 1420 and/or between adjacent fabric sections, which can ensure proper orientation of the components and also significantly increase the strength and/or stability of the final assembled system. In various embodiments, the skirt section may include a closeable flap that provides protection for the connection to adjacent boom segments (see FIGS. 9D and 9E). If desired, a plurality of securement strips, hook and loop connectors and/or Velcro™ strips 1480 can be provided that allow the fabric skirt section 1410 to be secured around the float 1420 in a desired manner.

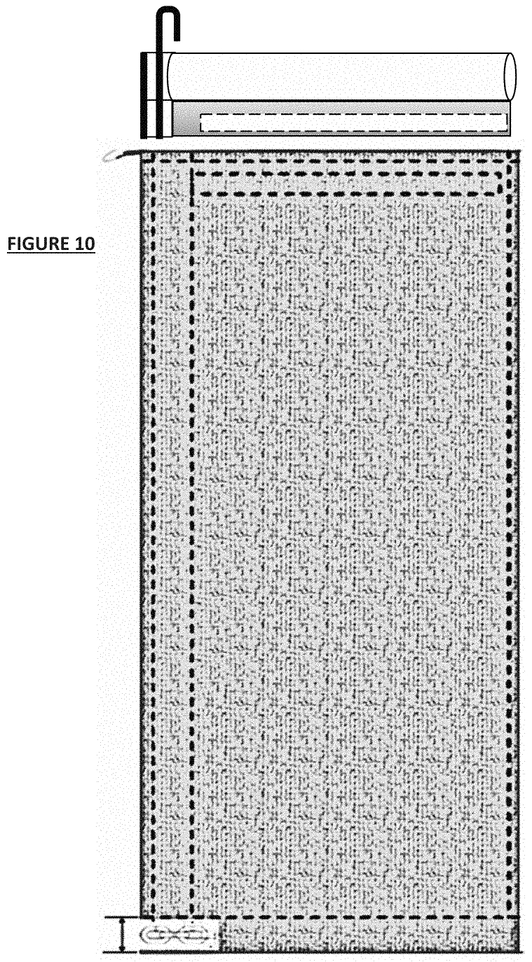

In at least one alternative embodiment, various components of a biofouling system could be attachable to a commercially available floating boom system, such as the American Marine PIG Super Swamp Boom (BOM 100) (commercially available from New Pig Corporation of Tipton, Pa., USA). In this embodiment, shown in FIG. 10, a coated fabric sheet 1500 (which may optionally be coated with a biocide containing formula) can be attached to an existing floating boom system 1510 by hook and loop-type fasteners or similar arrangements, with the sheet 1500 including various flaps 1520 and/or closures 1530 which desirably allow the fabric sheet to be positioned over various locations of the boom system 1510 that are currently prone to biofouling. In this embodiment, the fabric sheet 1500 can comprise a coated and/or impregnated fabric, such as the various fabric constructions described herein. If desired, one or more of the fabric sheets could be removeable from the boom system to allow repair and/or replacement of an individual sheet or boom section, and then replaced to facilitate continued functioning of the biofouling protective system.

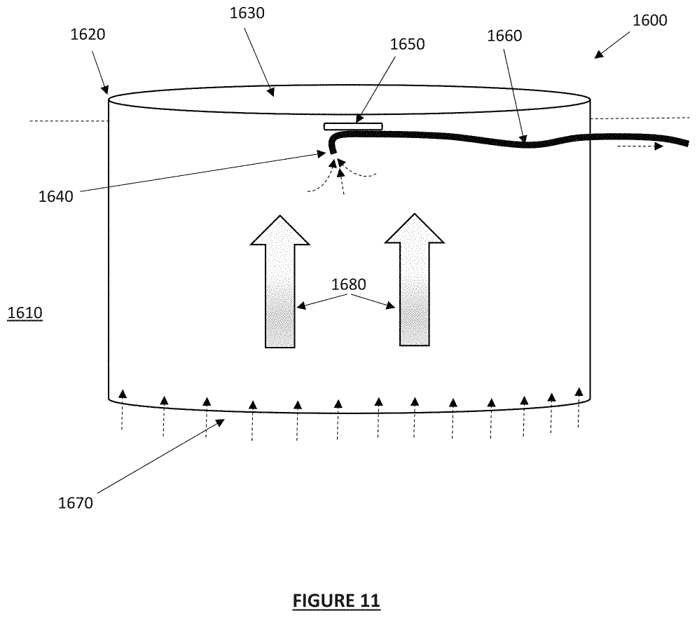

FIG. 11 depicts another exemplary embodiment of a skirt-type enclosure, which may have particular utility as an anti-biofouling and/or filtering system for systems that use sea and/or fresh water as a source of cooling water. In this embodiment, a floating enclosure 1600 or “reservoir” in the aqueous environment 1610 is provided, with the enclosure having one or more peripheral walls 1620 what can encompass a significantly larger amount of aqueous fluid than is required by the cooling system on a normal use basis. For example, if the cooling system demands 1000 gallons of water per minute during normal operations, then the reservoir could desirably encompass at least 10,000 gallons, at least 20,000 gallons, at least 50,000 gallons, at least 100,000 gallons, at least 500,000 gallons and/or at least 1,000,000 gallons and/or more of water. An optional top cover 1630 can be provided, if desired, to isolate the enclosed water from the atmosphere, such as by using a flexible non-permeable membrane or plastic tarp material. A water inlet 1640 may be positioned near a top, center location in the reservoir, with the inlet supported by a float 1650 or other support, with connected flexible or rigid water piping 1660 which carries water drawn from the inlet 1640 (which may have a relatively low—but desirably not anoxic—dissolved oxygen level or other desired water chemistry factor level in various embodiments) for transfer to cooling equipment or other uses. Desirably, water having a relatively higher dissolved oxygen level can enter the reservoir through the bottom 1670 and or any side openings or gaps of the reservoir. During the time it takes for the water molecules to transit up and/or across the water column within the reservoir, natural and/or artificial oxygen scavengers within the water column will desirably reduce the dissolved oxygen level in the water (as depicted by gradient arrows 1680), such that the dissolved oxygen level is depleted prior to traveling into the inlet. In at least one alternative embodiment, however, the water inlet may be near the bottom of the enclosure and/or the bottom surface of the reservoir, which is generally the coldest water within the enclosure/reservoir for use in cooling equipment.

As previously noted, at least one exemplary embodiment includes a method for determining an appropriate design, size, shape and/or other features of the of enclosure can be utilized to determine a recommended minimum enclosed volume and/or water exchange rate to desirably reduce and/or eliminate biofouling within the enclosure. In some embodiments, such as in a membrane filter configuration, where the enclosure may be utilized to provide a cooling water source and/or other source water for a manufacturing plant (i.e., a power plant, a desalination plant, a refinery and/or other manufacturing facility), the disclosed methods can potentially be utilized to reduce and/or eliminate biofouling within the water and/or other conduits of the plant, and in some embodiments without the need for additional filtration and/or microfiltration of the water.

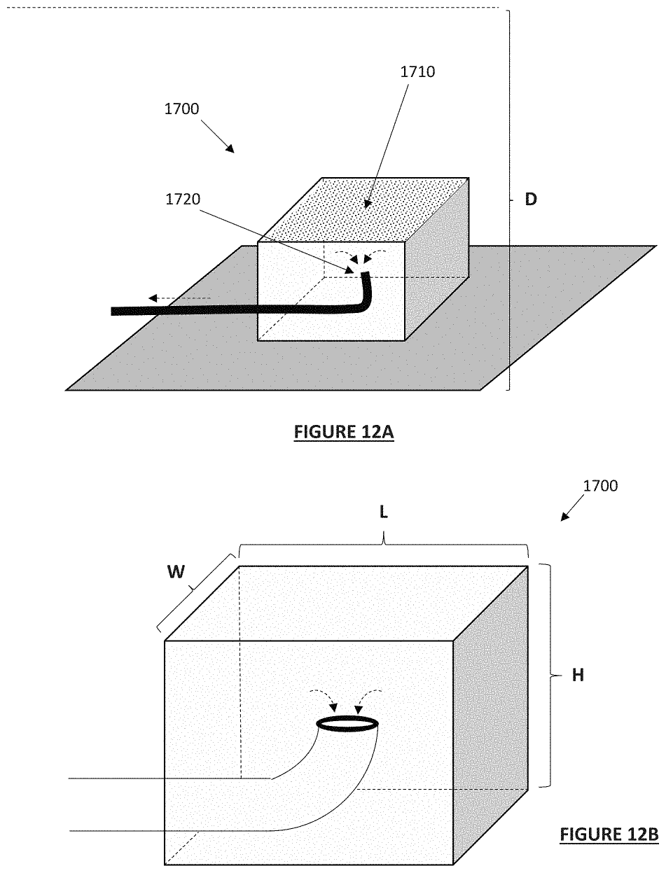

FIGS. 12A and 12B depict another exemplary embodiment of an enclosure 1700 that can be utilized to reduce biofouling and facilitate the utilization of seawater, fresh water, brackish water, or some other aqueous liquid by a manufacturing plant, a power plant or some other facility. In this embodiment, the enclosure 1700 can be positioned within a body of water and may even be fully submerged within the aqueous environment (i.e., an underwater “lanai”) to a depth “D”, such as shown in FIG. 12A. The enclosure can include one or more replaceable impregnated fabric filtration media 1710 on one or more of the outer surfaces, with a water suction pipe or other inlet device 1720 positioned within the enclosure 1700, and when water is drawn into the suction device a flow of replacement water can enter the enclosure through the media 1710 and/or any other openings and/or perforations in and/or between the walls of the enclosure (which may include the ceiling, side walls and/or floor surfaces of the enclosure).

In some embodiments, the volume of the enclosure may be sufficiently large to contain a significant reservoir of liquid, such that the liquid can remain within the enclosure for a desired “dwell time” to allow the desired water chemistry changes to occur to reduce and/or eliminate biofouling from occurring within the enclosure and/or the facility's water piping. In some other embodiments, the volume of the enclosure may be smaller and may not contain a significantly large reservoir of liquid (as compared to the anticipated flow rate into the inlet during use), in which embodiments the liquid may not remain within the enclosure for a desired “dwell time” to allow the desired water chemistry changes, but may rather primarily rely on the filtration and/or optional biocide application through the filtration media to desirably reduce and/or eliminate biofouling from occurring within the enclosure and/or the facility's water piping and/or heat transfer surfaces.

In various desired embodiments, a fully submerged enclosure may particularly useful where the enclosure retains and/or draws water from a lower or lowest point within the water column, which may be colder water (i.e., useful as industrial cooling water) and/or which may contain lower and/or the lowest levels of dissolved oxygen (or other desirable water chemistry factors) within the body of water.

In various embodiments, an enclosure design may desirably encompass a volume of water that equals or exceeds the daily (i.e., 24 hour) water use for the facility. For example, where a facility utilizes 100,000 gallons of cooling water per hour over a 24-hour period, one preferred enclosure design would encompass at least 2.4 million gallons of water. Assuming that 1 cubic foot of seawater contains approximately 7.48 gallons, one preferred enclosure design could encompass approximately 321,000 cubic feet, which could be an enclosure with a contained volume of approximately 113 feet wide by 113 feet long by 26 feet high (i.e., 331,994 cu ft). In other preferred embodiments, the volume of contained water may be sufficient to supply at least 8 hours of water usage, while still other preferred embodiments may provide 2 or more days of water usage. Desirably water present in the enclosure will desirably be granted a sufficient “dwell” time to alter the water chemistry in a desired manner (as previously disclosed) so as to create “conditioned” water of some type, which may include situations where the entire water needs for a given installation may be provided by the “conditioned” water, as well as situations where only a portion of a given installation's water needs may be provided by the “conditioned” water.

In some alternative embodiments, it may be desirous to modify an existing body of water to include various features of the present enclosures, such as where a natural or artificial water source is being utilized to provide water for cooling and/or some other industrial processes. For example, energy generating facilities will often utilize between 300,000 to 500,000 gallons of water (or more) per minute to cool the generating units, while a typical large petroleum refining plant may utilize 350,000 to 400,000 gallons per minute. In such cases it may not be economical, practical and/or desirable to construct a single enclosure or series of enclosures that contain a full day's worth of water usage. Rather, various embodiments that incorporate “partial” enclosures and/or enclosure components described herein (i.e., vertical sheets and/or skirts) may be utilized to create a tortuous path for the water within the existing natural and/or artificial reservoir to condition the water to meet a desired water chemistry level, and may include features that expose the surface of the flowing water to the atmosphere to promote evaporating cooling of the water reservoir and/or turbulent mixing of the water along the tortuous flow path.

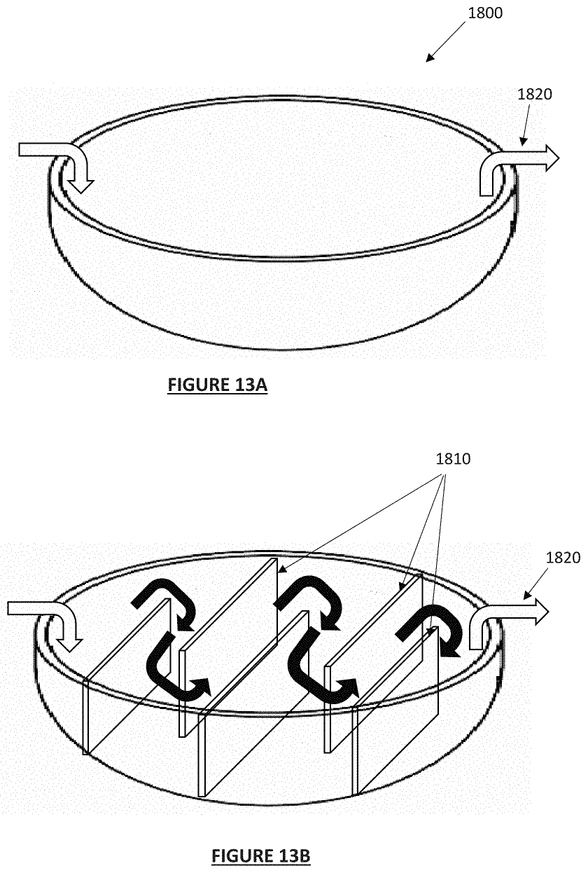

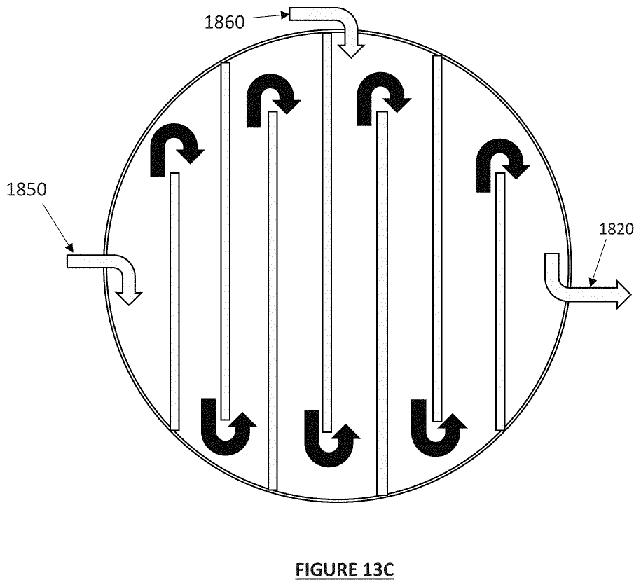

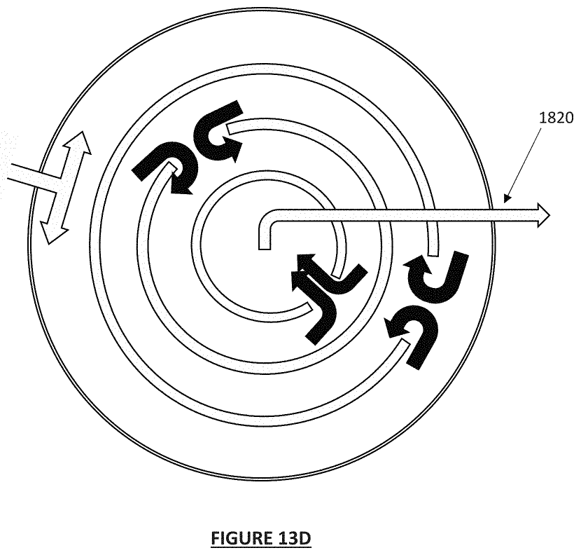

FIG. 13A depicts a simplified perspective view of one exemplary embodiment of a natural or artificial reservoir or pond 1800, which could encompass a water source for once-through cooling as well as a recirculating water reservoir or “cooling pond” often used in recirculating cooling systems. As best seen in FIGS. 13B and 13C, a biofouling protection system can include a plurality of enclosure walls 1810 which are positioned within the pond 1800 to desirably create a labyrinth or tortuous path for the aqueous liquid within a body of water, such as by positioning the series of alternating walls 1810 within the water basin, pond or harbor that alters the natural from of the fluid towards an inlet 1820. In this embodiment, the walls 1810 can desirably redirect the liquid along a desired path or paths, thereby potentially increasing the effective length and/or shape of a desired water “path”, which may allow the water to be “conditioned” in a desired manner to obtain various of the disclosed improvements herein. For example, water passing through such a tortuous path could be granted a sufficient “dwell” time to alter water chemistry in a desired manner so as to create “conditioned” water of some type, which may include situations where the entire water needs for a given installation may be provided by the “conditioned” water, as well as situations where only a portions of a given installation's water needs may be provided by the “conditioned” water. If desired, different “streams” of water may be treated in different matters by the present invention, such as in the embodiment of FIG. 13C, in which a first stream of water 1850 passes through an entirety of the labyrinth to the inlet 1820, while a second stream of water 1860 is added to a location of the labyrinth where it only travels through half of the labyrinth to the inlet 1820. Such an arrangement may include water from varying sources which is added directly to conditioned water within an enclosure.

Another alternative arrangement of a labyrinth path is shown in FIG. 13D, wherein a series of circular enclosures are employed to create a tortuous path towards the center of the reservoir where the inlet 1820 is located, from which the water can then be removed for as previously described.

If desired, an enclosure and/or other system design may incorporate one or more flowpaths for the aqueous fluid that gradually increase in width and/or volume, with the water flow getting larger and larger in cross-section as it approaches a water intake, which may be a particularly useful design feature in natural reservoirs and/or artificial tributaries or rivers to provide additional dwell time and/or more surface area for the flowing water.

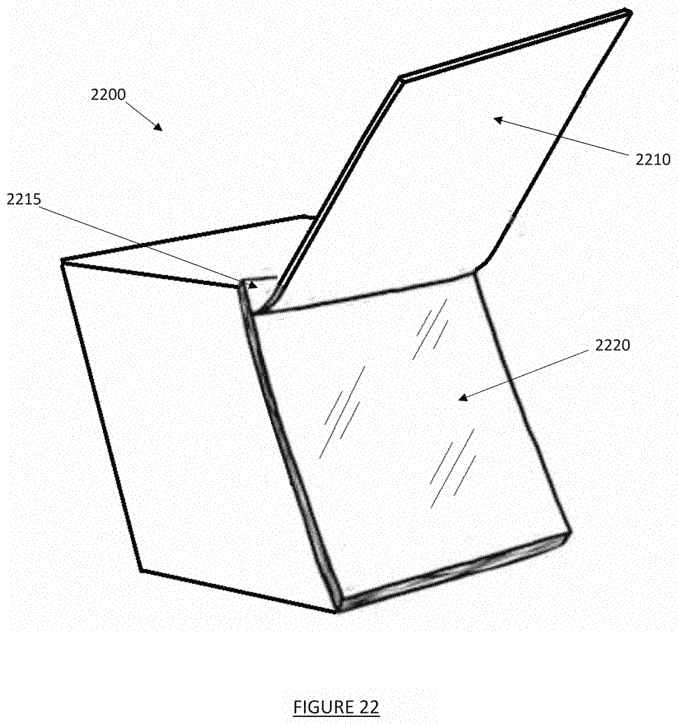

FIG. 22 depicts a perspective view of another exemplary embodiment of an enclosure 2200 for protecting a substrate from biofouling that incorporates a wall structure having a plurality of layers, which could include wall structures incorporating multiple layers having the same, similar or differing permeabilities in each layer, same, similar or different materials in each layer and/or same, similar or differing thicknesses in each layer. In another embodiment, layers may be spaced with minimal or no distance of spacing between each layer or a significant distance of spacing between each layer. If desired, a first overlayer 2210 could be removable, with removal of the first overlayer (which may include a “tear away” or other type of connection section 2215) the revealing an intact second underlayer 2220, and removal of the second underlayer revealing an intact third underlayer (not shown), etc., all surrounding the protected substrate. If desired, a first overlayer could be removable, with the remaining underlayer(s) left intact about the substrate, and then a replacement first overlayer could be positioned around the intact underlayer(s) and/or substrate, such as where the first overlayer may become sufficiently fouled to justify removal and/or replacement. Alternatively, the multiple over and/or underlayers could comprise a plurality of sacrificial layers, with each layer removed as it becomes sufficiently fouled, revealing a virgin or semi-virgin layer below (i.e., still surrounding and protecting the substrate). In some embodiments, the underlayers could remain in position about a substrate for an extended period of time, even 1, 2, 3, 4 and/or 5 years or more, with periodic removal, replacement, and/or refreshing of the exterior layer about the substrate and/or underlayer(s) as previously described (i.e., removal of a fouled layer and immediate and/or delayed replacement with a new overlayer). Such a system could have applications in salt, fresh and/or brackish water, if desired.

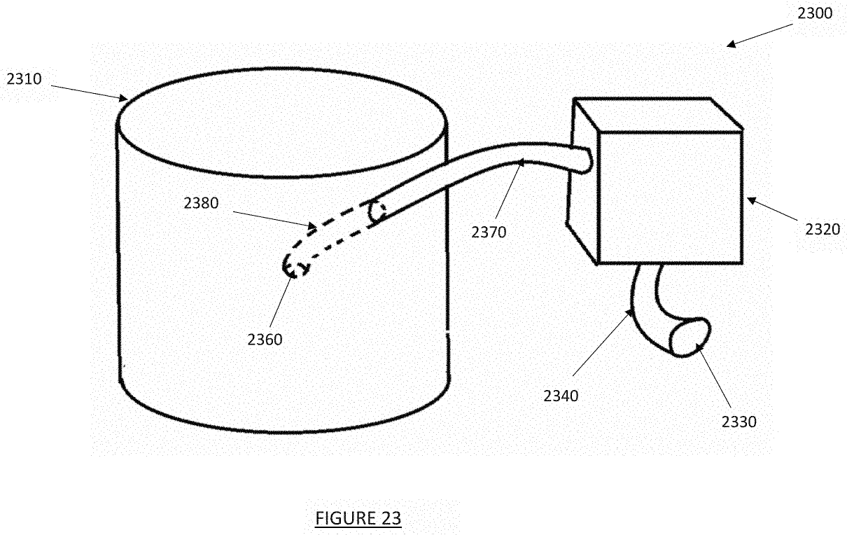

FIG. 23 depicts one exemplary embodiment of an aqueous flow mechanism of a supplemental pumping system 2300 for adding and/or removing aqueous liquids and/or other materials or substances to/from the enclosed environment within an enclosure 2310. In this embodiment, the enclosure includes an outer wall or boundary, which in some embodiments may comprise one or more permeable walls, and in other embodiments may comprise one or more semi-permeable and/or non-permeable walls (which in some embodiments may include some or all walls of the enclosure being non-permeable). A pumping mechanism 2320 with a flow cavity or intake 2330 and intake tube 2340 can be provided, with the pump further including an outlet 2360 and outlet tube or flow cavity or flow path tube 2370 extending from an outlet of the pump, through at least one wall of the enclosure, and through/into the aqueous environment within the enclosure. In various embodiments, at least some flow cavity portion 2380 of the outlet tube can extend some distance within the enclosure, with the outlet potentially positioned proximate and/or distal from a protected substrate (not shown) and/or one or more enclosure walls of the enclosure. During use, the pumping mechanism may be activated to supply outside water into the enclosure in a desired manner, and/or the pump operation may be reversed to draw water from the enclosure to be released in the environment outside of the enclosure. Alternatively, the pumping mechanism could be utilized to supply additional oxygen or other water chemistry factors to the enclosed environment. If desired, some or all of the pumping mechanism and/or flow cavity and/or intake 2330 could be positioned within the enclosure, or alternatively within and/or through some portion of the enclosure walls, or could be positioned outside of the enclosure, if desired. In another embodiment, the aqueous flow mechanism may be a propeller system, petal system, flow pipes, flow canals, or flow tunnels that may be used in a similar manner to move water or create desired flow characteristics as the pump system.

In various embodiment, enclosure designs can incorporate permeable walls of varying configuration, including (1) an enclosure that fully enclose a substrate (i.e., a “box” or “flexible bag” enclosure), (2) an enclosure having lateral walls that surround a periphery of a substrate (i.e., a “skirt” or “drape” that encloses the sides of the substrate, but which may have an open top and/or bottom), (3) an enclosure formed from modular walls that can be assembled around the substrate, which may incorporate various openings and/or missing modular sections (i.e., an “open geodesic dome” enclosure), (4) an enclosure that surrounds only a submerged portion of the substrate (i.e., a “floating bag” enclosure with open top), and/or (5) an enclosure that protects only a single side of a substrate (i.e., a “drape” enclosure), as well as many other potential enclosure designs. In addition, the enclosure walls could be relatively smooth or flat or curved and/or continuous, or the enclosure walls could comprise much more complex structures such as undulating surfaces, corrugated or accordion-like surfaces, folded, “crumpled” or “scrunched” surfaces and/or other features which can dramatically increase the surface area and/or potentially alter a filtering ability of the enclosure walls, if desired.

In various embodiments, an enclosure can incorporate one or more walls which comprise a 3-dimensional flexible filtering fabric including fibrous filaments and having an average base filament diameter of about 6 mils or less (i.e., 0.1524 millimeters or less). In various alternative embodiments, an enclosure material could comprise textured polyesters. In addition, a natural fiber material such as 80×80 burlap might be useful in protecting the substrate as an enclosure material, even if the natural material degrades relatively quickly in the aqueous environment and the underlying degradation process contributes to a significant measurable pH difference within the enclosure, which may be useful in various aqueous environments. If desired, various enclosure embodiments could incorporate degradable and/or hydrolysable materials and/or linkages (i.e., between components and/or along the polymer chains of the component materials) that allow the enclosure components to degrade after a certain time in the aqueous medium.

In various embodiments, the devices of the present invention will desirably provide a reduction, cessation and/or reversal of biofouling and/or the creation of a desired enclosed environment that deters settling of biofouling organisms and/or that is conducive to formation of a desired anti-fouling layer and/or biofilm on the substrate—i.e., initiating the creation of a desired local aquatic environment (i.e., the “differentiated environment”) upon being deployed to influence the formation of an advantageous biofilm which results in decreased biofouling on the protected substrate or article. In various embodiments, this “differentiated environment” may be created within minutes or hours of enclosure deployment about a substrate, while in other embodiments it may take days, weeks or even months to create a desired “differentiated environment.” If desired, an enclosure may be deployed long before a substrate is placed therein, while in other embodiments the enclosure can be deployed concurrently with the substrate or the enclosure can be deployed long after the substrate has been immersed and/or maintained in the aqueous environment. In various embodiments, the creation of significant water chemistry differences and/or other unique aspects of the differentiated environment may begin immediately upon deployment or may be created within 1 hour of the enclosure being placed in the aqueous environment (which could include the enclosure being placed alone in the environment and/or in proximity to the substrate to be protected), while in other embodiments the initiation and/or creation of a desired differentiated environment (which may include creation of the complete differentiated environment as well as creation of various fouling inhibiting conditions which may alter and/or be supplemented as further aspects of the differentiated environment are induced) may require the enclosure to be in place about the substrate for at least 2 hours, at least 3 hours, at least 6 hours, at least 12 hours, at least 18 hours, at least 1 day at least 2 days, at least 3 days, at least 4 days, at least 5 days, at least 6 days, at least 1 week, at least 2 weeks, at least 3 weeks, at least 4 weeks, at least a month, at least 2 months, at least 3 months and/or at least 6 months or longer. In various embodiments, the various water chemistry differences which may be created in these various time periods may include dissolved oxygen, pH, total dissolved nitrogen, ammonium, ammoniacal nitrogen, nitrates, nitrites, orthophosphates, total dissolved phosphates, silica, salinity, temperature, turbidity, chlorophyll, etc.), the various concentrations of which may increase and/or decrease at differing times, including differing concentrations of individual constituents at different durations of enclosure immersion.

In some cases, the devices and/or components thereof of the present invention may degrade and/or no longer provide a desired level of antifouling and/or environment creating effects after a certain period of time. In various embodiments, the amount of time until the enclosure loses its antifouling affect can vary based on numerous factors, including the particular aquatic environment, the season, the temperature, the makeup of marine organisms present, temperature, light, salinity, wind, water speed, etc. It should be noted that, based on the conditions of the aquatic environment, the enclosure may temporarily lose antifouling and/or environment creating effects, only to regain its antifouling/environment creating effect(s) when the conditions return to normal or to some desired measure. “Useful life,” as used herein, can mean the amount of time from the deployment of the enclosure to the time when the level of macro-fouling becomes problematic on the substrate, while “enclosure life” can mean the amount of time the enclosure itself remains physically intact and effective around the substrate itself (which may be exceeded by the “useful life” of the biofouling protection provided by the enclosure). In various aspects of the present invention, one or both of the useful life and/or enclosure life of the enclosure can be: not less than 3 days, not less than 7 days, not less than 15 days, not less than 30 days, not less than 60 days, not less than 90 days, not less than 120 days, not less than 150 days, not less than 180 days, not less than 270 days, not less than 1 year, not less than 1.5 years, not less than 2 years, not less than 3 years, not less than 4 years, or not less than 5 years.

If desired, the enclosure or portions thereof could optionally be constructed of a degradable material and/or could incorporate degradable attachments and/or closures, which could include biodegradable, photodegradable, oxidizable and/or hydrolysable materials, which desirably results in a decrease in molecular weight, reduction in mass, and/or reduced strength or durability of the enclosure (as well as other potential effects) or portions thereof over time under certain conditions. In various embodiments, the continued exposure to the aquatic environment by such materials may eventually result in detachment of the enclosure (or one or more layers thereof) from the substrate and/or environmentally friendly degradation of the enclosure and/or various constituents thereof. Such detachment could include detachment of the entire enclosure and/or detachment of different layers in a time-released and/or fouling extent (i.e., weight-based, drag-based and/or reduced wall flexibility) released manner.

Whichever type of materials are used, the enclosure may optionally be constructed such that the structure is formable to be capable of being expanded three-dimensionally, radially, longitudinally and/or various combinations thereof. This type of construction would desirably allow positioning over and/or around an object in a variety of configurations, which could include positioning such that the enclosure walls might mirror the contour of the surface of the object for which it is attached thereto, if desired. In some embodiments, the enclosure may be formed in a mirror shape of one or more surface of the substrate and will generally be of at least slightly larger size to accommodate the substrate therein.

In some exemplary embodiments, an enclosure could be constructed of completely natural materials such as burlap or hemp, and deployed to protect substrates in particularly sensitive waters such as drinking water reservoirs and/or wildlife refuges, where the use of artificial materials and/or biocidal toxins may be prohibited and/or discouraged. In such a case, the enclosure would desirably provide protection to the underlying substrate for a desired period of time without posing a significant potential to pollute the water and/or harm the local aquatic environment, even if the enclosure becomes detached from the substrate and/or relevant supporting structure (as the additional opening(s) in the detached structure might now prevent the development of the protected aqueous environment and its attendant advantages). In such a case, once the substrate no longer requires protection, or where the enclosure becomes fouled and/or damaged for a variety of reasons, the enclosure could be removed and/or replaced with a new enclosure and/or enclosure components of similar materials, with fouling protection restored to the substrate as desired.

Filtration Media and Fabrics

In various embodiments, a wide variety of fabrics and/or other filtration media are described which can be incorporated into some or all of the fouling protective systems described herein. In many of these embodiments, a coating or paint may be incorporated into the fabric, with the coating or paint including one or more biocidal and/or bio-toxic substances which can be released and/or elute into fluid flowing through the fabric and/or pores thereof.

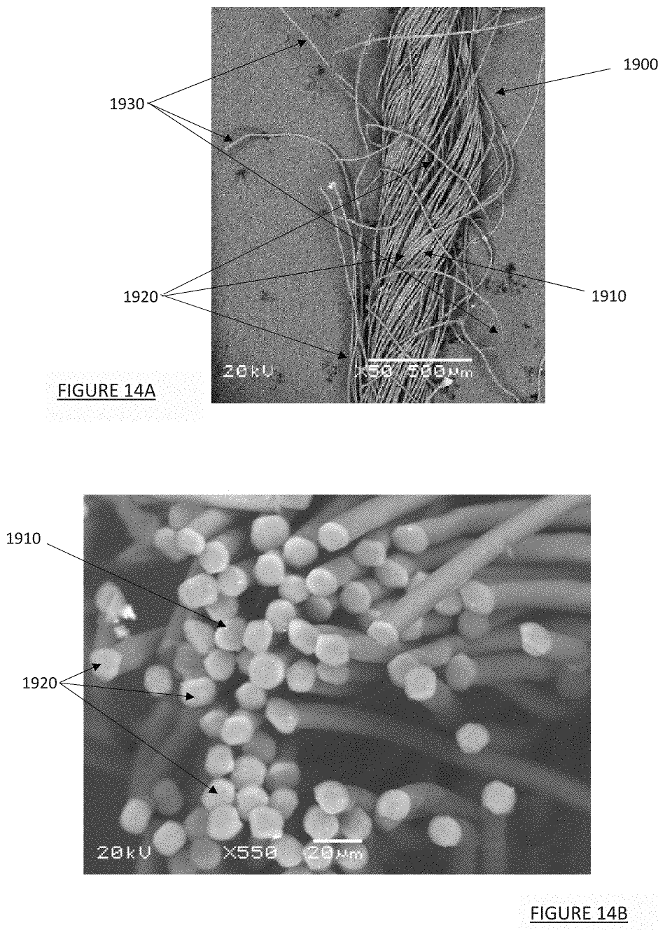

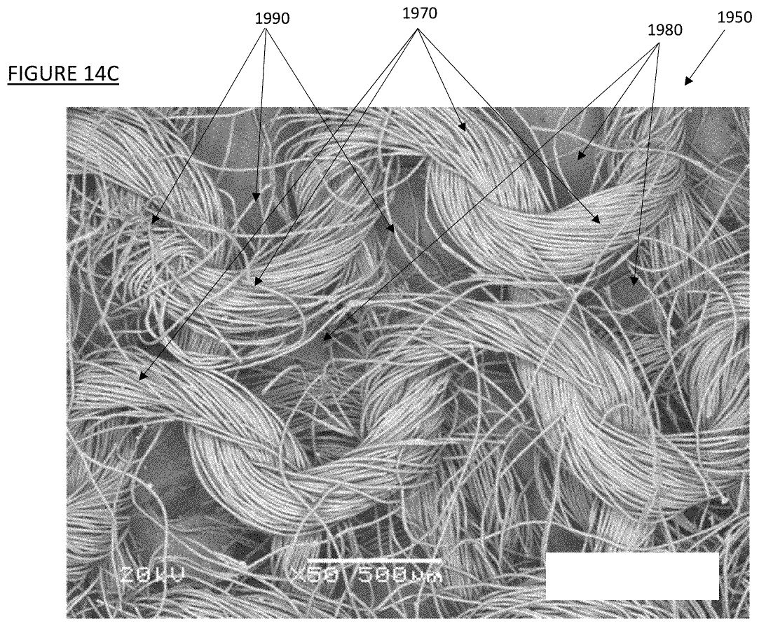

FIG. 14A depicts one exemplary scanning electron microscope (SEM) micrograph of an exemplary spun yarn 1900, which depicts a central body or yarn bundle 1910 of intertwined filaments 1920, with various filament ends 1930 extending laterally relative to the central body 1910. FIG. 14B depicts a cross-sectional view of the central body 1910, highlighting the very fine size of the individual filaments 1920 within the yarn bundle 1910. As best seen in FIG. 14C, which depicts an enlarged view of a knit fabric 1950 comprising PET spun yarn, a series of interstices or openings 1980 are positioned between the yard bundles 1970 during the knitting process, with one or more extending fibers or fiber ends 1990 extending across various of the openings (with multiple fiber ends desirably traversing each opening in various embodiments).

In various embodiments, the enclosure walls and the substrate(s) protected therein can be separated and/or spaced apart by an average spacing (i.e., between an inner wall of the enclosure and an outer surface of the substrate) of about 200 inches, or about 150 inches, or about 144 inches, or of about 72 inches or less, or about 36 inches or less, or about 24 inches or less, or about 12 inches or less, or about 6 inches or less, or about 1 inch or less, or about 1 inch or greater, or about 6 inches or greater, or from about 1 inch to about 24 inches, or from about 2 inches to about 24 inches, or from about 4 inches to about 24 inches, or from about 6 inches to about 24 inches, or from about 12 inches to about 24 inches, or from about 1 inch to about 12 inches, or from about 2 inches to about 12 inches, or from about 4 inches to about 12 inches, or from about 6 inches to about 12 inches, or from about 1 inch to about 6 inches, or from about 2 inches to about 6 inches and/or from about 4 inches to about 6 inches. In various alternative embodiments, at least some or all of the enclosure may be in direct contact with the substrate in one or more areas (including, but not limited to, a closure portion of the enclosure), and thus there may be substantially little or no distance between the structure and substrate in some embodiments.

In various other embodiments, it may be desirous for the spacing between the enclosure walls and the substrate to fall within a certain range of average distances, or a desired spacing could be proportional to the width, length, depth and/or other characteristics of the enclosure and/or the substrate to be protected. For example, maintaining a predetermined spacing between a smaller substrate and a smaller enclosure containing only a few gallons of water may be more critical, especially where there is a relatively smaller amount of water in the differentiated environment which may be more susceptible to water exchange levels and the resulting water chemistry changes relative thereto, as compared to the spacing between a relatively large ship hull and a large enclosure which contained many thousands or millions of gallons of water in its “differentiated environment” within the enclosure. In such cases, a desired spacing between an enclosure wall and an opposing surface of the substrate may be 2% or less of the distance between opposing enclosure walls, or 5% or less, or 10% or less, or 20% or less, or 30% or less, or 40% or up to 49.9% of the distance between opposing enclosure walls, depending upon substrate size, type, enclosure design and/or enclosure rigidity and/or design. In another embodiment, the local aqueous environment may extend a distance of 100 inches or more, 50 inches or more, 10 inches or more, 5 inches or more, 3 inches or more, 2 inches or more, 1 inch or more, 0.5 inches or more, 0.1 inches or more, 0.04 inches or more, 50 feet or less, 40 feet or less, 20 feet or less, 20 feet or less, 10 feet or less, 4 feet or less, 2 feet or less, 100 inches or less, 10 inches or less, 5 inches or less, 1 inch or less, 0.1 inches or less, 0.04 inches or less away from the surface of the substrate.

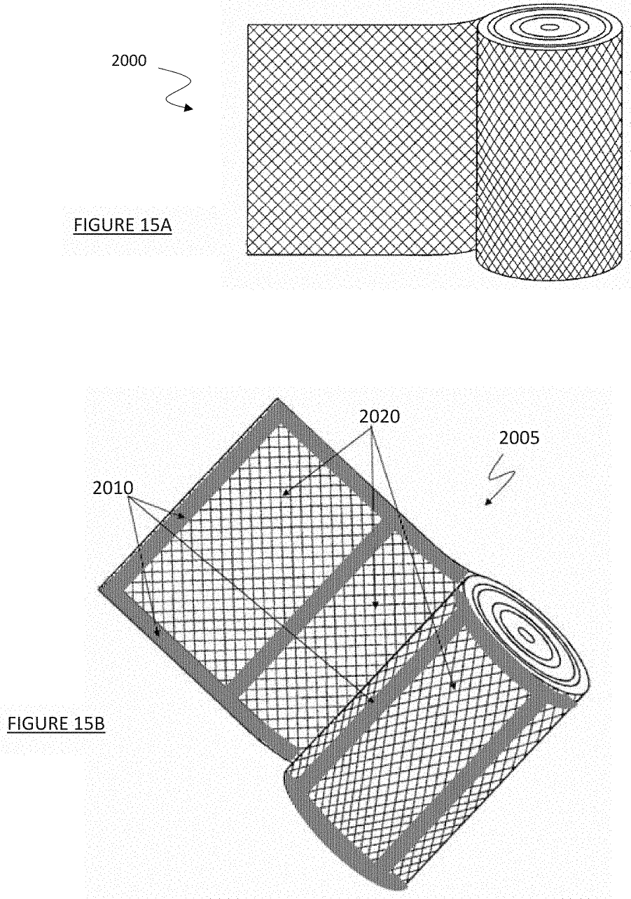

FIG. 15A depicts an exemplary fabric material 2000 in a rolled sheet form, which can be used in a variety of ways to form various enclosures and/or filtration elements described herein. In this embodiment, the material desirably comprises a flexible fibrous material, in this case a fabric material, which can include natural fiber cloth as well as woven, knitted, felted, non-woven and/or other structures of polyester or other synthetic fibers, and/or various combinations thereof. In various embodiments, the fabric may be utilized to construct the various enclosure embodiments described herein, and/or it may be possible and/or desirous to wrap or otherwise “cover” an elongated substrate with such rolled sheet material, especially where the unrolled and wrapped sheet may overlap other sheet sections (i.e., along a piling or support girder) which may create an “enclosure” comprising a progressively wrapped substrate wherein the fabric material is wrapped around the substrate in an overlapping “barber pole” or maypole-type technique or lining inner walls of water tank or irrigation pipes. In such a case, it may be desirous for the fabric to directly contact the protected substrate, with a very thin layer of liquid between the fabric enclosure walls and the substrate surface (as well as optionally the liquid within the fabric itself) constituting a “differentiated environment” as described herein.

FIG. 15B depicts another exemplary embodiment of a rolled-up sheet fabric 2005 that incorporates adhesive, hook-and-loop fastener material 2010 (and/or sewn seams) along various portions of the fabric, which can desirably self-adhere to other fabric portions and/or to other devices and/or components, with the majority of the fabric comprising perforated or permeable portions 2020 as described herein (and in various embodiments the fastener materials themselves could comprise permeable and/or non-permeable portions as well). If desired, a material flap covering some other fabric portion could be non-permeable and protect underlying structures.

In use, the fabric could be wrapped around a piling or support girder or other structure to form an enclosure around some portion of the piling, which could include a progressive wrapping method (i.e., a “barber-pole” type wrapping) or a circular wrapping method (i.e., a “round-robin” type wrapping) to create various enclosures similar in function to those described herein, to protect various portions of the piling from biofouling organisms and/or other degradation. In various embodiments, attachment using hook and loop or similar fasteners may be particularly desirably, as such fastening techniques can be rendered permeable and allow water exchange therethrough in a manner similar to the various permeable materials described herein.

If desired, an enclosure may be constructed using individual components sections that can be assembled into a three-dimensional (3D) construct. For example, individual walls sections of an enclosure can be provided to be attached to each other in a variety of configurations, including triangular, square and/or other polygonal shapes. If desired, the wall sections could be supported by a relatively rigid underframe, or the sections could be highly flexible and/or provided on a roller or other carrier, which could be unrolled to release each individual section prior to assembly. In at least one alternative embodiment, an open enclosure frame or support could be provided, with an elongated sheet or enclosure wall material provided that could be wrapped around and/or overlain over the frame segments (and applied to the frame in a manner similar to taping or “ship wrapping” of an object for shipment by common carrier, for example).

In various alternative embodiments, the enclosure and/or component materials thereof may comprise a three-dimensional fabric matrix and/or fibrous matrix structure fashioned from interwoven and/or intertwined strands of thread formed in a lattice-like, mesh, mat or fenestrated fabric arrangement, which in various embodiments could incorporate one or more non-flat and/or non-smooth fabric layer(s). In one very simplified form, the enclosure could contain a plurality of horizontally positioned elements interwoven with a plurality of vertically positioned elements (as well as various combinations of other fiber elements aligned in various directions), which can include multiple separated and/or interwoven layers. The flexible materials may include one or more spaced apart layers, which may include baffles or various interconnecting sections. Desirably, each yarn or other thread element(s) in the enclosure material will include a preselected number of individual strands, with at least a portion of the strands extending outward from the thread core elements at various locations and/or directions, thereby creating a three-dimensional tortuous network of interwoven threads and thread strands in the fabric. In various embodiments, the various elements of the fibrous matrix may be arranged in virtually any orientation, including diagonally, or in a parallel fashion relative to each other, thereby forming right angles, or in virtually any other orientation, including three dimensional orientations and/or randomized distributions (i.e., felt matting) and/or patterns. In addition, while in some embodiments there may be a significant spacing between the individual elements, in other embodiments the spacing can be decreased to a much tighter pattern in order to form a tight pattern with little or no spacing in between. In various preferred embodiments, the elements, such as threads and/or fibers, may be made of natural or synthetic polymers, but could be made of other materials such as metals, nylons, cotton, or combinations thereof.

Various aspects of the present invention can include the use of a fibrous matrix and/or flexible material that is highly ciliated, which means that the material can include tendrils or hair-like appendages (i.e., fibers) projecting from its surface or into the pores or open spaces in the 3-dimensional flexible fabric that create a “filtering” media. The tendrils or hair-like appendages may be a portion of or incorporated into the material that makes up the 3-dimensional flexible filtering material. Alternatively, the tendrils or hair-like appendages may be formed from a separate composition adhered or attached to the flexible material. For example, the tendrils or hair-like appendages may be attached to and project from an adhesive layer, which is itself attached to the surface of the flexible material. In aspects of the invention, the tendrils or hair-like appendages may project from the surface of the enclosure material, while in other aspects the tendrils or hair-like appendages may extend inward from the enclosure materials and/or inwards towards and/or into other threads and/or fibers of the enclosure material fibrous matrix and/or fabric. In various aspects of the invention, the tendrils or hair-like appendages may be resilient and/or may vibrate and/or sway due to enclosure and/or water movement. In various embodiments, the combination of the ciliation itself and/or the movement of the tendrils or hair-like appendages may also discourage the settlement of biofouling organisms on or in the surface of the enclosure.

In various embodiments, the presence of numerous small fibers in the permeable material of an enclosure can provide a substantial increase in the complexity of the 3-dimensional structure of the material, as these structures can extend into and/or around open interstices in the woven pattern. This arrangement of fibers can further provide a more tortuous path for organisms trying to traverse the depth of the fabric and enter the internal environment protected by the enclosure (i.e., increasing the “filtering” effect of the material), and/or or may provide a much higher surface area of the fabric to which the optional biocide coating may adhere. In various embodiments, it has been determined that spun polyester has highly desirable characteristics as an enclosure material, as the shape and/or size of the 3-dimensional “entry paths” into the enclosure (i.e., as the microorganisms pass through the openings and/or pores of the material) will desirably provide a longer pathway, a larger surface area and/or may prove more effective in filtering and/or impeding the flow of fouling organisms into the enclosure and/or retaining larger amounts of biocide coating therein.

In various embodiments, the three-dimensional topography of the enclosure walls will desirably contribute to the anti-biofouling effects of the enclosure, in that such fabric construction can increase the “filtering effect” of the enclosure walls and/or could negatively affect the ability for various fouling organisms to “latch onto” the enclosure fabric and/or protected substrate. In other embodiments, however, enclosure walls and/or other components could comprise “flatter” and/or “smoother” materials such as textured yarn or other materials (and/or other material construction techniques) and still provide many of the anti-biofouling effects disclosed herein. While such materials may be significantly flatter, smoother and/or less ciliated than materials incorporating spun polyester yarns, these materials may still provide an acceptable level of biofouling protection for a variety of applications.

A variety of materials that may be suitable to varying degrees for constructing the enclosure include various natural and synthetic materials, or combinations thereof. For example, burlap, jute, canvas, wool, cellulosics, silk, cotton, hemp, and muslin are non-limiting examples of possible useful natural materials. Useful synthetic materials can include, without limitation, the polymer classes of polyolefins (such as polyethylenes, ultra-high molecular weight polyethylenes, polypropylenes, copolymers, etc.), polyesters, nylons, polyurethanes, rayons, polyamides, polyacrylics, and epoxies. Fiberglass compositions of various types may also be used. Combinations of polymers and copolymers may also be useful. These three-dimensional flexible materials may be formed into textile structures, permeable sheets, or other configurations that provide a structure capable of providing the anti-fouling and/or filtering properties as described herein. Examples of potentially suitable flexible materials for use in constructing the enclosures described herein include, but are not limited to, burlap, canvas, cotton fabrics, linen, muslin, permeable polymeric sheets, fabrics constructed from polymeric fibers or filaments, and permeable films and membranes. In aspects of the invention, the flexible material may be selected from natural or synthetic fabrics, such as, burlap, knitted polyester or other fabrics, woven polyester or other fabrics, spun polyester or other fabrics, various combinations thereof, or other fabrics having a variety of characteristics, including those disclosed herein.

In various embodiments, the flexible material forming one or more walls of the enclosure may have a structure formed by intertwined fibers or bundles of fibers (i.e., yarns). As used herein, “intertwined” means the fibers may be non-woven, woven, braided, knitted, or otherwise intermingled to produce a fibrous matrix capable of various of the filtering and/or water permeability and/or water exchange features discussed herein. The matter in which the fibers are intertwined can desirably create a pattern of open and closed spaces in the 3-dimensional flexible material, the open spaces therein defining interstices. Desirably, the fibers that may make up the flexible material are, for example, single filaments, bundles of multiple filaments, filaments of a natural or a synthetic composition, or a combination of natural and synthetic compositions. In aspects of the invention, the fibers have an average diameter (or “average filament diameter”) of: about 50 mils or less, about 25 mils or less, about 10 mils or less, about 6 mils or less, about 5 mils or less, about 4 mils or less, about 3 mils or less, about 2 mils or less, about 1 mil or less, about 0.5 mils or less, about 0.4 mils or less, about 0.3 mils or less, about 0.2 mils or less, or about 0.1 mils or less.

In some aspects of the invention, the flexible material could comprise a woven or knitted fabric. For example, the woven fabric may have picks per inch (“ppi” or weft yarns per inch) of from about 3 to about 150, from about 5 to about 100, from about 10 to about 50, from about 15 to about 25 from about 20 to about 40 and/or approximately 20 ppi. In other aspects of the invention, the woven fabric has ends per inch (“epi” or warp yarns per inch) of from about 3 to about 150, from about 5 to about 100, from about 10 to about 50, from about 15 to about 25, from about 20 to about 40 and/or approximately 20 epi or approximately 24 epi. In still other various other aspects of the invention, a knitted fabric may have courses per inch (“cpi”) of from about 3 to about 120, from about 5 to about 100, from about 10 to about 50, from about 15 to about 25, from about 20 to about 40 and/or approximately 36 cpi or approximately 37 cpi. In even other aspects of the invention, the knitted fabric has wales per inch (“wpi”) of from about 3 to about 80, from about 5 to about 60, from about 10 to about 50, from about 15 to about 25, from about 20 to about 40 and/or approximately 36 wpi or approximately 33.7 wpi.

Accordingly, in at least one aspect of the invention the woven fabric has a yarn size density (i.e., the weft multiplied by the warp yarns per unit area) of from about 9 to about 22,500, from about 100 to about 20,000, from about 500 to about 15,000, from about 1,000 to about 10,000, from about 2,500 to about 8,000, from about 4,000 to about 6,000, from about 2,500 to about 4,000, from about 5,000 to about 15,000, from about 10,000 to about 20,000, from about 8,000 to about 25,000, from about 20 to about 100, form about 30 to about 50, about 45, or about 40 yarns per square inch.

In another aspect of the present invention, the yarns of the woven or knit fabric may have a size of from about 40 denier to 70 denier, about 40 denier to 100 denier, about 100 denier to about 3000 denier, about 500 to about 2500 denier, about 1000 to about 2250 denier, about 1100 denier, about 2150 denier, or about 2200 denier.

In still another aspect of the invention, the woven or knit fabric may have a base weight per unit area from about 1 to about 24 ounces per square yard (about 34 to about 814 g/m2), from about 1 to about 15 ounces per square yard, from about 2 to about 20 ounces per square yard (about 68 to about 678 g/m2), from about 10 to about 16 ounces per square yard (about 339 to about 542 g/m2), about 12 ounces per square yard (about 407 g/m2), or about 7 ounces per square yard (about 237 g/m2), or about 3 ounces per square yard. In another aspect of the present invention, a desirable spun polyester fiber based woven fabric can be utilized as an enclosure material, with the fabric having a BASIS WEIGHT (weight of the base fabric before any coating or modifications are included) of approximately 410 Grams/Meter² (see Table 4).

In various exemplary embodiments, the thickness of a suitable enclosure or structure wall can range from 0.025 inches to 0.0575 inches or greater, with desirable enclosures being approximately 0.0205 inches thick, approximately 0.0319 inches thick, approximately 0.0482 inches thick and/or approximately 0.0571 inches thick. Depending upon the size of perforations and/or openings in the enclosure, as well as the shape, size and/or degree of tortuosity of the various opening in the enclosure, enclosures of greater and/or lesser thicknesses than those specifically described may be utilized in various enclosure designs with varying degrees of success and various enclosure materials. In various alternative embodiments, the flexible base materials, fibers and/or threads utilized in construction of the disclosed fibrous matrices may have a wide variation in thickness and/or length depending on the desired substrate to be protected or specific application. For example, in some aspects of the invention the thickness of the flexible material may be from about 0.001 to about 0.5 inch, from about 0.005 to about 0.25 inch, from about 0.01 to about 0.1 inch, about 0.02 inch, about 0.03 inch, about 0.04 inch, about 0.05 inch, or about 0.06 inch. Variations in thickness and in permeability within a single structure are contemplated, such as in membrane filtration structures, as well as multiple layers thereof.

It should be understood that a wide variety of materials and/or material combinations could be utilized as enclosure materials to accomplish various of the objectives described herein. For example, a film or similar material may be utilized as one alternative to a fabric enclosure wall material, which may include permeable and/or non-permeable films in some or all of the enclosure walls. Similarly, natural and synthetic materials such as rubbers, latex, thin metals, metal films and/or foils and/or plastics or ceramics might be utilized with varying results.

In various embodiments, “permeability” is desirably utilized as a metric for some aspects of the enclosure and/or its components, as it may be somewhat difficult to measure and/or determine an “effective” porosity of the openings in the entirety of a spun poly and/or burlap material due to the “fuzziness” and/or randomness in the architecture of this fabric, which may be compounded by variations in the flexibility and/or form of the fabric in wet and/or dry conditions, which Applicant believes can optionally be important to the effectiveness of various embodiments of the disclosed systems and devices. In various embodiments, the enclosure can comprise one or more walls comprising a flexible material with openings and/or pores formed therethrough. In some desirable embodiments, some or all of the openings through the wall(s) can comprise a tortuous or “crooked” flow path, where the tortuosity ratio is defined as a ratio of the actual length of the flow path (Lₜ) to the straight line distance between the ends of the flow path:

$$τ = \frac{{L}_{t}}{L}$$

In one exemplary embodiment, a woven fabric made from Textured Yarn or Spun Polyester Yarn may be highly desirous for use in creating the exemplary enclosure walls, with the Spun Polyester Yarn potentially having a significant number of fiber ends that extend from the yarn at various locations (i.e., a relatively higher level of “hairiness” or ciliation) and in multiple directions—desirably leading to a more complicated 3-dimensional macro-structure and/or more tortuous path(s) from the external to internal surfaces of the fabric. In various preferred embodiments, these fiber ends can extend into natural openings that may exist in the fabric weave, potentially reducing and/or eliminating some “straight path” openings through the fabric and/or increasing the tortuosity of existing paths through the fabric (which in some instances may extend a considerable distance through the topography of the 3-dimensional fabric). In various embodiments, it may be desirable for portions of the fabric to incorporate openings having a tortuosity ratio greater than 1.25, while in other embodiments a tortuosity ratio greater than 1.5 for various openings in the fabric may be more desirable.

Permeability

In many embodiments, it is highly desirable to incorporate permeable elements, components and/or structures into some and/or all of the enclosure components, which allow some bulk transport of water into and/or out of the filtration media and/or enclosure in a controlled manner and/or rate. Desirably, the material or materials selected for the filtration media/enclosure will include one or more walled structures having a level of permeability that allows for some level of “bulk fluid exchange” between the enclosure and the surrounding aqueous environment. This permeability will desirably be optimized and/or suited to the local environment within which the enclosure will be placed, although in general the enclosure may incorporate a low to moderate level of permeability, as enclosure materials with very high permeabilities may be somewhat less effective at altering the water chemistry within the enclosure and/or limiting or reducing biofouling on the protected article, while enclosure materials with exceptionally low or no permeability (or that may become very low in permeability over time for many reasons, including due to fouling on and/or in the textile surface) may lead to an unacceptably low level of liquid exchange through the walls of the fabric, which could lead to various substrate corrosion or other issues resulting from a low oxygen level (i.e., anoxic or other conditions) or other chemical levels within the protected environment. In various locations and/or environmental conditions (including various changes in seasons and/or weather patterns), greater or lesser permeabilities or other enclosure design changes may be desirous. In many cases, the local environmental conditions (i.e., water flow, temperature, bio-floral type, growing season, salinity, available nutrients and/or oxygen, pollutants, etc.) and/or local water conditions/velocity (i.e., due to currents and/or tides) could affect the desired permeability and/or other design considerations—for example, the impingement of higher velocity liquids on an enclosure may create an increased water exchange rate for a given permeability of material, which may require or suggest the use of a lower permeability material in such conditions.

In various embodiments, the enclosure can desirably inhibit biofouling on a substrate or substrate portion at least partially submerged in an aquatic environment, with the enclosure including a material which is or becomes water permeable during use, said enclosure adapted to receive said substrate and form a differentiated aquatic environment which extends from a surface of the substrate to at least an interior/exterior surface of the structure, wherein the structure or portions thereof are water permeable, upon positioning the structure about the substrate or thereafter, of about 100 ml of water per second per square centimeter of substrate or less. In various embodiments, water permeability of the structure may be achieved by forming the structure to allow water to permeate through, such as by manufacturing a textile to have a desired permeability. In some embodiments, the structure may be designed to become water permeable over time as it is used. For example, an otherwise water permeable structure may include a coating that initially makes it substantially non-permeable (which impermeability may be particularly useful in “jump starting” a desired low-oxygen condition within the enclosure immediately after initial placement), but as the coating ablates, erodes, or dissolves, the underlying permeability increases and/or becomes useful (which can allow oxygenated water to permeate into/through the enclosure and help prevent unwanted sustained anoxic conditions from occurring within the enclosure after low-oxygen condition has been attained).

TABLE 3
Exemplary Wall Fabric Permeabilities

| | | Average | | | Average |
|---|---|---|---|---|---|
| | | Perme- | | | Perme- |
| | | ability | | | ability |
| Fabric | Coating | (ml/s/cm2) | Fabric | Coating | (ml/s/cm2) |
| 1/64 Poly | Un | 43.08 | Spun Poly | Un | 10.17 |
| | SW | 42.04 | | SW | 0.32 |
| | HC | 28.16 | | HC | 1.08 |
| 23 × 17 | Un | 8.11 | | MB(out) | 2.47 |
| | SW | 0.83 | | MB(in) | 2.09 |
| | HC | 1.65 | | 154-30-v | 9.20 |
| 23 × 23 | Un | 0.79 | | 154-30-nv | 0.90 |
| | SW | 0.18 | | 154-40-v | 11.27 |
| | HC | 0.08 | | 154-40-nv | 0.77 |
| 61588 | Un | 20.46 | | 153-30-v | 9.02 |
| | SW | 2.29 | | 153-30-nv | 2.36 |
| | HC | 0.50 | | 153-40-v | 9.43 |
| 61598 | Un | 25.41 | | 153-40-nv | 1.11 |
| | SW | 0.19 | 60 × 60 Bur | Un | 21.97 |
| | HC | 2.57 | | SW | 14.72 |
| 900d | Un | 14.04 | | HC | 4.43 |
| | SW | 0.07 | 60 × 70 Bur | Un | 15.79 |
| | HC | 8.24 | | SW | 5.99 |
| 6/1 Poly | Un | 40.55 | | HC | 3.68 |
| | SW | 29.08 | 80 × 80 Bur | Un | 8.16 |
| | HC | 22.30 | | SW | 2.77 |
| A21 | Un | 46.71 | | HC | 0.48 |
| | SW | 46.22 | | S(HVY) | 2.25 |
| | HC | 42.54 | | HC(HVY) | 0.06 |
| Text | Un | 11.10 | | MR(HVY) | 0.11 |
| | 40MB | 14.19 | | MB(HVY) | 0.13 |
| | 50MB | 13.91 | Poly | 152 | 2.43 |
| | | | | 9696-7W | 5.40 |
| | | | | 9696-7C | 4.77 |
| | | | | 9696-7M | 4.70 |
| | | | | 154-40/25 | 1.05 |
| | | | | 10311803 | 3.84 |
| | | | | 03061907 | 6.04 |

In various embodiments, an optimal and/or desired permeability level for an enclosure fabric can approximate any of the fabric permeabilities identified in Table 3 (below), and in some embodiments can include permeabilities ranging from 100 ml/s/cm² to 0.01 ml/s/sm². In various alternative embodiments, a fabric or other permeable material may be utilized in or on one or more walls of the enclosure, including materials having a permeability range from 0.06 ml/s/cm² to 46.71 ml/s/cm², or from 0.07 ml/s/cm² to 46.22 ml/s/cm², or from 0.08 ml/s/cm² to 43.08 ml/s/cm², or from 0.11 ml/s/cm² to 42.54 ml/s/cm², or from 0.13 ml/s/cm² to 42.04 ml/s/cm², or from 0.18 ml/s/cm² to 40.55 ml/s/cm², or from 0.19 ml/s/cm² to 29.08 ml/s/cm², or from 0.32 ml/s/cm² to 28.16 ml/s/cm², or from 0.48 ml/s/cm² to 25.41 ml/s/cm², or from 0.50 ml/s/cm² to 22.30 ml/s/cm², or from 0.77 ml/s/cm² to 21.97 ml/s/cm², or from 0.79 ml/s/cm² to 20.46 ml/s/cm², or from 0.83 ml/s/cm² to 15.79 ml/s/cm², or from 0.90 ml/s/cm² to 14.72 ml/s/cm², or from 1.05 ml/s/cm² to 14.19 ml/s/cm², or from 1.08 ml/s/cm² to 14.04 ml/s/cm², or from 1.11 ml/s/cm² to 13.91 ml/s/cm², or from 1.65 ml/s/cm² to 11.27 ml/s/cm², or from 2.09 ml/s/cm² to 11.10 ml/s/cm², or from 2.25 ml/s/cm² to 10.17 ml/s/cm², or from 2.29 ml/s/cm² to 9.43 ml/s/cm², or from 2.36 ml/s/cm² to 9.20 ml/s/cm², or from 2.43 ml/s/cm² to 9.02 ml/s/cm², or from 2.47 ml/s/cm² to 8.24 ml/s/cm², or from 2.57 ml/s/cm² to 8.16 ml/s/cm², or from 2.77 ml/s/cm² to 8.11 ml/s/cm², or from 3.68 ml/s/cm² to 6.04 ml/s/cm², or from 3.84 ml/s/cm² to 5.99 ml/s/cm², or from 4.43 ml/s/cm² to 5.40 ml/s/cm², and/or from 4.70 ml/s/cm² to 4.77 ml/s/cm².

In various embodiments, an optimal and/or desired water exchange rate between the differentiated environment within the enclosure and the open environment can range from about 0.1% to about 500% per hour, or from about 0.1% to about 400%, or from about 0.1% to about 350%, or from about 20% to about 375%, or from about 0.1% to about 100%, or from about 0.1% to about 250%, or from about 20% to about 500%, or from about 50% to about 200%, or from about 100% to about 200%, or from about 0.1% to about 20%, or from about 100% to about 200%, or from about 25% to about 200%, or from about 25% to about 100%, or from about 10% to about 75%, or from about 25% to about 275%, or from about 100% to about 500%, or from about 100% to about 250%, or from about 50% to about 150%, or from about 75% to about 200%, or from about 20% to about 350%, or from about 50% to about 100%, or from about 0.2% to about 120% per hour, or from about 0.2% to about 20% per hour, or from about 20% to about 50% per hour, or approximately 25% of the volume per hour.

The water permeability of a material can be a function of numerous factors, including the composition of the material, the method and type of construction of the material, whether the material is coated or uncoated, whether the material is dry, wet, or saturated, whether the material is itself fouled in some manner and/or whether the fabric has been “pre-wetted” prior to testing and/or use in the aqueous environment. Moreover, because permeability of a given material may alter over time, even for a single material there may be a range of acceptable and/or optimal water permeabilities. In various aspects of the present invention, the water permeability of the enclosure may be an initial minimum permeability sufficient to desirably avoid the creation of a constant anoxia condition in the local (i.e. protected within the enclosure) aquatic environment, while in other embodiments the permeability may be greater. In various aspects of the invention, the enclosure material has a water permeability (milliliters of water per second per square centimeter of substrate) as measured by the above test method, either prior to use or achieved during use of: about 100 or less, about 90 or less, about 80 or less, about 70 or less, about 60 or less, about 50 or less, about 40 or less, about 30 or less, about 25 or less, about 20 or less, about 10 or less, about 5 or less, about 4 of or less, about 3 or less, about 2 or less, about 1 or less, about 0.5 or less, about 0.1 or less, about 1 or greater, about 0.5 or greater, about 0.1 or greater, from about 0.1 to about 100, from about 0.1 to about 90, from about 0.1 to about 80, from about 0.1 to about 70, from about 0.1 to about 60, from about 0.1 to about 50, from about 0.1 to about 40, from about 0.1 to about 30, from about 0.1 to about 25, from about 0.1 to about 20, from about 0.1 to about 10, from about 0.1 to about 5, from about 0.5 to about 100, from about 0.5 to about 90, from about 0.5 to about 80, from about 0.5 to about 70, from about 0.5 to about 60, from about 0.5 to about 50, from about 0.5 to about 40, from about 0.5 to about 30, from about 0.5 to about 25, from about 0.5 to about 20, from about 0.5 to about 10, from about 0.5 to about 5, from about 1 to about 100, from about 1 to about 90, from about 1 to about 80, from about 1 to about 70, from about 1 to about 60, from about 1 to about 50, from about 1 to about 40, from about 1 to about 30, from about 1 to about 25, from about 1 to about 20, from about 1 to about 10, or from about 1 to about 5.

Optional Biocide Coatings

In various exemplary embodiments, the disclosed enclosures may optionally include the use of supplemental biocidal and/or antifouling agent(s) for the enclosure to provide adequate biofouling protection for the enclosure materials and/or substrate, which might also include the periodic use of uncoated fabric enclosures during certain immersion periods when the fouling pressure may be such that unprotected fabrics could be free of macrofouling and/or where an uncoated enclosure might be sufficient to provide protection to the contained substrate for a desired period of time. In many embodiments, at least a portion of a surface of the filtration media and/or enclosure wall structure may be impregnated by, infused with and/or coated with a biocidal paint, coating and/or additive. In some additional embodiments, biocidal and/or antifouling agent(s) may be integrated into the filtration media and/or enclosure walls and/or other portions thereof to desirably protect the enclosure itself from unwanted fouling. In some exemplary embodiments, the fabric or material may act as a carrier for the biocide.

In general, a biocide or some other chemical, compound and/or microorganism having the capacity to destroy, deter, render harmless and/or exert a controlling effect on any unwanted or undesired organism by chemical or biological means may optionally be incorporated into and/or onto some portion(s) of the material, such as during manufacture of the material or material components, or the biocide et al can be introduced to the material after manufacture. Desirably, the one or more biocides in/on the material will inhibit and/or prevent colonization of aquatic organisms on the outer surface and/or within openings within the enclosure, as well as to repulse, incapacitate, compromise and/or weaken biofouling organisms small enough to attempt or successfully penetrate through the openings in the enclosure, such that they are less able to thrive within the artificial or synthetic local aquatic environment between the structure and the substrate. In various embodiments, the enclosure desirably incorporates a material which maintains sufficient strength and/or integrity to allow the protection and/or inhibition of biofouling (and/or enables the creation of the desired artificial local aquatic environment or synthetic local aqueous environment) for a useful life of not less than about 3 to 7 days, 7 to 15 days, 3 to 15 days, at least 1 month, at least 3 months, at least 6 months at least 12 months, at least 2 years, at least 3 years, at least 4 years and/or at least 5 years or longer.

In at least one exemplary embodiment of an enclosure, the enclosure can incorporate a material which is coated, painted and/or impregnated with a biocide coating, which desirably adheres to and/or penetrates the material to a desired depth (which could include surface coatings of the material on only one side of the fabric, as well as coatings that may penetrate from 1% to 99% of the way through the fabric, as well as coatings that may fully penetrate through the fabric and coat some or all of the opposing side of the fabric). Desirably, the biocide will reduce and/or prevent the type, speed and/or extent of biofouling on the material, and/or may have some deleterious effect on microorganisms attempting to pass through openings in the material into the differentiated aqueous environment (and may also have some effect on microorganisms already resident within the enclosure). In various embodiments, the presence of the biocide coating or paint along the 3-dimensional “entry path” into the enclosure (i.e., as the microorganisms pass through the openings and/or pores of the material) will desirably provide a larger surface area and prove more effective than the standard 2-dimensional “planar” paint biocide coverage (i.e., a hard-planar coating) utilized on rigid, submerged surfaces in marine use today. In various aspects, especially where the fabric matrix material is highly fibrillated and/or ciliated, the coating of such materials can desirably provide a higher “functional surface area” of the fabric for the biocide coating to adhere to, which desirably increases the potential for anti-biofouling efficacy as organisms are more likely to be located near to and/or in contact with these small fibers (and the biocide paint, coating or additive resident thereupon or therein) as they pass through the fabric.

In various alternative embodiments, the enclosure can incorporate a material which is coated, painted and/or impregnated with a biocide coating (which could include surface coatings of the material on only one side of the fabric, as well as surface coatings from the front and/or back of the fabric which may extend some amount into the pores of the fabric), which may include coatings on one surface of the fabric that penetrate up to 5% into the pores of the fabric, up to 10% into the pores of the fabric, up to 15% into the pores of the fabric, up to 20% into the pores of the fabric, up to 25% into the pores of the fabric, up to 30% into the pores of the fabric, up to 35% into the pores of the fabric, up to 40% into the pores of the fabric, up to 45% into the pores of the fabric, up to 50% into the pores of the fabric, up to 55% into the pores of the fabric, up to 60% into the pores of the fabric, up to 65% into the pores of the fabric, up to 70% into the pores of the fabric, up to 75% into the pores of the fabric, up to 80% into the pores of the fabric, up to 85% into the pores of the fabric, up to 90% into the pores of the fabric, up to 95% into the pores of the fabric, up to 99% into the pores of the fabric, up to 100% of the way through the pores of the fabric and/or extending out of the pores onto the opposing surface of the fabric.

In various embodiments, the additional incorporation of a biocide coating or other coating/additives in some embodiments also desirably improves durability and functional life of the filtration media, the enclosure and/or its components, in that biofouling organisms and/or other detrimental agents should be inhibited and/or prevented from colonizing the flexible fabric and/or perforations therein for a period of time after immersion, thereby desirably preserving the flexible, perforated nature of the enclosure walls and the advantages attendant therewith. Where the biocide is primarily retained proximate to the fabric matrix (i.e., where the biocide may have very low or no biocide elution levels outside of the fabric or the enclosure), the biocide will desirably significantly inhibit biofouling of the enclosure walls, while the presence of the enclosure and the “differentiated aqueous environment” created therein will reduce and/or inhibit biofouling of the protected substrate. In various exemplary embodiments, it is possible for the biocide to have extremely low and/or no detectable levels in water within the differentiated aqueous environment and/or in open waters adjacent to the enclosure (i.e., below 30 ng/L) and still remain highly effective in protecting the enclosure and/or substrate from biofouling. In one example, biocide release rates from an enclosure material was detected as 0.2-2 ppm and/or lower between 7 days in artificial sea waters and low local concentrations (i.e. biocide release rates) were detected as 0.2-2 ppm and/or lower between 7 days in artificial sea waters, and these release rates were effective at protecting the enclosure materials from biofouling.

A wide variety of supplemental coatings incorporating various biocides and/or other dispensing and/or eluting materials may be incorporated into a given enclosure design to provide various anti-fouling advantages. For example, coatings which release econea and/or pyrithione in varying amounts and/or timing can be useful in combatting biofouling, including embodiments having initially high release rates which significantly reduce after only a few days and/or weeks after immersion, as well as other embodiments having initially low release rates which increase over time of immersion.

In at least one exemplary embodiment, an enclosure material can comprise a spun polyester fabric having a surface and/or subsurface coating of a commercially available biocide coating, including water-based and/or solvent-based coatings containing registered biocides, with the coating applied to the fabric by virtually any means known in the art, including by brushing, rolling, painting, dipping, spray, production printing, encapsulation and/or screen coating (with and/or without vacuum assist). Coating of the material may be accomplished on one or both sides of the material, as well as single-sided coating on the inner facing side of the materials, although single-sided coating on the outwardly facing side of the material (i.e., away from the substrate and towards the open aqueous environment) has demonstrated significant levels of effectiveness while minimizing biocide content, cost, and maintaining advantageous flexibility. While water-based (“WB”) biocidal coatings are primarily discussed in various embodiments herein, solvent-based (“SB”) biocidal coatings could alternatively be used in a variety of applications (and/or in combination with water-based paints), if desired.

In various embodiments, the use of various printing processes for the coating could have an added benefit of allowing the incorporation of visible patterns and/or logos into and/or on the enclosure walls, which could include marketing and/or advertising materials to identify the source of the enclosure (i.e., enclosure manufacturer) as well as identification of one or more users (i.e., a particular marina and/or boat owner/boat name) and/or identification of the anticipated use area and/or conditions (i.e., “salt water immersion only” or “use only in Jacksonville Harbor” or “summer use only”). If desired, various indicators could be incorporated to identify the age and/or condition of the enclosure, including the printing of a “replace by” date on the outside of the enclosure. If desired, the visible patterns could be printed using the biocide coating itself, which could incorporate supplemental inks and/or dyes into the coating mix, or the additional logos, etc. could be printed using a separate additive.

In various embodiments, a biocide coating or paint can desirably be applied to the material in an amount ranging from 220 grams per square meter to 235 grams per square meter, although applications of less than 220 grams per square meter, including 100 grams per square meter or less, as well as applications of more than 235 grams per square meter, including 300 grams per square meter and greater, show significant potential. In various alternative embodiments, the coating mixture could comprise one or more biocides in various percentage weights of the mixture, including weights of 10% biocide or less, such as 2%, 5% and/or 7% of the mixture, or greater amounts of biocide, including 10%, 20%, 30%, 40% 50% and/or more biocide by weight of the coating mixture, as well as ranges encompassing virtually any combination thereof (i.e., 2% to 10% and/or 5% to 50%, etc.). Where the enclosure design may be particularly large, it may be desirous to significantly increase the percentage of biocide in the coating mixture, which would desirably reduce the total amount of coating required for protection of the enclosure and/or substrate.

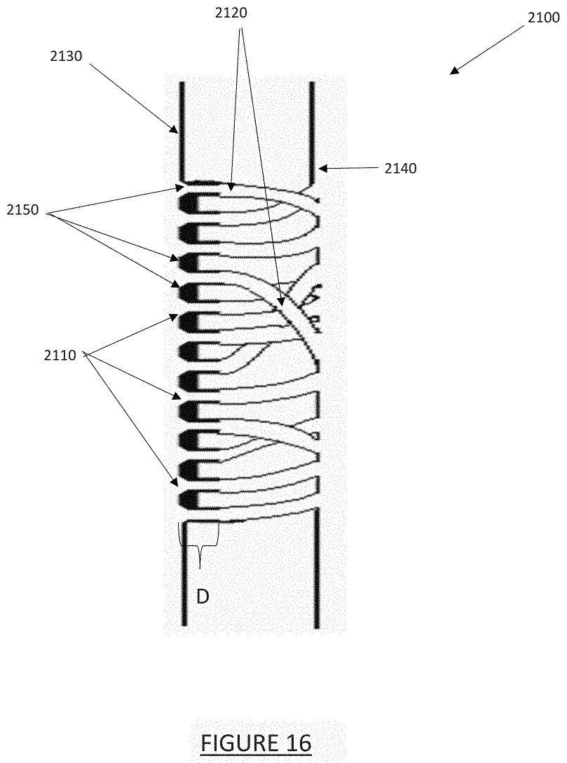

FIG. 16 depicts a cross-sectional view of an exemplary permeable fabric 2100, with various pore openings 2110 and simplified passages 2120 extending from a front face 2130 to a back face 2140 of the fabric 2100. A coating substance 2150, optionally containing a biocide or other debilitating substance, is also shown, wherein some portions of this coating substance extends from the front face 2130 at least some distance “D” into the pore openings 2110 and/or passages 2120 of the fabric 2100. In various embodiments, the coating substances will desirably penetrate some average distance “D” into the fabric of the material and/or fabric wall openings/pores (i.e., a 3%, 5%. 10%, 15%, 20%, 25%, 50%, 75% or greater depth of penetration into the fabric—see FIG. 16). Desirably, the coating substance, which is often “stiffer” in a dried configuration than the fabric to which is it applied, will be applied in such a manner as to allow the fabric to be bent and/or molded to some degree (i.e., the coating will desirably not appreciably or severely “stiffen” the fabric to an undesirable degree), allowing the fabric to be formed into a desired enclosure shape and/or to be wrapped around structures and/or formed into flexible bags and/or containers (if desired). Where a bag or similar enclosure (i.e. a closable shape) is provided, the coating may desirably be applied onto/into the item after manufacture thereof, which may include the coating and/or encapsulation of any seams and/or stitched/adhered areas beneath one or more coating layers. In various embodiments, the coating penetration depth will average no more than half of the depth through the material.

Once coated with the coating or paint, the material and/or enclosure can be allowed to cure and/or air dry for a desired period of time (which may take less than two minutes for some commercial applications, or up to an hour or longer in other embodiments) or may be force dried utilizing gas, oil or electric heating elements. The material and/or enclosure can then be used as described herein.

In various embodiments, the enclosure may include an optional biocide agent that is attached to, coated on, encapsulated, integrated into and/or “woven into” the threads of the material. For example, the biocide could be incorporated into strips containing various concentrations of one or more biocides, thus desirably preventing the various plant and animal species from attaching or establishing a presence on and/or in the enclosure. Alternatively, the enclosure could include a reservoir or other component which contains free or a microencapsulated form of a biocide. The microencapsulation desirably provides a mechanism in which the biocide may be diffused or released into the environment in a time dependent manner. The biocide filled microcapsules could be embedded into the individual threads and/or the woven material without the use of a reservoir or container, or alternatively the biocide could be coated onto the surface of the fibrous substrate elements (i.e., the threads) and/or the openings or “pores” therebetween.

Other methods of inserting and/or applying a coating or anti-fouling agent, such as the use of spray-on applications as known to one of skill in the coating art, are contemplated. Additionally, the enclosure need not contain individual fibrous elements, but may instead be made of a perforated and/or pliable sheet which contains an agent embedded therein and/or coated on the material. To provide a securing mechanism, the enclosure can include fastening elements, such as but not limited to loop and hook type fasteners, such as VELCRO®, snaps, buttons, clasps, clips, buttons, glue strips, or zippers. If desired, an enclosure can desirably comprise a plurality of wall structures, with each wall structure attached to one or more adjacent wall structures (if any) by stitching, weaving or the like, which may include the coating and/or encapsulation of any seams and/or stitched/adhered areas beneath one or more coating layers to form a modular enclosure. If desired, enclosure material may be added to expand beyond and/or on to the enclosure fastening element to protect the fastening element from fouling.

In various embodiments, the enclosure desirably includes anti-biofouling characteristics, attached to and/or embedded within the threads and/or fibers (i.e., the various elements of the fibrous matrix) to inhibit and/or prevent biofouling of the enclosure. In a preferred embodiment, the anti-biofouling agent is a biocide coating comprising Econea™ (tralopyril—commercially available from Janssen Pharmaceutical NV of Belgium) and/or zinc omadine (i.e., pyrithione), but other anti-biofouling agents currently available and/or developed in the future, such as zinc, copper or derivatives thereof, known to one of skill in the art, may be used. Moreover, antifouling compounds from microorganisms and their synthetic analogs could be utilized, with these different sources typically categorized into ten types, including fatty acids, lactones, terpenes, steroids, benzenoids, phenyl ethers, polyketides, alkaloids, nucleosides and peptides. These compounds may be isolated from seaweeds, algae, fungus, bacteria, and marine invertebrates, including larvae, sponges, worms, snails, mussels, and others. One or more (or various combination thereof) of any of the previously described compounds and/or equivalents thereof (and/or any future developed compounds and/or equivalents thereof) may be utilized to create an anti-biofouling structure which prevents both microfouling, such as biofilm formation and bacterial attachment, and macrofouling, such as attachment of large organisms, including barnacles or mussels, for one or more targeted species, or may be utilized as a more “broad-spectrum” antifoulant for multiple biofouling organisms, if desired.

In one exemplary embodiment, a desirable spun polyester fiber based woven fabric can be utilized as an enclosure wall material, with the fabric having a BASIS WEIGHT (weight of the base fabric before any coating or modifications are included) of approximately 410 Grams/Meter² (See Table 4).

TABLE 4
Exemplary Fabric Specifications

| Fabric Name | 100% polyester woven canvas fabric (loomstate) | |
|---|---|---|
| Content | 100 Polyester (virgin) | |
| Yarn Count | Warp | 10s/4 |
| | Filing | 10s/4 |
| Density | Warp | 20/inch ± 3 |
| | Filing | 20/inch ± 2 |
| Weight | 410 gsm ± 10 g (12.09 OZ/sqy) | |
| Width | 64/65″ | |
| | Overroll | 64/65″ |
| | Cuttable | 63″ |
| | Edge | Plain selvage |

| | |
|---|---|
| Color | Nature white |
| Finishing | None |
| Dyeing | None |
| Washing | None |
| Packing | Rolling with plastic bag inside and weave bag outside |

Table 5 depicts some alternative fabric specifications that can be utilized as enclosure wall materials with varying levels of utility.

TABLE 5
Additional Exemplary Fabric Specifications

| | | Ends/ | Picks/ | Weight | Thickness |
|---|---|---|---|---|---|
| Style | Yarn size and type | Courses | Wales | oz/yd | inches |
| 61598 | 75.4% 70/36 SD Rd Text Nat Polyester, | 36 cpi | 36 wpi | 3.68 | 0.0571 |
| | 24.6% 40/24 SD Rd Flat at Polyester | | | | |
| 61588 | 75.4% 70/36 SD Rd Text Nat Polyester, | 37 cpi | 33.7 wpi | 3.26 | 0.0205 |
| | 24.6% 40/24 SD Rd Flat at Polyester | | | | |
| 410G/SM2 | 100% 10 singles, 4 ply spun polyester | 20 epi | 20 ppi | 12.09 | 0.0482 |
| 235G5M | 100%-300 den, 4 ply textured polyester | 24 epi | 20 ppi | 6.93 | 0.0319 |

For various structure or enclosure embodiments, a target add-on weight on the paint/coating could be set from approximately about 5 grams/meter² to 500 grams/meter², from about 50 grams/meter² to 480 grams/meter², from about 100 grams/meter² to 300 grams/meter², from about 120 grams/meter² to 280 grams/meter², from approximately 224 grams/Meter² (or up to ±10% thereof).

In various embodiments where the addition of a biocide or other coating may be desirous, it should be understood that in some embodiments the coating may be applied to the enclosure after the enclosure has been fully assembled and/or constructed, while in other embodiments the coating may be applied to some or all of the components of the enclosure prior to assembly and/or construction. In still other embodiments, some portions of the enclosure could be pre-coated and/or pretreated, while other portions could be coated after assembly. Moreover, where processing and/or treatment steps during the manufacture and/or assembly of the may involve techniques that may negatively affect the quality and/or performance of the biocide or other coating characteristics, it may be desirous to perform those processing and/or treatment steps to the enclosure and/or enclosure components prior to application of the coating thereof. For example, where a heat sensitive biocide and/or coating may be desired, material processing techniques involving elevated temperatures might be employed to create and/or process the fabric and/or the enclosure walls before application of the biocide coating thereof (i.e., to reduce the opportunity for heat-related degradation of the biocide and/or coating).

In various embodiments, a coating material or other additive (including a biocide coating or other material) may be applied to and/or incorporated into the fabric of the enclosure, potentially resulting in an altered level of permeability, which may convert a material that may be less suitable for protecting a substrate from biofouling to one that is more desirable for protecting a substrate from biofouling once in a coated condition. For example, an uncoated polyester fabric, which experimentally demonstrates a relatively high permeability to liquids (i.e., 150 mL of a liquid passed through a test fabric in less than 50 seconds), which may be less desirable for forming an enclosure to protect a substrate from biofouling, as described herein. However, when properly coated to a desired level with a biocidal coating, the permeability of the coated fabric can be substantially reduced to a much more desirable level, such as a moderately permeable level (i.e., 100 mL of a liquid passed through a test fabric in between 50 to 80 seconds) and/or a very low permeability level (i.e., little to no liquid passed through the test fabric). In this manner, a deliberate permeability level can optionally be “dialed into” or tuned for each selected fabric, if desired.

During immersion testing in an aqueous environment over an extended period of time, one embodiment of an enclosure incorporating a polyester coated fabric developed no macrofouling and/or a very minimal coating of macrofouling. Moreover, one example the polyester fabric became more permeable during the immersion period, while another example became less permeable during the immersion period.

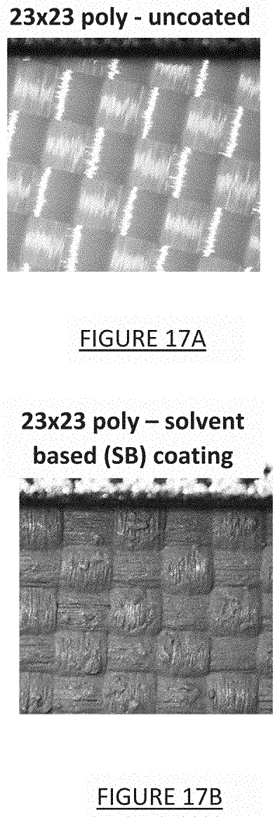

FIG. 17A depicts an exemplary embodiment of an uncoated 23×23 polyester woven fabric, which experimentally demonstrated a relatively low permeability to liquids (i.e., 100 mL of a liquid passed through a test fabric in approximately 396 seconds), which may be on a low end of a desirable permeability range for forming some enclosure designs to protect a substrate from biofouling, as described herein, depending upon local conditions. When coated (See FIG. 17B), these materials became essentially non-permeable prior to immersion, but became more permeable after immersion. As previously noted, the desired permeability level could be “dialed into” or tuned for each selected fabric, if desired. In various embodiment, the permeability of a given fabric and/or enclosure components can change or be different in wet or dry conditions, if desired.

During immersion testing in an aqueous environment over an extended period of time, the uncoated 23×23 polyester and coated polyester fabrics all had no macrofouling on the enclosure and/or the substrate. Moreover, each of these materials experienced a significant increase in permeability during immersion, with the 23×23 uncoated polyester fabric allowing passage of 150 mL of liquid in 120 seconds, while the first 23×23 coated polyester fabric allowed 150 mL of liquid in 160 seconds and the second 23×23 coated polyester allowed 150 mL of liquid in 180 seconds.

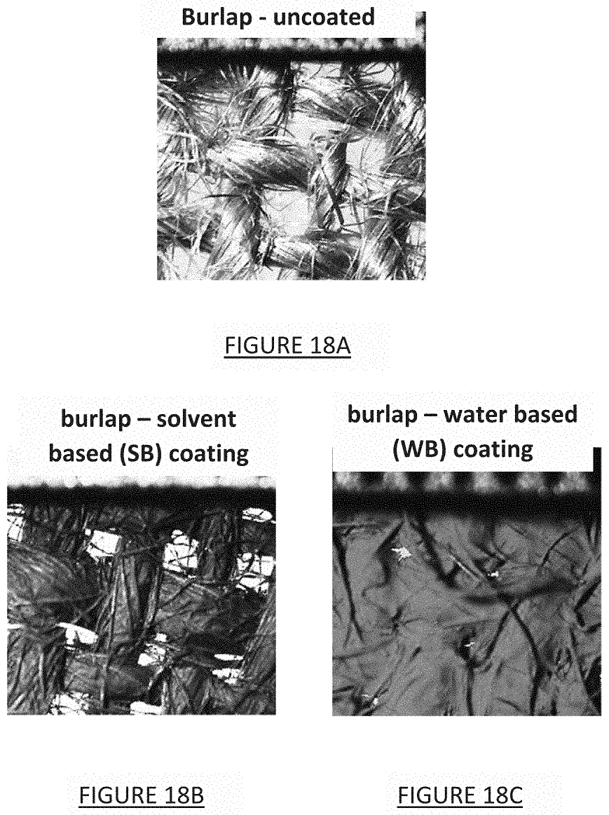

In other alternative embodiments, FIGS. 18A through 18C depict a natural material, burlap, uncoated (FIG. 18A), coated with a solvent based biocidal coating (FIG. 18B) and coated with a water based biocidal coating (FIG. 18C). During permeability testing, the uncoated burlap fabric demonstrated a permeability of 50.99 ml/s/cm2, while the coated burlap fabrics had permeabilities of 52.32 ml/s/cm2 and 38.23 ml/s/cm2, for solvent based biocidal coating and water based biocidal coating, respectively. After 32 days of immersion in salt water, the permeability for both coated fabrics significantly increased to 85.23 ml/s/cm2 and 87.28 ml/s/cm2, whereas the uncoated burlap fabric decreased permeability to 20.42 ml/s/cm2. For fouling observations, uncoated burlap fabrics experienced very minimal fouling and the coated burlap fabrics experiencing virtually no macrofouling.

Additionally, in another alternative embodiment, a 1/64 polyester uncoated fabric was coated with a solvent based biocidal coating, and alternatively coated with a water based biocidal coating. During permeability testing, the uncoated 1/64 polyester fabric demonstrated a permeability of 26.82 ml/s/cm2, while the coated 1/64 polyester fabrics had permeabilities of 44.49 ml/s/cm2 and 29.25 ml/s/cm2, for solvent based biocidal coating and water based biocidal coating, respectively. After 32 days of immersion in salt water, the permeability for all 1/64 polyester fabrics significantly decreased to 10.99 ml/s/cm2, 13.78 ml/s/cm2 and 13.31 ml/s/cm2, respectively. For fouling observations, uncoated 1/16 polyester fabrics experienced some fouling, whereas the coated 1/64 polyester fabrics experiencing virtually no macrofouling.

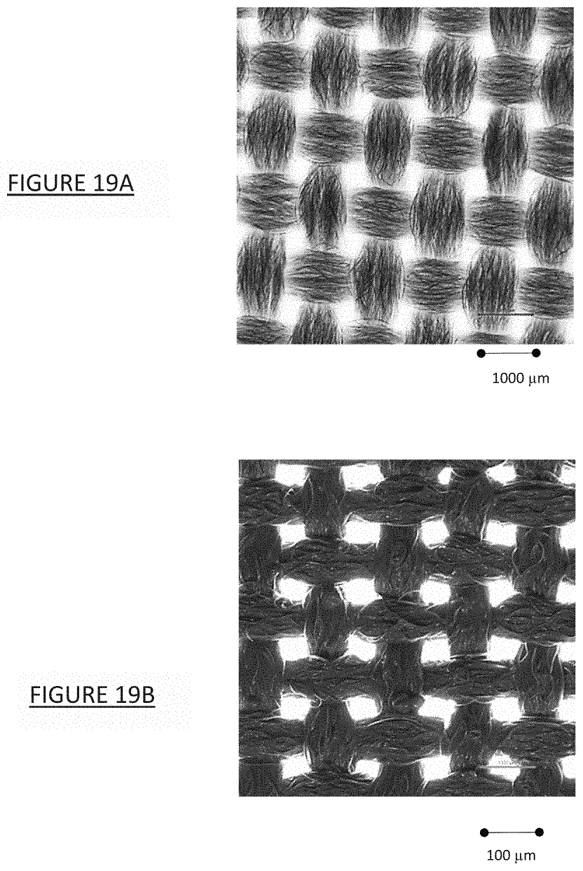

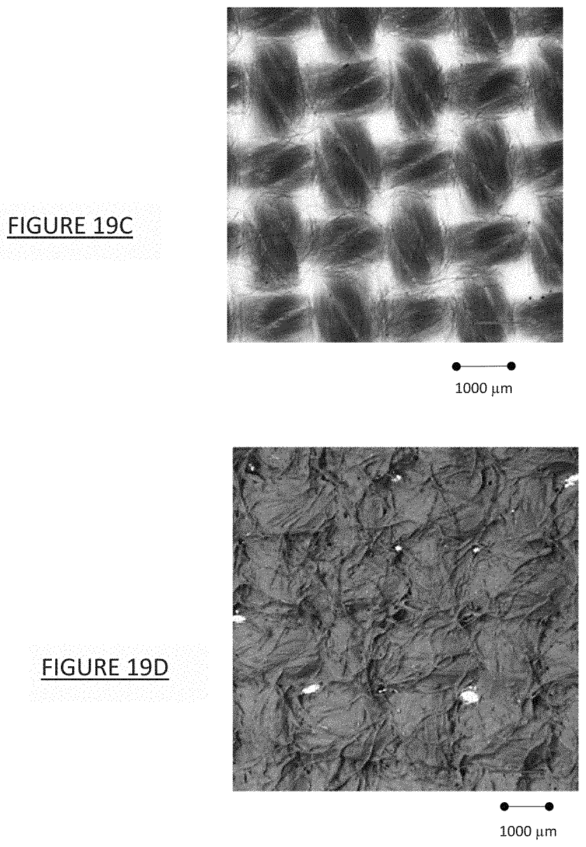

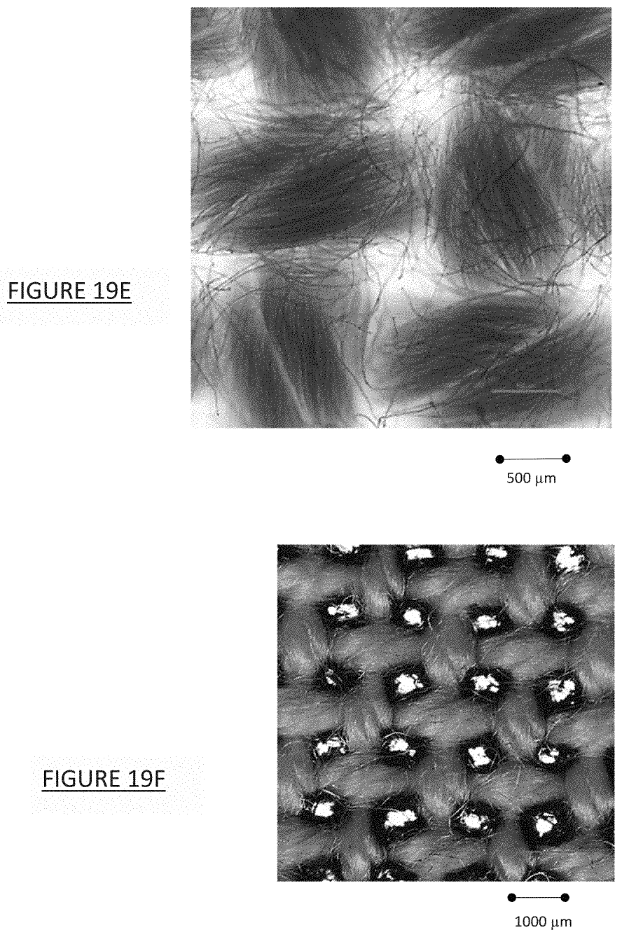

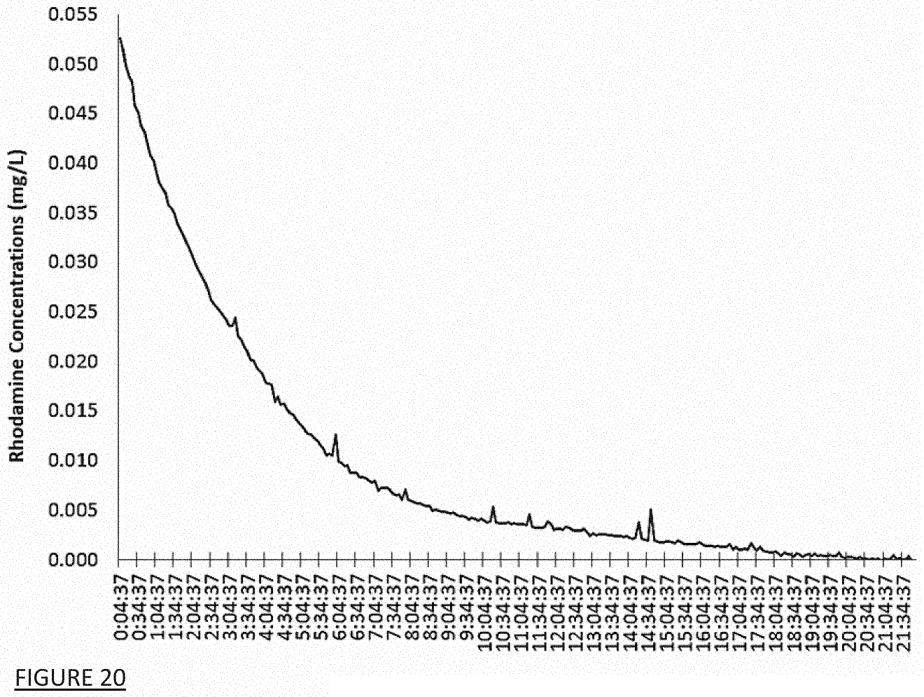

Different varieties of fabric cloth were manufactured, coated and utilized in the construction and testing of anti-biofouling enclosures. In a first embodiment (shown in FIG. 19A with a scale bar of 1000 μm), a textured polyester cloth was coated with a biocide coating on a first surface, with a significant amount of this coating penetrating completely through the cloth to the opposing second surface (with some areas of coating on the second surface being thinner than in other areas). FIG. 19B depicts this coated cloth at a bar scale of 1000 μm. On average, this coated cloth had 523.54 (±2.33) pores/in², with approximately less than 5 percent of the pores occluded (on average).

FIG. 19C depicts another preferred embodiment of a 100% spun polyester fabric, with FIG. 19D depicting this fabric coated with a biocidal coating. During testing, the uncoated 100% polyester fabric demonstrated a permeability of 10.17 ml/s/cm² of the fabric, while the coated poly fabrics had permeabilities of 0.32 ml/s/cm² and 1.08 ml/s/cm². After 23 days of immersion, the permeability for both coated fabrics was not significantly changed, with the uncoated poly fabric experiencing very minimal fouling and the coated poly fabrics experiencing virtually no macrofouling. In various other embodiments, however, other approaches to preparing spun polyester yarn, such as core-spinning staple fiber around a continuous core, open end spinning, ring spinning, and/or air jet spinning are anticipated to yield favorable results as well.

In another embodiment (the uncoated fabric shown in FIG. 19E with a scale bar of 500 μm), a spun polyester cloth was subsequently coated with a biocide coating on a first surface, with a significant amount of this coating penetrating partially through the fibers and/or pores of the cloth (in some embodiments, up to or exceeding 50% penetration through the cloth). FIG. 19F shows the opposing uncoated side of the fabric at 1000 μm, with this figure also demonstrating the significant pore size reduction that can be accomplished using this coating technique, if desired. On average, this coated cloth had 493 (±3.53) pores/in², with approximately 7 to 10 percent of the pores fully occluded by the coating material (on average).

Experimentally, all of these fabric embodiments demonstrated desirable levels of permeability, which may be due to the high number of small pores, the smaller size of the fibers, and or various combinations thereof. The various coating methods were very effective in coating and penetrating the fabric to a desired level and produced a highly effective material for incorporation into a protective enclosure.

Table 3 depicts a variety of fabrics potentially suitable for use in various embodiments of the present invention, with exemplary permeabilities of these fabrics in uncoated and coated states. For example, in Port Canaveral Harbor (Port Canaveral, Fla., USA), it was experimentally determined that a permeability range of 0.5 ml/s/cm² to 25 ml/s/cm² to 50 ml/s/cm² to 75 ml/s/cm² to 100 ml/s/cm² or from about 0.1 ml/s/cm² to about 100 ml/s/cm², cm² or from about 1 ml/s/cm² to about 75 ml/s/cm², or from about 1 ml/s/cm² to about 10 ml/s/cm², or from about 1 ml/s/cm² to about 5 ml/s/cm², or from about 5 ml/s/cm² to about 10 ml/s/cm², or from about 10 ml/s/cm² to about 20 ml/s/cm², or from about 10 ml/s/cm² to about 25 ml/s/cm², or from about 10 ml/s/cm² to about 50 ml/s/cm², or from about 20 ml/s/cm² to about 70 ml/s/cm², or from about 10 ml/s/cm² to about 40 ml/s/cm², or from about 20 ml/s/cm² to about 60 ml/s/cm², or from about 75 ml/s/cm² to about 100 ml/s/cm², or from about 60 ml/s/cm² to about 100 ml/s/cm², or from about 10 ml/s/cm² to about 30 ml/s/cm², might be sufficient (depending upon local conditions) to prevent significant amounts of fouling from occurring on and/or within the enclosure and/or on the protected substrate, while still allowing sufficient water flow to inhibit and/or prevent anoxia within the enclosure. In addition, fabrics with a permeability of 0.5 ml/s/cm² or lower may be suitable for various enclosure embodiments, where occasional periods of hypoxic conditions may be acceptable and/or desired. Lower permeability than these ranges may lead to anoxic conditions during periods of low water movement in some areas, which may be less desirable and/or undesirable in various embodiments. In another exemplary embodiment, a permeability range of at least 0.32 ml/s/cm², and up to 10.17 ml/s/cm² was determined to be an optimal range of desirable permeability characteristics and/or a desired range of anticipated permeability changes during the life of the enclosure. In other embodiments, a range of at least 1.5 ml/s/cm², and up to 8.0 ml/s/cm² may be desirous (as well as any combination of the various ranges disclosed herein). In many cases, because the specific fouling organisms, the incidence of fouling incursion and/or rate of fouling growth in a given region and/or water body can be highly dependent upon a multiplicity of interrelated factors, as well as the local and/or seasonal conditions of the intended area of use (and the intended substrate to be protected, among other things), the acceptable ranges of permeability for a given fabric in a given enclosure design may vary widely—thus a fabric permeability that may be optimal and/or suitable for one enclosure design and/or location may be less optimal and/or unsuitable for another enclosure design and/or location. Accordingly, the desired permeability values and ranges thereof should be interpreted as general trends of the ability of a given fabric and/or permeability to provide antifouling protection while avoiding extended periods of anoxic conditions in a given body of water, but should not be interpreted as precluding the use of a given fabric in other enclosure designs and/or water conditions.

In various embodiments, the permeability of filter media and/or enclosure materials can desirably be maintained within a desired range of permeabilities over its useful life in situ (or until the desired biofilm layer has been established, if desired), such that any potential increases in the permeability of the material due to changes in the structure and/or materials of the enclosure (as one example) would desirably approximate various expected decreases in the material's permeability due to clogging of the pores by organic and/or inorganic debris (including any biofouling of the material and/or its pores that may occur). This equilibrium will desirably maintain the integrity and/or functioning of the enclosure and the characteristics of the differentiated environment over an extended period of time, providing significant protection for the enclosure and/or the protected substrate.

In various embodiments, the enclosure walls may incorporate a variety of materials that experience permeability changes during immersion testing in an aqueous environment over an extended period of time. For example, uncoated synthetic materials may generally become less permeable over time (which may be due to progressive fouling of the fabric once positioned around a substrate), while some materials coated with biocidal coatings can undergo a variety of permeability changes, including some embodiments becoming less permeable over time. In addition, a natural test fiber (Burlap) in an uncoated state became more permeable, while biocide coated burlap became less permeable overtime. In various embodiments, varying of coating parameters (i.e., coating add-on/thickness, application methods, vacuum application to maintain and/or increase pore size, drying parameters, etc.) and varying textile parameters (i.e., construction, materials, initial permeability, constrained during drying or not, heat set or not, etc.) can make it possible to produce a broad range of desirable permeability characteristics as well as anticipated permeability changes during the life of a given enclosure design. When deployed into the aqueous environment, it is thus possible to influence (and/or control) whether the permeability increases or decreases over time for some extended period(s), as well as the associated correlation with product life cycle.

In various embodiments, the enclosure can desirably inhibit biofouling on a substrate at least partially submerged in an aquatic environment, with the enclosure including a material which is or becomes water permeable during use, said enclosure adapted to receive said substrate and form a differentiated aquatic environment which extends from a surface of the substrate to at least an interior/exterior surface of the structure, wherein said structure or portions thereof has a water permeability, upon positioning the structure about the substrate or thereafter, of about 100 milliliters of water per second per square centimeter of substrate, of about 100 milliliters of water per minute per square centimeter of substrate, or values therebetween, or greater/lesser permeabilities.

In various embodiments, water permeability of a structure may be achieved by forming the structure to allow water to permeate there through, such as by weaving a textile to have a desired permeability and/or optionally coating a textile with a biocide coating (or non-biocide containing coating) that provides the textile with a desired permeability. In some embodiments, the structure may be designed to become water permeable over time as it is used. For example, an otherwise water permeable structure may have a coating that initially makes it substantially non-permeable, but as the coating ablates, erodes, or dissolves, the underlying permeability increases and/or becomes useful.

Table 6 (below) depicts one exemplary test of water permeability of an enclosure incorporating permeable fabric walls. In this embodiment, an initial high concentration of Rhodamine was created in an enclosure in an aqueous environment, and then the Rhodamine concentration was measured over time to determine how the concentration of this marker fell as water exchange occurred in and out of the enclosure's permeable walls. The test indicated that the residence time of Rhodamine in this enclosure with its dimensions and wall permeabilities was approximately 4 hours and 10 minutes, with a half-life of 3 hours and a flow rate of approximately 0.0027 ml/cm²/sec.

TABLE 6
RHODAMINE DYE TESTING
Flow Rate Calculations for Rectangular Enclosures

| | | | | area | | pumping | turnover | flow rate | |
|---|---|---|---|---|---|---|---|---|---|
| | length | width | depth | (square | volume | rate (gal- | time | (gal/sq | ml/sq |
| Enclosure | (feet) | (feet) | (feet) | ft) | (gallons) | lons/hr) | (hrs) | ft/hr) | cm/sec |
| Stern Mimic | 4.0 | 3.0 | 3.0 | 54 | 269 | 65 | 4.17 | 1.20 | 0.001357 |
| (dye test) | | | | | | | | | |
| 18″ Cube | 1.5 | 1.5 | 1.5 | 11 | 25 | 650 | 0.04 | 57.78 | 0.065397 |
| (pumping Test) | | | | | | | | | |
| 50′ boat | 50.0 | 12.0 | 5.0 | 1220 | 22,442 | 1200 | 18.70 | 0.98 | 0.001113 |
| (theoretical) | | | | | | | | | |

The Rhodamine Dye testing was utilized as an analog for determining water exchange rate in various test enclosures. For example, a YSI Total Algae Sensor (TAL) was placed into a bagged stern mimic. A concentration of 0.9 mg/L of Rhodamine was added to the stern mimic. When data had returned to background concentrations for the pigments in the bag, the YSI was placed in the open water for 2 days to get open water readings for comparison with the undosed bag levels. Residence time, half-life and flow rate were calculated from the rhodamine data. Residence time was calculated as 37% of the initial concentration of rhodamine dye. Half-life was calculated as 69.3% of the residence time (using these calculations as found in the literature). Flow rate was calculated by taking 2× the volume (to account for 1 volume in and one out) and dividing that by the residence time and the surface area. Rhodamine concentration in mg/L was graphed after background pigment was subtracted to get a better idea of the dilution rate. The test results show that it took approximately 26 hours for the pigment concentration in the stern mimic to stabilize back to natural levels. The residence time was calculated as 4 hours 10 minutes with a flow rate calculated to be 0.0027 mL/cm²/s.

In various embodiments, it may be highly desirous for an enclosure or portions thereof to have an initially high permeability, with a subsequent reduction in permeability that occurs after the enclosure has been placed about a substrate to be protected. For example, an enclosure having extremely low permeability might maintain positive buoyancy after placement in an aqueous medium, which might render it difficult if not impossible to place the enclosure about a submerged and/or partially submerged substrate. In contrast, an enclosure incorporating more permeable elements might “sink” more readily upon deployment about a substrate. Such an enclosure might include a lower portion that is highly permeable (to allow water inflow and rapid filling of the enclosure), with other enclosure elements that are more or less permeable. Once deployed about a substrate as desired, the more permeable elements may change permeability (i.e., more or less permeable) or may remain the same permeability, as desired.

In various embodiments, when an enclosure such as described herein is utilized, the biological colonizing sequence on the substrate may be interrupted (disrupted, altered, etc.) to reduce and/or minimize the settlement, recruitment and ultimate macrofouling of the substrate. Once positioned around or inside (if protecting inner surface of a substrate) the substrate, the permeable, protective fabric walls of the enclosure can desirably filter and/or impede the passage of various micro- and/or macro-organisms into the enclosure, and the optional biocide coating in some embodiments might prevent fouling of the enclosure and/or might injure and/or impair some and/or all of the organisms as they contact and/or pass through the fabric. If desired, the biocidal coating may experience significant biocidal elution upon initial placement around the substrate to establish an initial higher “kill level” affecting fouling organisms, with the biocidal elution levels significantly reducing over a period of time as the water chemistry changes within the enclosure to create the desired differentiate environment, thus protecting the substrate from further fouling.

In one exemplary embodiment, testing of microscopic plankton transiting a biocide coated permeable fabric membrane of an enclosure indicated that some organisms were likely to remain alive and viable after the transit, while some other organisms were likely to be impaired and/or injured during the transit. This observation of living organisms within the enclosure was reinforced by testing of differentiated water within an enclosure, wherein a significant percentage of micro-organisms within the enclosure that use appendages (like barnacle larvae and tunicates with speeds in the 1-10+ cm/s range) appeared to remain viable within the biocide coated enclosure, along with many viable micro-organisms that use cilia (like bivalve veligers and tube worms with speeds in the 0.5-2 mm/s range). But even while living fouling organisms were present inside of the enclosure and/or in direct contact with the substrate, the enclosure protective features prevented these living and/or viable organisms from thriving and/or colonizing on the protected substrate.

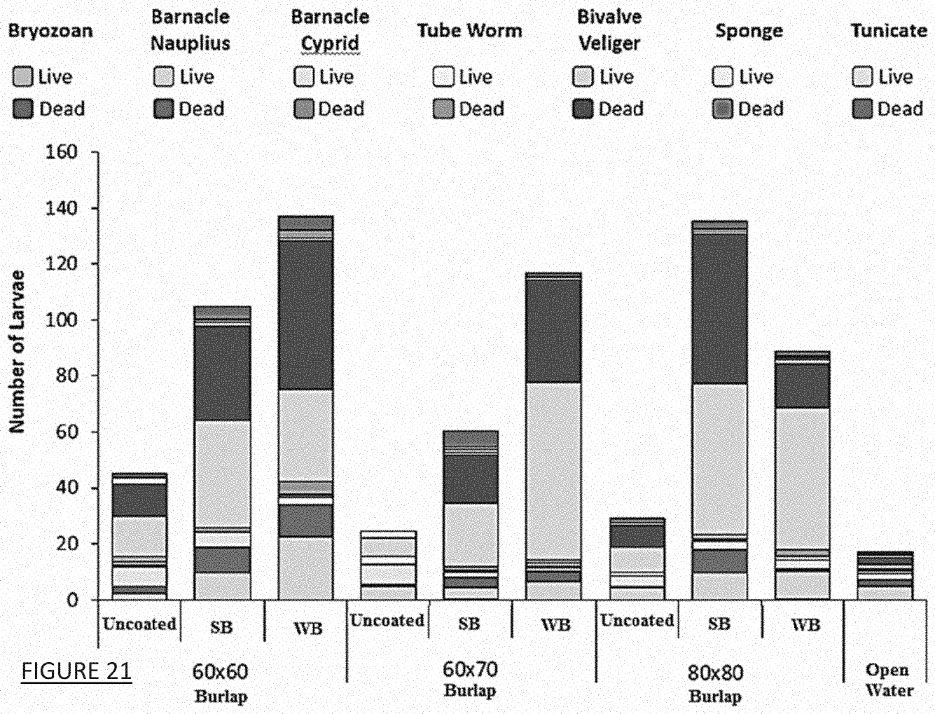

FIG. 21 depicts various plankton types and conditions (i.e., live or dead) identified in the various enclosures, by permeable fabric type. In various enclosure tests, the results showed there were more poor than good swimmers within the biocide coated fabric enclosures, suggesting that the biocide may have injured or otherwise affected the larvae that were swept into the enclosures with coated fabric and then could not get out. Additionally, the “good” swimmers may have been able to swim out of the enclosure and the “poor” swimmers might not have been able to leave the enclosure due to limited water movement within the enclosure. This observation was further supported by the fact that there were significantly more poor swimmers in coated fabric enclosures than the uncoated fabrics and open samples. It also appeared that there were more plankton total in coated fabric enclosures than in uncoated.

While some embodiments of the instant invention have been described in the form of a skirt-type enclosure, the anti-biofouling enclosure can be shaped to fit any structure. In various embodiments, the enclosure material can be provided in the form of a rolled up sheet, with or without the biocide or other coating applied to the outer surface of the sheet material, which could include significant penetration into and/or through the sheet material, or could alternatively include a biocide or other anti-biofouling material incorporated into the sheet material, which could utilize microencapsulation to customize the release of the biocide. As such, the anti-biofouling enclosure can be placed onto various types of aquatic structures, such as netting, in-take pipes, sewage pipes and/or holding tanks, water system control valves and safety valves, offshore systems, irrigation systems, power plants, pipeline valves and safety control systems, military and commercial monitoring sensors and arrays, et al. Other embodiments could include support columns for aquatic structures, bridges, flood barriers, dikes and/or dams. To extend the life of subsurface structures that extend above the water, the support and base structures could incorporate wrappings (tight or loosely bound) and/or similar enclosures.

Other objects that could be protected include tethered and/or free-floating structures such as buoy and/or sensors. An enclosure can be attached to the portion of the buoy that is near or in direct contact with the aquatic environment to prevent the accumulation of biofouling within those areas, as well as wrapped or enclosed/bounded envelope structures, blankets and/or sleeves placed around linkages and/or cables which anchor the buoy to the sea floor.

Once an enclosure is properly positioned about the substrate to a desired degree (including embodiments that may not be fully enclose the substrate, and/or embodiments that may only partially enclose a substrate) the influence of the enclosure in some embodiments will desirably create a unique aqueous environment in the area immediately surrounding the substrate and/or other object, with the goals of (1) buffering and/or minimizing exposure of the substrate from incursions of additional viable micro- and/or macro-fouling agents, (2) filtering any liquids passing into and/or out of the enclosure, (3) reducing and/or eliminating the direct effects of sunlight or other light/energy sources on the substrate and/or biological entities within the differentiated environment, (4) regulating the amount of dissolved oxygen and/or other water chemistry values within the differentiated environment, (5) metering, controlling and/or limiting liquid exchange between the differentiated environment and the open environment, including reducing the velocity and/or turbulence of liquid within the enclosure, (6) insulating and/or isolating the substrate from electrical charges and/or electrically charged fouling particles, and (7) maintaining various water chemistry values, such as pH, temperature, salinity and/or other environmental factors within the differentiated environment in close proximity to those of the surrounding open environment, if desired. Moreover, in various embodiments some or all of the enclosure itself will desirably be protected from significant biofouling by the activity of the biocide coating, the elution of various chemicals from inside of the enclosure, the flexibility of the enclosure material and/or the potential for biofouling agents to slough off of or other detach from the enclosure's structure(s).

Biofouling Protection with Water Chemistry Changes

In many of the embodiments described herein, the disclosed biofouling protective systems can provide significant levels of protection for substrates once the enclosure or filtration media “separates,” “encloses” or otherwise partially and/or fully creates a “separated” region of water in proximity to the substrate or other systems, with many embodiments still allowing some amount of liquid exchange between the open environment and the separated or enclosed environment, such as by permeation through the walls of the enclosure to pass into the differentiated environment, and similarly some amount of liquid from the differentiated environment can still permeate through the walls of the enclosure to pass into the open environment. Desirably, the design and positioning of the protective enclosures about the substrate may optionally alter various water chemistry features and/or components of the enclosed environment to a meaningful degree, as compared to those of the open aqueous environment. In various instances, the enclosure may induce some water chemistry features to be “different” as compared to the surrounding aqueous environment, while other water chemistry features may remain the same as in the surrounding aqueous environment. For example, where dissolved oxygen levels may often be “different” between the differentiated environment and the open environment, the temperature, salinity and/or pH levels within the differentiated and open environments may be similar or the same. Desirably, the enclosure can affect some water chemistry features in a desired manner, while leaving other water chemistry features minimally affected and/or “untouched” in comparison to those of the surrounding open aqueous environment. Some exemplary water chemistry features that could potentially be “different” and/or which might remain the same (i.e., depending upon enclosure design and/or other environmental factors such as location and/or season) can include dissolved oxygen, pH, total dissolved nitrogen, ammonium, nitrates, nitrites, orthophosphates, total dissolved phosphates, silica, salinity, temperature, turbidity, chlorophyll, etc.

In some exemplary embodiments, a measure of one or more water chemistry features may be “different” inside of the enclosure as compared to an equivalent measurement outside of the enclosure (which may include measurement at some distance removed from the enclosure to account for potential elution outside of the enclosure—such as a distance of only 1 or 2 inches or more, or even 1, 2, 3, 5, 10, 20 feet or greater from the enclosure outer wall)). Such “difference” may include a difference of 0.1% or greater between inside/outside measurements, or a difference of 2% or greater between inside/outside measurements, or a difference of 5% or greater between inside/outside measurements, or a difference of 8% or greater between inside/outside measurements, or a difference of 10% or greater between inside/outside measurements, or a difference of 15% or greater, or a difference of 25% or greater, or a difference of 50% or greater, or a difference of 100% or greater. In addition, such differences may be for multiple chemistry factors with unequal differences or may include an increase of one factor and a decrease of another factor. Combinations of all such described water chemistry factors are contemplated, including situations where some water chemistry factors remain essentially the same for some factors, while various differences may be noted for other factors.

In various embodiments of the present invention, the enclosure can create a “differentiated aqueous environment” in proximity to the substrate, but the enclosure may also permit a controlled or metered amount of “mixing” and/or other transport between the liquid and/or other substances within the enclosure with those of the surrounding aqueous environment (i.e., outside of the enclosure). This controlled transport, which can occur both into and/or out of the enclosure, desirably creates a unique aqueous environment within portions of the enclosure that inhibits and/or prevents significant amounts of biofouling from forming on the substrate. For example, dissolved oxygen in seawater is derived from one of three sources: (1) atmospheric oxygen which dissolves, diffuses and/or mixes (i.e., by aeration) into the water's surface, (2) oxygen that is released by algae, underwater grasses and/or other biologic processes due to photosynthesis or other metabolic pathways, and/or (3) oxygen present in stream and river water flows that mixes into the seawater. When properly designed and deployed in a suitable environment, the enclosure structure may also desirably block and/or inhibit significant amounts of sunlight from penetrating into the differentiated aqueous environment, thereby reducing the quantities of dissolved oxygen sourced from photosynthesis within the enclosure. In addition, the presence of the enclosure walls will desirably reduce and/or inhibit the physical bulk flow of water into, through and/or out of the enclosure due to horizontal and/or vertical water flow (or combinations thereof) due to a variety of factors, including because the enclosure walls can flex to varying degrees, which allows them to provide at least a partial barrier to water flow while also allowing the enclosure walls to alter in shape and/or orientations to some meaningful degree to reduce flow resistance, and also because the flexible enclosure walls can “move” and/or deform with the waterflow to varying degrees, thus reducing pressure differentials which impel water flow through the pores of the wall fabric.

In at least one exemplary embodiment, when an enclosure of the present invention is first placed around a substrate, dissolved oxygen in the differentiated aqueous environment can be quickly depleted from the interior of the enclosure by biologic, metabolic and/or other processes and/or activities within the enclosure to create an oxygen-depleted region within the enclosure. Because the enclosure allows some bulk flow of water into and/or out of the enclosure however (i.e., water exchange between the enclosure and the surrounding “open” waters), some amount of oxygen replenishment will occur with the inflow of oxygenated water through the enclosure walls, and some amount of oxygen-depleted water will pass out of the enclosure walls. In general, the oxygen replenishment into the enclosure occurs at a lower rate than it is normally being utilized by the microflora and/or microfauna in open waters, which induces and/or forces at least some of the microflora and/or microfauna within the enclosure to alter their activity, behavior, reproduction, metabolism, diversity, composition and/or relative distribution to accommodate the artificial conditions within the enclosure, as well as affects various natural chemical processes such as oxidation and/or the activity of free radicals, etc. Moreover, as the open water oxygen level and/or exchange rate fluctuates due to a variety of factors (day/night cycle, current/tidal flows and/or other water movement, aeration of water due to wind and/or storm activity, etc.), the inflow of dissolved oxygen will change, which alters the levels of oxygen and/or other chemicals within the enclosure, which induces further changes in the activity, behavior, reproduction, metabolism, composition and/or relative concentrations of the microflora and/or microfauna within the artificial environment inside the enclosure. Desirably, the artificial environmental conditions created by the enclosure will thereby inhibit and/or prevent the settlement, recruitment, growth and/or colonization of the substrate by fouling organisms, and will also induce a unique mix of metabolic and/or other processes to be occurring within the enclosure.

While in some embodiments the enclosure may substantially surround and/or encompass an exterior surface of the substrate, in some alternative applications the enclosure may desirably be positioned and/or configured to protect substrates located outside of the enclosure, wherein the “open aqueous environment” might be considered to be located within the enclosure, and the “enclosed aqueous environment” could be positioned between the exterior walls of the enclosure and the interior walls of the substrate. For example, in a water storage tank or cooling water inlet system, the interior walls of the tank and/or system might constitute the “substrate” to be protected, and some or all of water being pumped into the tank or system might constitute the “open aqueous environment” from which the substrate is sought to be protected. In such a case, an enclosure such as described herein could be positioned around the water inlet (or the enclosure walls could be positioned at some point between the water inlet and the tank walls), with the enclosure desirably creating the “different” environmental condition(s) proximate to the tank walls and protecting the tank walls and/or other internal structures (i.e., heat exchanger tubing) from the various effects of biofouling such as described herein.

If desired, the one or more enclosure walls can include perforations and/or penetrations in the walls, which could include perforations and/or penetration of differing sizes for employment at different depths along the enclosure wall. For example, an enclosure wall could include none or very small perforations at a shallower level of the wall, with larger perforations in the same wall which are formed at deeper levels of the wall, with each wall section including the same and/or different perforation sizes at the same or differing depths of the water column.

In various embodiments, the dissolved oxygen levels within various enclosure embodiments will be generally lower than the dissolved oxygen of the surrounding open waters, creating an artificial environment that causes the microflora and/or microfauna within the enclosure to alter their activity, behavior, reproduction, metabolism, diversity, composition and/or relative distribution to accommodate these artificial conditions. Moreover, these artificial conditions within a given enclosure will likely be constantly changing, such as where the level of dissolved oxygen within an enclosure “follows” or “lags” behind the changing oxygen levels outside of the enclosure.

In general, changes in the net amount of dissolved oxygen within an enclosure such as described herein should be due to any inflow of dissolved oxygen (i.e. typically a source of increased oxygen supplies) contained in water flowing through the enclosure walls into the enclosure and/or any other enclosure openings, minus an amount of oxygen consumed within the enclosure (i.e., decreasing oxygen supplies) by various processes occurring within the enclosure, including oxidative or similar processes and/or metabolic process of the flora and/or fauna therein (and to some extent the flow of any dissolved oxygen in deoxygenated water flowing out of the enclosure). Where the external dissolved oxygen levels are higher and/or where water inflow brings more oxygen into the enclosure than is consumed within the enclosure and/or leaves the enclosure, the net oxygen level in the enclosure should increase to some extent, and where external dissolved oxygen levels are lower and/or when water inflow is slowed and brings less oxygen than is consumed within the enclosure, the net oxygen level in the enclosure should decrease to some extent. The dissolved oxygen levels within the enclosure thus “react” or “lag” behind the dissolved oxygen levels of the waters surrounding the enclosure, with enclosure DO levels typically (but not necessarily always) below the DO of the surrounding waters. Moreover, the DO levels within a properly constructed and applied enclosure will often generally mimic the diurnal and/or seasonal fluctuations of dissolved oxygen outside of the enclosure, but at a reduced level. Each of these changes in the differentiated environment will desirably cause the macrofouling and microflora and/or macrofouling and microfauna within the enclosure to further alter their activity, behavior, reproduction, metabolism, diversity, composition and/or relative distribution to accommodate the change in artificial conditions.

In addition to inducing generally lower dissolved oxygen levels within the enclosure than those outside of the enclosure, various embodiments of the present invention can reduce and/or limit the amount of variation between highest and lowest oxygen levels in the open environment, and additionally have the capability to reduce or “smooth out” many of the transient variations in oxygen levels that can contribute to fouling in the open environment. Desirably buffering or smoothing of the DO levels within enclosures will mediate the variation in dissolved oxygen within the enclosure as compared to a more “jagged” and/or abrupt DO level changes of the open environment outside of the enclosure.

In various enclosure embodiments, the dissolved oxygen levels within the local aquatic environment will desirably be maintained on an average over a 24 hour period or at levels above 5%, or 8%, or 10%, or 12%, or 15%, or 20%, or 25%, or 50%, or 60%, or 75%, or 80%, or 85%, or 90%, or 100%, or 105%, or 110%, or 115%, or 120%, or 125% concentration or above other dissolved oxygen levels including above 15%, above 14%, above 13%, above 12%, above 11%, above 10%, above 9%, above 8%, above 7%, above 6%, above 5%, above 4%, above 3%, above 2%, above 1% and/or above 0% dissolved Oxygen. In some embodiments, however, it may be acceptable and/or even desirous for the dissolved oxygen levels within the enclosure to reduce to anoxic levels, which may include oxygen concentrations of less than 0.5 milligrams of oxygen per liter of liquid within some or all of the enclosure. Such anoxic conditions will desirably not be maintained for extended periods of time, but rather tend to be relatively transient phenomena having a duration of less than a minute, or less than 10 minutes, or less than a half hour, or less than an hour, or less than 3 hours, or less than 12 hours, or less than 24 hours, or less than a week, depending upon the relevant enclosure design, the local water conditions, the substrate to be protected, the relevant season(s), local fouling pressures and/or other factors. Desirably, such reduced and/or anoxic oxygen levels would not be maintained for a period of time that would be significantly deleterious to the underlying substrate and/or structure of the enclosure.

In various embodiments, the reduced dissolved oxygen levels created within the enclosure will significantly contribute to the reduction of biofouling of the substrate, in that the reduced availability of oxygen can render it difficult for some fouling organisms to colonize and/or thrive within the enclosure and/or on the substrate. In addition, the reduction in dissolved oxygen levels within the enclosure can increase the creation of, and/or greatly reduce the opportunity for other organisms to process and/or eliminate, waste materials such as hydrogen sulfide and/or ammoniacal nitrogen (i.e., free ammonium nitrogen, Nitrogen-Ammonia or NH₃—N), which are both detrimental and/or even toxic to a variety of aquatic organisms and/or microorganisms. For example, the biologically driven nitrogen cycle, which occurs in various bodies of water, can contribute greatly to the reduction of free Oxygen within the enclosure, with NH₃—N levels being at least partially dependent on available dissolved Oxygen levels. In addition, in some embodiments an anammox reaction may potentially be initiated and/or sustained by bacteria within the enclosure, which may produce hydrazine and/or other byproducts that similarly inhibit marine growth. In general, the concentrations of these byproducts will be greater inside of the enclosure than outside of the enclosure (although various of these detrimental compounds—including various known and/or unknown microbial “toxins” and/or inhibitory compounds—may elute through the walls of the enclosure at varying rates), and in some embodiments the individual concentrations and/or comparative ratios of these byproducts within the enclosure may fluctuate for a variety of reasons.

For example, in various embodiments the enclosures described herein can induce the creation of metabolic wastes, toxins or other inhibitory compounds such as NH₃—N in concentrations ranging from 0.53 mg/L to 22.8 mg/L within the enclosure, which can be toxic to various freshwater organisms (typically dependent upon pH and/or temperature). In other embodiments, the concentrations of NH₃—N created in the differentiated environment within the disclosed enclosures may range from 0.053 to 2.28 mg/L, which may inhibit biofouling formation within the enclosure and/or on exterior surfaces of the enclosure. In addition, at levels as low as 0.002 mg/L or greater of NH₃—N, the ability of various aquatic flora and/or fauna to colonize and/or reproduce can be significantly degraded.

It is further proposed that, in some exemplary embodiments, the fluctuations and/or variations in the individual levels of water chemistry constituents within the enclosure, such as dissolved oxygen, ammonium, total dissolved nitrogen, nitrates, nitrites, orthophosphates, total dissolved phosphates and/or silica (as well as various others of the chemistry components described herein), forms an important aspect of some embodiments of the present invention, in that the artificial environments created within the enclosure will desirably “promote” and/or “inhibit” the thriving of different macrofouling and microflora and/or macrofouling and microfauna at different periods of time. Such continuous changes in the differentiated environment desirably forces the various organisms present within and/or in proximity to the enclosure to constantly adapt and/or change to accommodate new environmental conditions, which tends to inhibit predominance of a single species or species grouping within and/or in proximity to the enclosure. This can have the effect of enhancing competition between various of the flora and/or fauna within the enclosure, which may inhibit and/or prevent the domination of the enclosure by a single variety, species and/or distribution of flora and/or fauna, and thereby reduce the potential for a predominant species of bacteria or other micro or macro entities to have an opportunity to thrive and/or devote energy to fouling the substrate or forming a base to which other fouling organisms may attach.

In various embodiments, the enclosure may induce the formation of a water chemistry factor which inhibits fouling such as ammoniacal nitrogen in higher concentrations within the enclosure than outside of the enclosure. If desired, a concentration of ammoniacal nitrogen within the enclosure may be obtained that may be equal to or greater than 0.1 parts per billion (ppb), may be equal to or greater than 1 parts per billion (ppb), may be equal to or greater than 10 parts per billion (ppb) and/or may be equal to or greater than 100 parts per billion (ppb). In various embodiments, the enclosure may induce the formation of a water chemistry factor which inhibits fouling such as nitrite in higher concentrations within the enclosure than outside of the enclosure. If desired, a concentration of nitrite within the enclosure may be obtained that may be equal to or greater than 0.1 parts per billion (ppb), may be equal to or greater than 0.1 parts per million (ppm), may be equal to or greater than 0.5 parts per million (ppm) and/or may be equal to or greater than 1 parts per million (ppm).

Another important aspect on the enclosure in many embodiments of the present invention is that the enclosure desirably inhibits but does not completely prevent the flow of water into and/or out of the enclosure under typical water conditions. In many cases, a substrate to be protected will be secured, connected, attached and/or tethered to one or more solid, immovable objects such as the sea floor, anchors, walls, piers, pilings, quays, wharves or other structures, which can constrain the movement of the substrate to varying degrees relative to the water in which it sits, which can induce some level of bulk water flow past the various surfaces of the substrate. However, various embodiments of enclosures described herein (which are typically attached to the substrate, to various supporting structures thereof and/or to other adjacent objects) will desirably interrupt and/or impeded the ambient flow of water immediately adjacent to the substrate surfaces to some degree, and will more desirably maintain an enclosed or bounded body of water in direct contact with the substrate under many water flow conditions. Various enclosure designs disclosed herein accomplish this objective via flexibility of various enclosure components, which allows the enclosure and the enclosed or bounded body of water therein to deform and/or be displaced to varying degrees in response to impingement and/or movement of surrounding waters.

In various embodiments, the placement of an enclosure within the aqueous medium about a substrate will desirably “modulate” the dissolved oxygen and create a dissolved oxygen differential between waters of the inside and outside of the enclosure, which desirably provides a significant improvement in preventing fouling of the protected article. In many cases, dissolved oxygen modulation of the differentiated environment can encompass the creation of a meaningfully lower dissolved oxygen level within the enclosure versus the external environment, with this dissolved oxygen level within the enclosure fluctuating by varying degrees in response to internal oxygen consumption and external dissolved oxygen levels. In addition, a secondary gradient between the dissolved oxygen of the “bulk water” within the differentiated environment and the dissolved oxygen in the water within a “boundary layer” at the surface of the protected substrate or article may also exist, at least in part due to the lower energy environment within the enclosure compared to the external environment and/or the absence of significant turbulence and/or eddy flow currents that can “mix” the water within the enclosure. These localized differential conditions may be caused by the consumption of oxygen and/or nutrients by organisms and/or other factors at the substrate's or article's surface and/or in the water column within the enclosure, which can lead to a further depleted “boundary layer” that contributes to the lack of biofouling and/or creation of an anti-fouling biofilm on the protected article.

In general, 100% DO (“dissolved oxygen”) means that the water contains as much dissolved oxygen molecules as possible at equilibrium, while over 100% DO means the water is “super-saturated” with oxygen (which can occur often in seawater due to the effects of photosynthesis, atmospheric exchange and/or temperature changes). At equilibrium, the proportion of each gas in the water may approximate, but is rarely identical to, the proportion of each gas in the atmosphere. Thus, at equilibrium the percentage of oxygen in the water (compared to the other gases in the water) may be equivalent to the percentage of oxygen in the atmosphere (compared to the other gases in the atmosphere). However, the specific concentration of dissolved oxygen in a body of water will typically vary based on temperature, pressure, salinity and other factors such as the availability of photosynthesis and/or surface agitation. First, the solubility of oxygen decreases as temperature increases. Thus, warmer water contains less dissolved oxygen at 100% saturation than does cooler water, and cooler water can therefore carry more oxygen. For example, at sea level and 4° C., 100% air-saturated water would hold 10.92 mg/L of dissolved oxygen. But if the temperature were raised to room temperature, 21° C., there would only be 8.68 mg/L DO at 100% air saturation. Second, dissolved oxygen increases as pressure increases. Deeper water can hold more dissolved oxygen than shallow water. Gas saturation decreases by 10% per meter increase in depth due to hydrostatic pressure. Thus, if the concentration of dissolved oxygen is at 100% air saturation at the surface, it would only be at 70% air saturation three meters below the surface even though there would still be the same amount of oxygen available for biological demand. Third, dissolved oxygen decreases exponentially as salt levels increase. Accordingly, at the same pressure and temperature, saltwater holds about 20% less dissolved oxygen than freshwater. In addition, the dissolved oxygen at any specific time may not be at equilibrium with the environment because the factors above have changed (for example, the air or water temperature may vary over the course of the day) and equilibrium may not yet have been achieved. Moreover, wind and other agitation of the water may lead to aeration of the water beyond that expected under ambient conditions, and local oxygen usage and/or production by biologic and/or other processes can continually increase or decrease the amount of dissolved oxygen.

In various embodiments, once an enclosure as described herein is placed about a substrate in an aqueous environment, the dissolved oxygen in the enclosure will desirably be utilized by various naturally occurring biologic and/or other processes such that the localized levels of dissolved oxygen within the enclosure begin to change relative to the levels of dissolved oxygen in the water outside of the enclosure. Because osmotic transport of dissolved oxygen occurs very slowly in water, and because there typically is little to no sunlight energy streaming into the enclosure to permit oxygen production via photosynthesis, the primary source of additional dissolved oxygen into the enclosure generally comes from bulk transport of water outside of the enclosure (which typically carries dissolved oxygen at a higher percentage) into the enclosure through openings in the enclosure walls and other components. This additional dissolved oxygen is then utilized within the enclosure in a similar manner as previously described, with this cycle continually repeating, until the dissolved oxygen levels within the enclosure typically reach a steady level, which is generally above anoxic levels but is also significantly lower than oxygen levels outside of the enclosure.

In various embodiments, the dissolved oxygen level within an enclosure may be consistently lower in the enclosures than the open water reading surrounding the enclosure, thereby creating a “different environment” than the surrounding aqueous environment. However, because the various enclosures allowed various levels of “fluid exchange” with the external aqueous environment, many other characteristics of the overall water quality within the enclosures (including pH, temperature and salinity) may be the same or similar to those of the surrounding aqueous environment. However, because natural oxygen levels over a 24-hour period are typically fluctuating (i.e., the oxygen levels outside of the enclosure will typically fluctuate in a diurnal fashion—with higher levels of dissolved oxygen occurring during the daytime due to photosynthesis, and dissolved oxygen levels dropping during periods of darkness), within the enclosure the levels of dissolved oxygen over the same 24-hour period will typically fluctuate in a similar fashion as the levels outside of the enclosure, because the quantity of “dissolved oxygen replacement” which enters the enclosure via bulk fluid transport will change depending upon outside dissolved oxygen levels. In some instances, such as when oxygen levels outside of the enclosure are low, inside of the enclosure may have higher oxygen levels for a limited period of time. Moreover, because the replacement dissolved oxygen enters the enclosure proximate to the walls of the enclosure, and there is often limited bulk movement and/or mixing of water within the enclosure, causing a gradient of higher to lower dissolved oxygen to typically be present between the enclosure walls and the surface of the protected substrate.

In many cases, the enclosures described herein can desirably control, mitigate and/or “smooth” the level(s) of dissolved oxygen in the differentiated aqueous environment (i.e., proximate to the protected substrate) as compared to the DO levels of water in the surrounding open aqueous environment. In many instances, the DO levels within the enclosure will desirably be lower than the DO levels of the surrounding aqueous environment, although the differentiated DO levels may periodically exceed the DO levels of the surrounding open aqueous environment in some embodiments and/or some conditions. In addition, the enclosures described herein will desirably maintain the differentiated DO levels above anoxic DO levels, although periodic and/or intermittent differentiated DO levels falling within the anoxic range may be acceptable in various situations, including situations where the anoxic period is short enough to allow little or no anoxic corrosion of the substrate to occur.

In various embodiments, a dissolved oxygen level of 0.5 mg/L or less can be considered undesirable and/or “anoxic” conditions, while dissolved oxygen levels of approximately 2 mg/L (or less) being capable of causing significant negative effects to an aqueous organism's ability to colonize, thrive and/or reproduce in an aqueous environment.

In many cases, a significant change in the dissolved oxygen content of a given aqueous environment can provoke a quick response from many organisms, with a downward change in DO levels being one of the parameters to which organisms respond the fastest. The broad classification of bacteria or other organisms as anaerobic, aerobic, or facultative is typically based on the types of reactions they employ to generate energy for growth and other activities. In their metabolism of energy-containing compounds, aerobes require molecular oxygen as a terminal electron acceptor and typically cannot grow in its absence. Anaerobes, on the other hand, typically cannot grow in the presence of oxygen—oxygen is toxic for them, and they must therefore depend on other substances as electron acceptors. Their metabolism frequently is a fermentative type in which they reduce available organic compounds to various end products such as organic acids and alcohols. The facultative organisms are the most versatile. They preferentially utilize oxygen as a terminal electron acceptor, but also can metabolize in the absence of oxygen by reducing other compounds. For example, much more usable energy, in the form of high-energy phosphate, is obtained when a molecule of glucose is completely catabolized to carbon dioxide and water in the presence of oxygen (38 molecules of ATP) than when it is only partially catabolized by a fermentative process in the absence of oxygen (2 molecules of ATP). In some cases, a reduction in DO levels within an enclosure may prompt an organism to alter its rate and/or type of metabolic pathways, which may include adaptation to the new DO levels, while other organisms may simply enter a stasis state and/or die. Where an enclosure environment has an undesirably low level of DO, organisms will generally seek another environment with higher DO levels to settle (and/or may seek to abandon a lower DO environment), as remaining within the lower DO environment of the enclosure can negatively affect settlement ability and/or can cause various health issues and/or death if the organisms does not find an increased DO environment.

In various embodiments, an optimal and/or desired level of DO within the enclosure could be a DO content of at least an average of 20% or greater, or at least an average of 50% or greater, or at least an average of 70% or greater, or within a range of an average of 20% to 100%, or within a range of an average of 33% to 67%, or within a range of an average of 50% to 90%, or within a range of an average of 70% to 80%. Alternatively, a desired level of DO within the enclosure could be a DO content of at least an average of 10% less than a level of dissolved oxygen in water detected some distance from the outside of the enclosure (i.e., at 1 or 2 or 5 or 10 or 12 inches, or 2 or 5 or 10 feet away from the enclosure).

In various embodiments, the modulation of dissolved oxygen within the enclosure will induce a dissolved oxygen differential of at least 10% between the differentiated environment within the enclosure and the open aqueous environment outside of the enclosure. In various embodiments, this differential may occur within/after a few hours after the enclosure is placed within the aqueous medium, or it may occur within 2 to 3 hours, 6 hours, 12 hours, 1 day, 2 days, 3 days, 4 days, 5 days, 6 days, 1 week, 2 week or even within a month after enclosure placement. In various alternative embodiments, a desired dissolved oxygen differential of at least 5%, at least 10%, at least 15%, at least 20%, at least 25%, at least 50%, at least 70% and/or at least 90% or greater will be created.

In many cases, the Dissolved Oxygen levels within a given enclosure will be depleted by biologic and/or other processes, with the maintenance of Dissolved Oxygen levels within various enclosure designs potentially dependent upon the influx of dissolved oxygen from the surrounding aqueous environment (when such DO levels are higher than the DO levels within the enclosure) through the walls of the enclosure—which may also occur at some level via diffusion through the wall structure itself as well as accompanying the bulk transfer of water via the permeable enclosure walls. The structures and methods described herein desirably provide an enclosure having an adequate level of “water exchange” to provide sufficient water flow (and/or dissolved oxygen flow) into and/or through the structure in order to avoid the creation of an anoxic environment within the enclosure for an extended period of time, which could lead to the corrosion of metal surfaces, but also desirably creating a local aquatic environment and/or biofilm coating on the substrate that minimizes and/or prevents aquatic organisms from settling and/or thriving on the substrate. In particular, the devices of the invention will desirably provide a permeability level that is intended to maintain dissolved oxygen (DO) levels within the differentiated aquatic environment (i.e., around the object to be protected) at levels that are “different” than DO level(s) of the surrounding aqueous environment.

In one exemplary embodiment, open aquatic environment DO levels can range from approximately 90% to approximately 150% DO, while the DO levels of the differentiated aquatic environment (i.e., containing the substrate to be protected) can range from about 50% to about 110% DO—which in this embodiment inhibited the ability of various organisms to foul the substrate (which is believed to substantially inhibit and/or prevent their ability to thrive and/or colonize), and which did not “dip” for an extended period of time to DO levels where anoxia might occur and promote corrosion on the substrate (although periodic anoxic conditions for relatively shorter time periods may have occurred and may have been acceptable for a variety of reasons). In various embodiments, the presence of the enclosure may also mediate, “smooth out” or “buffer” the natural spikes and/or dips that may occur in the dissolved oxygen levels of the surrounding aqueous environment, which may further prevent and/or inhibit aquatic organisms from settling and/or thriving on the protected substrate.

In at least one alternative embodiment, an enclosure design could include wall material that may be permeable to one or more water chemistry factors, such as dissolved oxygen (i.e., by diffusion and/or osmotic transport) while not facilitating transport or passage of one or more other factors, chemicals and/or even the water itself, which might allow a sufficient level of oxygen (or other chemistry factor) to penetrate the enclosure to create some or all of the water chemistry differences described herein. Such an alternative design may have some potential to create various of the biofouling improvements disclosed herein.

In various other alternative embodiments, particular enclosure designs could include features to supplement various water chemistry components (such as dissolved oxygen, for example) within the enclosure to obtain a desired fouling protection. For example, an enclosure having walls that are somewhat less permeable than an optimal level may include a supplemental source of dissolved oxygen, which could be utilized to maintain dissolved oxygen levels within the enclosure above an undesired anoxic level. Alternatively, one embodiment of an enclosure could include a supplemental fluid supply pump or even an externally mounted “propeller” which can be activated to induce additional fluid outside of the enclosure to pass through and/or into the enclosure, thereby providing additional supplemental dissolved oxygen and/or waste removal from the enclosure, with the pump/propeller actuated and/or deactivated on a periodic basis and/or based on various measurements of water chemistry factors taken within the enclosure, which could include water chemistry factors directly influenced by the design and placement of the enclosure, as well as water chemistry factor changes that may result from one or more water chemistry factors directly altered by the presence of the enclosure. Alternatively, a supplemental pump and/or pumping system could be utilized to pump water directly into and/or out of the enclosed or bounded body of water without said water passing through the permeable enclosure walls.

In place of and/or in addition to a reduction of the dissolved oxygen levels in the water contained in the enclosure, a wide variety of other water chemistry factors may be affected by the design and placement of the enclosure embodiments described herein, including water chemistry factors which may significantly retard and/or prevent fouling of a protected substrate. For example, when oxygen is depleted within an enclosure, some species of naturally occurring bacteria within the enclosure will typically first turn to a second-best electron acceptor, which in sea water is nitrate. Denitrification will occur, and the nitrate will be consumed rather rapidly. After reducing some other minor elements, these bacteria eventually turn to reducing sulfate, which results in the byproduct of hydrogen sulfide (H₂S), a chemical toxic to most biota and responsible for a characteristic “rotten egg” smell. This elevated level of hydrogen sulfide within the enclosure, among other chemicals, can then inhibit fouling of the substrate in a desired manner as described herein. Moreover, the hydrogen sulfide within the enclosure can also elute through the walls of the enclosure (i.e., with bulk flow of water out of the enclosure) and potentially inhibit fouling growth in the pores of and/or on the external surfaces of the enclosure.

In addition to creating localized conditions that inhibit fouling of a protected substrate contained within an enclosure, the various embodiments of enclosures described herein are also extremely environmentally friendly, in that any toxic and/or inhospitable conditions created within the enclosure are quickly neutralized outside of the enclosures. For example, when 1 ml of fluid enters the enclosure through an opening, it can be assumed that approximately 1 ml of enclosure fluid will be displaced outside of the enclosure to the external environment. This displaced fluid will typically contain components that are toxic and/or inhospitable to marine life (which desirably reduce and/or prevent fouling from attaching to the substrate within the enclosure). Once outside the enclosure, however, these components are quickly degraded, oxidized, neutralized, metabolized and/or diluted in the external aqueous environment by a wide variety of naturally-occurring mechanisms, which generally cause no lasting effect on the aquatic environment, even in close proximity to the enclosure itself. This is highly preferable to existing antifouling devices and/or paints that incorporate high levels of biocides and/or other agents, some of which are highly toxic to many forms of life (including fish and humans and/or other mammals), and which can persist for decades in the marine environment.

Desirable Biofilm Formation

Where an enclosure is being utilized to protect a substrate, such as disclosed herein, the biological colonizing sequence on the substrate may significantly vary from the normally expected, open water sequence. For example, where an enclosure such as described herein is utilized, the biological colonizing sequence on the substrate may be interrupted (disrupted, altered, etc.) to reduce and/or minimize the settlement, recruitment and ultimate macrofouling of the substrate. Once positioned around or inside of the substrate (if protecting an inner surface of a substrate, for example), the permeable, protective fabric walls of the filter media and/or the enclosure can desirably filter and/or impede the passage of various micro- and/or macro-organisms into the enclosure, and the different water conditions created between the enclosure walls and the substrate can prevent some and/or all of the organisms from settling on and/or colonizing the substrate if they are already located within the enclosure and/or if they ultimately pass through the enclosure. For example, when microscopic plankton and other traditional non-settling organisms and other settling organisms transit a permeable fabric membrane of an enclosure, the different water conditions within the enclosure may impair or injure some of the plankton, while other plankton which remain alive and active will avoid settling and/or colonizing the substrate surface.

In various embodiments, the initial placement of a biofilm protective enclosure about a substrate can cause and/or induce the formation of a “protective” biofilm layer on the surface of the substrate, with this biofilm layer having various desirable properties such as (1) forming a biofilm layer which minimizes biofilm interference with heat transfer through an underlying surface and/or (2) forming a biofilm layer which subsequently protects the substrate from significant additional fouling, which may even include the provision of biofouling protection after the integrity of an enclosure may be violated and the substrate potentially directly exposed to the outside environment.

In various aspects of the invention, the proper design and use of an enclosure, such as described herein, can create a “different environment” within the enclosure that influences and/or induces the formation of a biological coating, layer and/or biofilm on a surface of the substrate that effectively reduces and/or prevents the settlement of biofouling organisms on the substrate. In some aspects of the invention, this reduction and/or prevention may be due to one or more local settlement cues that discourage (e.g., lessen, minimize, or prevent) the settlement of larvae of biofouling organisms, which may include the discouragement of settlement on the substrate, while in other aspects of the invention the reduction and/or prevention may be due to the absence of one or more positive settlement cues that encourage the settlement of larvae of biofouling organisms, which may similarly reduce settlement on the substrate (and/or various combinations of the presence and/or absence of settlement cues thereof may be involved in various embodiments). In another aspect of the invention, the enclosure may encourage the growth of microorganisms that create one or more local settlement cues that discourage the settlement of larvae of biofouling organisms within the differentiated aquatic environment formed by the enclosure. In a further aspect of the invention, the enclosure may encourage the growth of microorganisms that create one or more local settlement cues that discourage the settlement of larvae of biofouling organisms onto and/or within the enclosure material itself. Accordingly, in these aspects of the invention, larvae of biofouling organisms may be unable or less likely to settle or attach to the submerged substrate or substrate portion(s) protected by the enclosure.

In various embodiments, biofilms can be on the protected substrate, can be formed outside of the enclosure, and/or inside of the enclosure. Biofilms on each location can be different based on an amount of bacteria, cyanobacteria, diatoms, different bacteria phyla, diversity, thickness, insulative ability and/or integrity, as well as by other measures.

There are many generally accepted “standard” progressions or colonizing sequences typically leading to the establishment of a fouling community on a substrate immersed in an aqueous medium such as sea water, brine and/or fresh water. In the typical sequence, immersion of the substrate into the aqueous medium immediately initiates a physical process of macromolecular adsorption, followed by prokaryotic cells and bacteria that rapidly land, attach and form colonies on any surface in the marine environment. In some cases, the subsequent formation of a microbial biofilm may then promote the attachment of algal spores, protozoa, barnacle cyprids and marine fungi, followed by the settlement of other marine invertebrate larvae and macroalgae, while in other cases macrofoulers may settle without a biofilm while still some other macrofoulers may prefer a cleaner surface. Marine fouling is typically described as following four stages of ecosystem development. The chemistry of biofilm formation describes the initial steps prior to colonization. Within the first minute the van der Waals interaction causes the submerged surface to be covered with a conditioning film of organic polymers. In the next 24 hours, this layer allows the process of bacterial adhesion to occur, with both diatoms and bacteria (e.g. Vibrio alginolyticus, Pseudomonas putrefaciens) attaching, initiating the formation of a biofilm. By the end of the first week, the rich nutrients and ease of attachment into the biofilm allow secondary colonizers of spores of macroalgae (e.g. Enteromorpha intestinalis, Ulothrix) and protozoans (e.g. Vorticella, Zoothamnium sp.) to attach themselves. Within 2 to 3 weeks, the tertiary colonizers—the macrofoulers—have attached. These include tunicates, mollusks and sessile Cnidarians.

Where an enclosure such as described herein is utilized, however, the biological colonizing sequence on the substrate can vary. For example, the biological colonizing sequence on the substrate may be interrupted (disrupted, altered, etc.) to reduce and/or minimize the settlement, recruitment and ultimate macrofouling of the protected substrate. Once positioned around the substrate, the permeable, protective fabric walls of the enclosure can desirably filter and/or impede the passage of various micro- and/or macro-organisms into the enclosure, as well as potentially alter various aspects of the water chemistry within the enclosure.

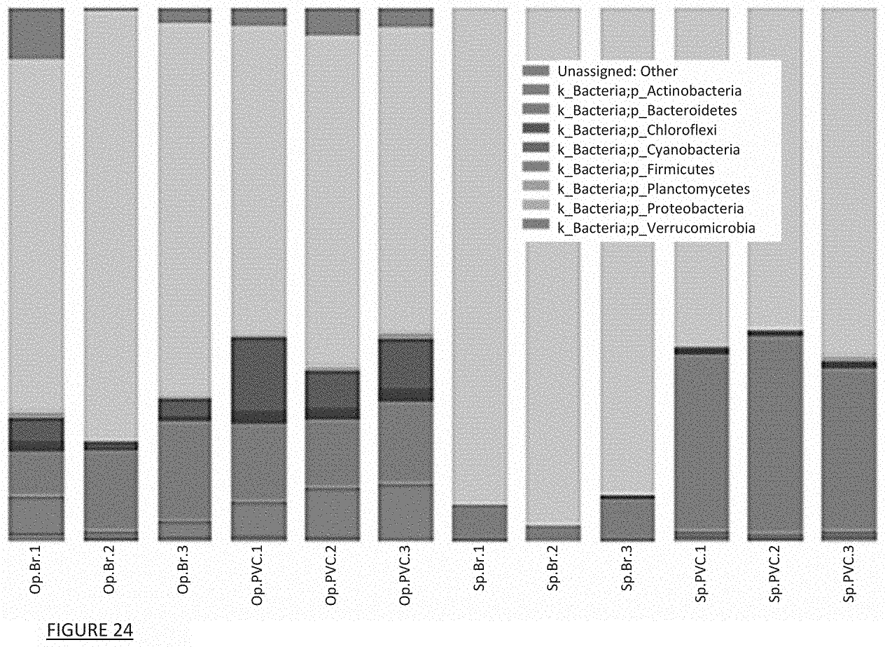

FIG. 24 graphically depicts various distributions of bacterial phyla in biofilms formed on substrates for open samples (six leftmost bars) and substrates within various enclosure embodiments (six rightmost bars) in seawater, with Table 7 (below) containing the underlying data being depicted in FIG. 24. The bacterial biofilms that formed on the substrate or other article protected by an enclosure was meaningfully different from any natural biofilm that form on a substrate or other object in the open ocean or other aqueous environment in the proximity to that protected article. In various embodiments, the enclosure's proper design and operation will desirably induce and/or promote the growth and replication of certain combinations of microorganisms, many of which are normally found in different (i.e., often relatively low) levels in the natural environment, and these combinations of microorganisms may have an ability to promote a certain “recruitment and settlement” behavior to other organisms, identifying the surface of the substrate as inhospitable and/or “less desirable” (and signaling this fact through a variety of means).

DNA analysis confirmed that the surface biofilms that form on PVC and bronze substrates inside of various protected enclosure embodiments were significantly different from those formed on similar substrates outside of the enclosure, and this is also true of the biofilm forming communities present within the enclosure as well as the biofilms that form in/on an inner wall surface of the enclosure. For example, biofilms that appeared on PVC and bronze article coupons in open waters were thicker and more diverse compared to biofilms appearing on PVC and bronze article coupons protected by an enclosure of the present invention. In addition, macrofouling was observed on the articles in open waters; whereas little to no macrofouling was present on the substrates protected by enclosures. In some embodiments, the biofilm on the enclosed substrates was less diverse that the open biofilms, with different amounts of diatoms, bacteria, cyanobacteria and differing distributions of bacterial phyla. In addition, the dominant bacterial phyla and bacterial distribution within each enclosure (and/or on each substrate) were markedly different for each enclosure design. For example, as best seen in FIG. 24 and supported by data of Table 7, the PVC substrate within a spun poly enclosure (three rightmost bars) were dominated by Proteobacteria (large grouping at top of bar) and Bacteroidetes (second largest grouping towards the bottom of the bar). In contrast, the bronze substrate within a spun poly enclosure (bars 6 through 9) were dominated by Proteobacteria, with a much smaller remainder portion being dominated by Bacteroidetes. This distribution chart of the dominant bacterial phyla in the biofilms are for open bronze bars (first through third columns), open PVC bars (fourth through sixth columns), enclosed bronze bars (seventh through ninth columns) and enclosed PVC bars (tenth through twelfth columns). Additionally, the biofilm “integrity” for the enclosed substrates was different from the open samples, in that the biofilm on some of the enclosed substrates appeared easier to remove and/or clean from the substrate surfaces as compared to the open substrates.

TABLE 7
DISTRIBUTIONS OF BACTERIAL PHYLA IN BIOFILMS

| | Open | Open | Open | | | | Spun | Spun | Spun | Spun | Spun | Spun |
|---|---|---|---|---|---|---|---|---|---|---|---|---|
| | Bronze | Bronze | Bronze | Open | Open | Open | Poly | Poly | Poly | Poly | Poly | Poly |
| Bacterial Taxa | 1 | 2 | 3 | PVC 1 | PVC 2 | PVC 3 | Bronze 1 | Bronze 2 | Bronze 3 | PVC 1 | PVC 2 | PVC 3 |
| Other | 1.2 | 0.3 | 0.5 | 0.8 | 0.5 | 0.1 | 0.1 | 0 | 0.1 | 0.9 | 0.2 | 0.7 |
| Actinobacteria | 7.2 | 1.5 | 3.1 | 6.6 | 9.4 | 10.5 | 0.1 | 0.1 | 0.2 | 1 | 1.1 | 1 |
| Bacteroidetes | 8.5 | 15.4 | 19.1 | 14.9 | 13 | 15.7 | 6.3 | 2.5 | 8 | 33.2 | 37.2 | 31 |
| Chloroflexi | 1.8 | 0.4 | 0.9 | 2.3 | 2.1 | 2.5 | 0 | 0 | 0 | 0.5 | 0.4 | 0.4 |
| Cyanobacteria | 4.6 | 1.3 | 3.3 | 13.7 | 6.9 | 9.3 | 0.3 | 0.1 | 0.3 | 0.8 | 0.6 | 0.7 |
| Firmicutes | 1.1 | 0.2 | 0.4 | 0.5 | 0.8 | 1 | 0 | 0 | 0 | 0.1 | 0.1 | 0.8 |
| Planktomycetes | 0.2 | 0 | 0.1 | 0.2 | 0.3 | 0.2 | 0 | 0 | 0 | 0 | 0 | 0 |
| Proteobacteria | 65.9 | 80.5 | 69.9 | 57.6 | 61.7 | 57.2 | 93.1 | 97.2 | 91.5 | 63.3 | 60.3 | 65.2 |
| Verrucomicrobia | 9.6 | 0.5 | 2.8 | 3.5 | 5.2 | 3.6 | 0 | 0 | 0 | 0.1 | 0 | 0 |
| TOTAL | 100.1 | 100.1 | 100.1 | 100.1 | 99.9 | 100.1 | 99.9 | 99.9 | 100.1 | 99.9 | 99.9 | 99.8 |

In a number of experiments, various substrates were immersed in an aqueous environment (i.e., natural seawater), with some substrates protected by enclosure designs such as those described herein for a period of three weeks of immersion, at which point the substrates were removed from the seawater and the enclosures and the resulting substrate surface biofilms (which had formed on these substrates during that time) were subjected to DNA analysis. A visual comparison between a bronze substrate protected by an enclosure as compared to an unprotected (i.e., open) bronze substrate depicted a marked reduction in fouling organisms on the protected substrate. Moreover, the biofilms that formed on the open bars (i.e., unprotected PVC and bronze) proved to be significantly thicker than the biofilms on the protected substrates. In addition, one significant difference between the biofilms of the open and differentiated samples was the predominance of Proteobacteria and Bacteroidetes in the biofilms of the protected substrates, as well as the virtual absence of the Verrucomicrobia and the Actinobacteria in the protected biofilms. It is believed that predominance and/or absence of various bacteria in the novel and/or “artificial” or “synthetic” biofilms formed on the substrates within the man-made “differentiated” environment created by the novel enclosures are unique and significantly different artificial biofilms which yield different (and possibly unfavorable) settlement cues than those normal settlement cues presented by biofilm layers formed naturally in the open aquatic environment, which thereby reduces the chance for settlement and/or colonization of the substrate by micro- and/or macro-fouling agents, even in the absence of the enclosure (i.e., after the enclosure is permanently and/or temporarily removed).

In another experimental test, a series of clear glass substrates were immersed in an aqueous environment and analyzed to determine the thickness and types of biofilms/fouling that form on substrates protected and unprotected by novel enclosure designs such as those described herein for a period of thirty days, 8 months and 12 months. These test results concluded that no macrofouling settlement occurred on slides inside the novel enclosures during the entirety of the 30 day test. In contrast, the slides placed in open water continued to accumulate macrofouling through day 30. Macrofouling on the open slides consisted of hydroids, encrusting and arborescent bryozoans, barnacles, tube worms, and sponges, and there was significantly higher settlement on open slides starting on day 14.

With regards to the biofilms on the various substrates, it was determined that the unique biofilm on the slides from inside the protective enclosure were so thin as to be not easily visible, with the biofilm presence indicated by small, adhered clumps of sediment. There was little change in the appearance of the biofilms in these protected slides from day 1 to day 30. Conversely, the open slide biofilms after 30 days of immersion in saltwater, underwent significant changes over the course of the experiment. On day 1, biofilms were very light and similar to the differentiated biofilms. By day 3, however, the open biofilms were dominated by peritrichs (a predatory ciliate that feeds on biofilms). On day 7, the visible portion of the open biofilms consisted of a conglomerate of diatoms, cyanobacteria and microalgae as well as microscopic motile organisms (ciliates, dinoflagellates, etc.) that feed on the sessile biofilm organisms. These unprotected biofilms were even thicker and more developed on day 14 and had accumulated filamentous algae. In addition, the level of dissolved oxygen was significantly higher in the open water than in the novel enclosures on day 1, day 7 and day 14. Moreover, the pH of the liquid was significantly higher in open water than within the novel enclosures after day 14.

After a year of immersion in saltwater, glass substrates, protected with a fabric antibiofouling enclosure, were examined for settlement of organisms. There was no major or minor biofouling or settlement of organisms on the protected glass substrates after 12-months of immersion; however a biofilm had formed on the glass substrate that was protected by a fabric enclosure. This 12-month biofilm ranged from a spotty, patchy, non-continuous thin layer on some substrates to a continuous thin film layer that extended fully across the surface on other substrates. These 12-month biofilm structures were more developed and complex compared to a biofilm on a glass substrate after 30 days; however a biofilm on an unprotected glass substrate after 30 days was exponentially more developed, complex and thicker than the biofilm on the protected glass substrate after 12 months. No cyanobacteria or diatoms were present in the biofilm on the protected glass substrate after 12 months, with the exception of a few trapped (but not settled) centric diatoms. The structure of the 12-month biofilm on the protected glass substrate contained silt trapped in the extracellular polymeric substances (EPS), and a few glass substrates contained a low cover of tube worms (spirorbid and Hydroides sp.).

There are a wide variety of larval and/or other settlement cues ranging from physical to biochemical. These cues indicate the presence of favorable or unfavorable habitat to settling larvae. Physical cues can include light and color, current direction and speed, oxygen, orientation, texture, sound and surface energy/wettability settlement. Other cues indicating the presence of predators or superior competitors may inhibit settlement. Incumbent fouling may enhance or inhibit settlement, and the effect may change depending on the incumbent and settling species. For purposes of the present disclosure, local settlement cues can mean current conditions and historical markers in a local aquatic environment that provide information to larvae of aquatic organisms that either encourage or discourage settlement (including the absence of encouragement) in the local aquatic environment. In an aspect of the invention, the enclosure defines, in conjunction with the substrate and/or the differentiated aquatic environment, a local aquatic environment that produces and/or promotes the creation of local settlement cues that don't encourage and/or actively discourage the settlement of aquatic organisms on the substrate and/or on/within the enclosure. In various embodiments of the present invention, there is provided a novel enclosure or other device(s) which induces, promotes, enables and/or encourages the formation of at least one exogenous local settlement cue.

It is anticipated that, once a biofilm or other layer with or without local settlement cues is present or established, these cues may remain with/on the substrate (e.g., the surface being sufficiently protected by the enclosure) for a period of time after the enclosure is no longer engaged with or is removed from the substrate. For example, once local settlement cues become associated with or present on the substrate, the enclosure may be removed and/or damaged and at least a portion of the local settlement cues should persist on the substrate to provide ongoing signaling to discourage and/or not encourage settlement of macrofouling organisms. As an example, this prophylactic effect of the local settlement cues may remain on the hull of a boat after the enclosure has been removed (and/or damaged) and may continue to discourage settlement. This discouragement of settlement may extend for periods of time up to about two (2) years, at least 1.5 years, at least 1 year, at least 9 months, at least 6 months, at least 3 months, at least 1 month, at least 1 week, at least 3 days, at least 1 day and/or at least 12 hours. Moreover, the biofilm or other layer(s) created thereupon may be resistant to removal, and thus may provide continued protection to moveable and/or mobile submerged and/or partially submerged surfaces and/or items, including items used to generate propulsion such as propeller vanes and/or shafts. Thus, the enclosure and the inventive processes described herein can allow for an “inoculation” of a substrate against biofouling, which inoculation may continue for a time due to the sustained effect of the local settlement cues (LSCS).

In various embodiments, it is proposed that the changes in water chemistry, including all parameters measured, may have been due, at least in part, to the accumulation of biofouling organisms on the outside surface, inside surface or within the fabric of the enclosure structure. In one embodiment, the external biofilm developed on the outside surface of the enclosure structure accumulated and was pronounced by Day 13, with maturing and developing an organized structure by Day 30. At these time points (Day 13 and Day 30), dissolved oxygen and pH fell significantly inside the enclosure structure. It is believed that, in some exemplary embodiments, dissolved oxygen and pH may be tied together, as it is anticipated that microbial respiration within the enclosure structure leads to a decrease of oxygen and a relative increase in carbon dioxide. The increase in carbonic acid in the water results in a more acidic condition, thus lowers the pH in the water.

In some embodiments, biofilm components may be used as cues to appropriate settlement sites. Further, receptors for bacterial cues of invertebrate larvae can be unique to each organism. For many organisms, larval settlement occurs in response to surface biofilms. The difference in the biofilm on the substrate surface and the biofilm on the enclosure surface may cause the organisms to settle on one biofilm and not the other. Preferably, settlement will occur on the biofilm on the enclosure surface, and not on the biofilm on the substrate surface.

In at least one additional embodiment, the biofilm(s) on the surface of the enclosure structure may act as a “biofilter” and/or utilize or consume nutrients (i.e. oxygen, nitrogen, carbon, phosphates, etc.), thus not allowing some or all of the nutrients to pass or migrate into the waters inside of the enclosure structure, which may be confirmed where water chemistry data showing that more respiration or nutrient uptake occurs in the open waters when compared to the enclosed waters within the structure. These two communities, the bacteria biofilm growing within the fabric and the invertebrate macrofouling growing on the external surface of the structure, may be responsible for establishing and maintaining the fixed-film barrier which provides the antifouling protection—at least one mechanism that can prevent biofouling from occurring within the compartment that is enclosed by the structure.

In another embodiment, one or more biofilms may be grown on the surface of the enclosure structure to protect the substrate and extend the life of the enclosure. These protective biofilms may be located on the exterior surface of the enclosure, on the inner surface of the enclosure or may be penetrative or within the wall(s) of the enclosure. In some embodiments, the 3-dimensional, multifilament textile enclosure structure may provide significantly more effective contact surface area than a flat surface, therefore, the biofilm resident thereon may be significantly more active and/or may be optimized to provide higher protection.

Tables 8A and 8B depict experimental permeability results for various fabrics and coated fabrics for pre-immersion conditions and after immersion for 23 days in an aqueous environment (i.e., seawater). From Table 9B, it can be seen that the permeability of the Burlap test sample was significantly lower than that of Spun Polyester. However, both Burlap and Spun Polyester performed somewhat similarly as anti-foulant fabrics, at least in part by exclusion of larger larval macro organisms from the environment of the substrate. In various instances, fabric permeability may decrease as function of time related to surface fouling and/or other fabric degradation. One significant result of this test is that spun polyester may be a more preferred material over Burlap (which may be less preferred, but still acceptable for various applications), due to degradation and/or other properties of Burlap, as well as production difficulties that may present with various natural fibers such as delousing, cleaning, sterilization and/or contamination of production equipment (i.e., natural fibers may require more extensive and frequent equipment cleaning during processing than synthetic materials).

TABLE 8A
Sample Pre-Immersion Permeabilities of Coated/Uncoated Fabrics

| | | Average Permeability |
|---|---|---|
| Name | Description | (ml/s/cm2) |
| 80 | 80 × 80 Burlap uncoated | 8.16 |
| SB80 | 80 × 80 Burlap coated | 2.77 |
| WB80 | 80 × 80 Burlap coated | 0.48 |
| SPUN | 100% Spun poly uncoated | 10.17 |
| SBSPUN | 100% Spun poly coated | 0.32 |
| WBSPUN | 100% Spun poly coated | 1.08 |

TABLE 8B
Permeabilities of Coated/Uncoated Fabrics 23 Days
Post Immersion (Sea Water)

| Name | Description | Average Permeability (ml/s/cm²) |
|---|---|---|
| SPUN | Uncoated Spun Polyester | 10.16 |
| SPUN SB | Spun Polyester | 0.32 |
| SPUN WB | Spun Polyester | 1.07 |
| 80 | Uncoated 80 × 80 Burlap | 8.16 |
| 80SB | 80 × 80 Burlap | 2.76 |
| 80WB | 80 × 80 Burlap | 0.47 |

In various alternative embodiments, the enclosure walls may incorporate a supplemental biocide or other chemical(s) or compound(s) that can inhibit and/or prevent fouling on the surface and/or within the pores of the enclosure. In various embodiments, the biocide or other chemical(s)/compound(s) can be applied and/or incorporated such that the primary biocidal activity is limited to the surface of enclosure fabric and/or within the pores, with extremely low and/or nonexistent levels of biocide elution into and/or outside of the enclosure. In such a case, the biocide will desirably protect the enclosure from fouling, while the enclosure in turn protects the substrate from fouling.

A variety of test enclosure designs were highly effective in providing biofouling protection to substrates under a variety of daily and/or seasonal water conditions. For various tests, different size and/or shaped structures or enclosure embodiments were tested to determine whether the presence of the enclosure reduces, decreases, eliminates, inhibits and/or prevents macrofouling settlement, including performing a visual comparison of the biofilms formed in the enclosures as compared to the open water, and comparing water quality and water chemistry in the enclosures to the open water. Table 9A depicts the results of salt water tests in tabular form, and shows that Ammonium, Nitrate+Nitrite (N+N), Total Dissolved Nitrogen (TDN), Dissolved Organic Nitrogen (DON), Phosphate and Silica all differed significantly between the enclosures and open samples at different points during sampling, with Table 9B depicting additional chemistry measures such as temperature, salinity, dissolved oxygen and pH. The testing results showed that ammonium was significantly higher inside the enclosures on Days 14 (Jun. 22, 2018) and 30 (Jul. 9, 2018), and N+N was significantly higher inside the enclosures on Days 1 (Jun. 9, 2018), 3 (Jun. 11, 2019) and Month 10 (Apr. 15, 2019) and 12 (Jun. 24, 2019). TDN and DON were significantly higher in open samples on Day 7 but switched and were higher in the enclosures on Days 14 and 30. Phosphate was significantly higher in enclosures on Days 3, 7, 14 and 30 and Months 10 and 12. Silica was significantly higher in open samples on Days 1, 3 and 14 but higher in enclosures on Day 30.

TABLE 9A
Water chemistry results for saltwater within enclosures (“bag”) and open water

| | | | | | | | | |
|---|---|---|---|---|---|---|---|---|
| DATE | Jun. 8, 2018 | Jun. 9, 2018 | Jun. 11, 2018 | Jun. 15, 2018 | Jun. 22, 2018 | Jul. 9, 2018 | Apr. 15, 2019 | Jun. 24, 2019 |

Ammonium (μM)

| | | | | | | | | |
|---|---|---|---|---|---|---|---|---|
| Bag | 0.51 | 0.49 | 0.89 | 0.21 | 15.73 | 13.45 | 0.07 | 0.81 |
| | (±0.14) | (±0.23) | (±0.27) | (±0.11) | (±3.16) | (±0.96) | (±0.07) | (±0.14) |
| Open | 0.17 (±0.07) | 0.1 (±0.0) | 0.35 (±0.16) | 0.1 (±0.0) | 6.54 (±0.17) | 3.76 (±0.17) | 0.13 (±0.13) | 6.93 (±0.25) |

Nitrate + Nitrate (μM)

| | | | | | | | | |
|---|---|---|---|---|---|---|---|---|
| Bag | 1.85 | 2.8 | 4.73 | 1.47 | 1.13 | 0.59 | 12.29 | 15.92 |
| | (±0.83) | (±0.92) | (±2.97) | (±0.54) | (±0.17) | (±0.15) | (±1.93) | (±0.46) |
| Open | 0.62 (±0.12) | 0.42 (±0.03) | 0.73 (±0.14) | 0.78 (±0.24) | 1.35 (±0.3) | 1.05 (±0.32) | 1.43 (±0.73) | 1.02 (±0.10) |

Total Dissolved Nitrogen (μM)

| | | | | | | | | |
|---|---|---|---|---|---|---|---|---|
| Bag | 43.15 | 28.88 | 26.45 | 28.25 | 39.86 | 41.78 | 32.32 | 39.02 |
| | (±2.15) | (±2.43) | (±4.92) | (±1.18) | (±5.0) | (±0.44) | (±2.99) | (±1.67) |
| Open | 36.9 (±4.42) | 29.33 (±1.62) | 23.23 (±1.72) | 32.28 (±1.1) | 25.14 (±0.56) | 20.13 (±1.82) | 18.45 (±1.6) | 30.16 (±0.71) |

Dissolved Organic Nitrogen (μM)

| | | | | | | | | |
|---|---|---|---|---|---|---|---|---|
| Bag | 40.79 | 25.58 | 20.84 | 26.57 | 23.01 | 27.73 | 19.95 | 22.28 |
| | (±1.65) | (±1.5) | (±2.28) | (±0.88) | (±2.08) | (±0.84) | (±1.05) | (±1.42) |
| Open | 36.11 (±4.35) | 28.81 (±1.63) | 22.15 (±1.76) | 31.4 (±0.87) | 17.26 (±0.53) | 15.32 (±1.94) | 16.89 (±1.09) | 22.21 (±0.88) |

Phospate (μM)

| | | | | | | | | |
|---|---|---|---|---|---|---|---|---|
| Bag | 0.44 | 0.29 | 0.19 | 0.2 | 0.73 | 0.49 | 1 | 0.67 |
| | (±0.01) | (±0.01) | (±0.01) | (±0.01) | (±0.08) | (±0.01) | (±0.1) | (±0.03) |
| Open | 0.38 (±0.02) | 0.27 (±0.02) | 0.15 (±0.01) | 0.16 (±0.01) | 0.44 (±0.01) | 0.35 (±0.01) | 0.4 (±0.02) | 0.29 (±0.02) |

Silica (μM)

| | | | | | | | | |
|---|---|---|---|---|---|---|---|---|
| Bag | 61.18 | 43.33 | 28.88 | 43.98 | 37.53 | 40.56 | 27.39 | 29.04 |
| | (±1.41) | (±1.18) | (±1.25) | (±2.04) | (±0.86) | (±0.72) | (±1.15) | (±1.15) |
| Open | 71.2 (±6.72) | 54.43 (±3.23) | 34.23 (±0.52) | 55.65 (±4.72) | 43.73 (±1.29) | 24.71 (±0.32) | 21.4 (±2.74) | 29.13 (±1.06) |

Alkalinity (meq/L)

| | | | | | | | | |
|---|---|---|---|---|---|---|---|---|
| Bag | 2.6 | 2.65 | 2.58 | 2.63 | 2.58 | 2.59 | 2.26 | 2.27 |
| | (±0) | (±0.05) | (±0.05) | (±0.03) | (±0.03) | (±0.03) | (±0.08) | (±0.07) |
| Open | 2.68 (±0.05) | 2.65 (±0.03) | 2.58 (±0.03) | 2.6 (±0) | 2.56 (±0.02) | 2.52 (±0.03) | 2.16 (±0.06) | 2.28 (±0.05) |

Alkalinity (mg/L)

| | | | | | | | | |
|---|---|---|---|---|---|---|---|---|
| Bag | 130.75 | 132.5 | 127.75 | 130.5 | 128.91 | 129.72 | 112.72 | 113.69 |
| | (±0.95) | (±2.25) | (±1.93) | (±1.04) | (±1.58) | (±1.68) | (±4.2) | (±3.60) |
| Open | 135 (±2.12) | 133.5 (±1.32) | 129.5 (±1.32) | 129.25 (±0.75) | 128.22 (±0.82) | 126.05 (±1.6) | 108 (±2.84) | 114.31 (±2.70) |

TABLE 9B
Additional water chemistry for saltwater in enclosures (“bag”) and open water

| | | | | | | |
|---|---|---|---|---|---|---|
| DATE | Jun. 8, 2018 | Jun. 9, 2018 | Jun. 11, 2018 | Jun. 15, 2018 | Jun. 22, 2018 | Jul. 9, 2018 |

Temperature (° C.)

| | | | | | | |
|---|---|---|---|---|---|---|
| Bag | 27.6 (±0) | 27.3 (±0) | 26.9 (±0.07) | 28.28 (±0.05) | 28 (±0.04) | 26.28 (±0.03) |
| Open | 27.55 (±0.05) | 27.55 (±0.05) | 27.13 (±0.03) | 28.38 (±0.08) | 28.18 (±0.05) | 26.35 (±0.03) |

Salinity (psu)

| | | | | | | |
|---|---|---|---|---|---|---|
| Bag | 31.28 (±0.03) | 31.13 (±0.02) | 32.58 (±0.05) | 31.55 (±0.05) | 32.83 (±0.05) | 31.55 (±0.05) |
| Open | 31.35 (±0.19) | 32.4 (±0.25) | 33.65 (±0.49) | 33.08 (±0.41) | 33.15 (±0.44) | 33.83 (±0.34) |

Dissolved Oxygen (mg/L)

| | | | | | | |
|---|---|---|---|---|---|---|
| Bag | 8.63 (±0.03) | 7.73 (±0.03) | 6.62 (±0.09) | 6.69 (±0.19) | 3.28 (±0.35) | 4.05 (±0.21) |
| Open | 8.59 (±0.03) | 7.94 (±0.06) | 6.75 (±0.04) | 7.22 (±0.03) | 5.19 (±0.06) | 6.42 (±0.07) |

Dissolved Oxygen (%)

| | | | | | | |
|---|---|---|---|---|---|---|
| Bag | 109.2 (±0.33) | 97.48 (±0.4) | 82.95 (±1.2) | 87.48 (±1.22) | 41.8 (±4.54) | 50.28 (±2.57) |
| Open | 108.7 (±0.32) | 100.58(±0.62) | 84.8 (±0.64) | 92.78 (±0.45) | 66.38 (±0.8) | 79.58 (±0.92) |

pH

| | | | | | | |
|---|---|---|---|---|---|---|
| Bag | 8.16 (±0) | 8.26 (±0.006) | 8.17 (±0.006) | 8.19 (±0.009) | 7.99 (±0.021) | 8.07 (±0) |
| Open | 8.17 (±0.002) | 8.26 (±0.005) | 8.18 (±0.002) | 8.21 (±0.003) | 8.14 (±0.003) | 8.16 (±0.002) |

Various conclusions appeared from the data, including: (1) the dissolved inorganic nitrogen (N+N and Ammonium) was higher in the enclosures while dissolved organic nitrogen (amino acids, urea) was higher outside the enclosures through Day 7. This may indicate higher biological activity outside the enclosures, with bacteria, cyanobacteria and phytoplankton using inorganic nitrogen for growth and creating organic nitrogen (through decay and excretion). Biofilm results from this experiment (observationally) and DNA results from the previous test confirmed this hypothesis. The overall dissolved organic nitrogen (DON) inside the enclosures remained similar throughout the latter part of the experiment, while the open DON fluctuated, likely due to natural cycling of Nitrogen in the seaport, which was insulated or buffered by the enclosures, (2) the phosphate level was higher in the enclosures than in the open water, likely due to greater biological activity using the phosphorus outside the enclosures, and/or (3) the silica level was higher outside the enclosures through Day 14, likely due to the greater activity and turnover of diatoms outside the enclosures, which switched on Day 30. The overall silica level in the enclosures was reasonable similar over time, while the open level silica fluctuated. This variability likely indicated cycling in the open water as the silica was used by diatoms—cycling that was insulated or buffered by the enclosure.

In another example, water chemistry and water quality were observed in various enclosure embodiments. The purpose of this salt-water testing was to examine the water chemistry differences between water within the various size enclosures (1, 2 and 4′ diameter) and the open water. Table 9C depicts the results of 12-month salt water test in tabular form, and shows that Ammonium, Nitrate+Nitrite (N+N), Total Dissolved Nitrogen (TDN), Dissolved Organic Nitrogen (DON), Phosphate, Silica, and alkalinity all differed significantly between the enclosures and open samples at different points during sampling, with Table 9D depicting additional chemistry measures such as temperature, salinity, dissolved oxygen and pH.

TABLE 9C
Water chemistry results for saltwater in enclosures (“1′, 2′, 4′”) and open water.

| | Ammonium | N + N | TDN | DON | Phosphate | Silica | Alkalinity | Alkalinity |
|---|---|---|---|---|---|---|---|---|
| Treatment | (μM) | (μM) | (μM) | (μM) | (μM) | (μM) | (Meq/L) | (mgCaCo₃/L) |
| 1′ | 1.44 | 17.33 | 36.93 | 18.16 | 0.77 | 23.03 | 2.73 | 137 |
| | (±0.56) | (±1.33) | (±3.21) | (±2.09) | (±0.14) | (±0.55) | (±0.04) | (±1.79) |
| 2′ | 1.53 | 17.42 | 36.09 | 17.14 | 0.87 | 22.5 | 2.59 | 129 |
| | (±0.48) | (±0.83) | (±1.34) | (±1.1) | (±0.03) | (±0.86) | (±0.04) | (±2.01) |
| 4′ | 1.18 | 15.7 | 34.83 | 17.94 | 0.74 | 23.95 | 2.31 | 116 |
| | (±0.09) | (±0.96) | (±1.34) | (±0.57) | (±0.11) | (±0.66) | (±0.01) | (±0.43) |
| Open | 2.24 | 1.27 | 22.03 | 18.53 | 0.27 | 20.66 | 2.4 | 120 |
| | (±0.76) | (±0.13) | (±2.5) | (±1.69) | (±0.05) | (±0.32) | (±0.01) | (±0.75) |

TABLE 9D
Additional water chemistry for saltwater in enclosures
(“1′, 2′, 4′”) and open water.

| Disk Size | Temperature (C.) | Salinity (psu) | DO mg/L | DO % | pH |
|---|---|---|---|---|---|
| 1′ | 28.87 | 33.03 | 1.44 | 22.2 | 8.06 |
| 2′ | 28.77 | 33.13 | 1.65 | 25.4 | 8.04 |
| 4′ | 28.73 | 33.07 | 1.62 | 24.97 | 8.03 |
| Open | 28.77 | 34.17 | 4.79 | 73.67 | 8.2 |

The testing results showed dissolved oxygen and pH were significantly higher in the open water compared to the waters within the enclosure, for all size enclosures (1, 2 and 4′ diameter). N+N, TDN, Phosphate and silica all differed significantly in waters within the enclosures compared to open waters. Alkalinity, N+N, TDN and phosphate were all significantly higher inside of the enclosure compared to open waters. This data shows a similar trend as other water chemistry tests in saltwater. The increased water chemistry concentrations within the enclosures when compared to the open waters may indicate a greater biological activity outside of the enclosures, with bacteria, cyanobacteria, and phytoplankton using available nutrients for growth.

Furthermore, some of the results of these water chemistry studies suggest various enclosure embodiments may create an effect that respiration or material metabolism is greater or exceeds photosynthesis within the enclosure structure. This effect may happen due to the lowered levels of dissolved oxygen or other water chemistry parameters that is created by the enclosure structure. Differences in dissolved oxygen inside the enclosure may likely be related to light limitation within the enclosure.

The effect of respiration exceeding photosynthesis within the enclosure structure may be confirmed based on the phosphate results. Phosphate concentration in the waters within the enclosure is consistently higher than open waters. Based on the phosphate cycle and knowing that phosphate is exchanging between particles and the dissolved phase, diffusion may be acting to try to restore water chemistry equilibrium on each side of the permeable enclosure. The more of a difference in the water conditions within the enclosure compared to the open water conditions, the more diffusion generally acts to restore equilibrium. Therefore, phosphate should likely continue to increase within the enclosure waters but may be lost due to diffusion.

In one embodiment, the enclosure structure provides antifouling protection within its confines through the initial establishment of a nitrification and de-nitrification rich environment. During this testing, data showed consistently higher ammonium in the water within the enclosure structure. With the initial nitrogen product of respiration being reduced nitrogen or ammonium. After 4 days of immersion, the internal environment becomes less oxygenated resulting in the formation of un-ionized ammonia nitrogen (NH3-N) which is toxic to marine organisms within the confines of the device. In addition to NH3-N production, it is possible that nitrite (NO2) and other toxic reactive nitrogen molecules may also be produced within the medium filled confines of the enclosure structure. This effect appears to be enhanced as the exterior of the enclosure becomes progressively more fouled. Further, the microbial biofilm that forms within and on the surface the enclosure device may contribute to universal nitrification and de-nitrification pathways.

Various testing data confirmed that Nitrate+Nitrite (N+N) in many cases was higher in waters within the enclosure structure when compared to open waters. This result may be related to nitrification of ammonia under oxic conditions. In some embodiments, even though dissolved oxygen is lower in the bag, it may not be low enough to inhibit nitrification, and the source of ammonium may come from respiration. In some embodiments, dissolved oxygen is not likely low enough to promote dissimilatory nitrate reduction to ammonium (DNRA) or nitrate/nitrite ammonification; however, it is possible there are anoxic microenvironments (less than 0.5 mg/L dissolved oxygen concentration in water) within the bag that can promote DNRA. DNRA is the result of microbial anaerobic respiration using nitrate as an electron acceptor, reducing to nitrite, then ammonium.

Additionally, Total Dissolved Nitrogen (TDN) was typically higher in enclosed waters compared to open waters during the saltwater testing. This result is consistent with high microbial respiration and dissolved nitrogen coming off particles as they decompose. In some embodiments, settlement of particles in the low-energy environment of the enclosure result in a settlement source of dissolved nutrients to the enclosed waters. This settlement, dead, dying or decomposed particles at the bottom of the enclosure can account for the water chemistry and water quality differences within the enclosure water and open waters in some embodiments. These decomposing particles or settlement may be consuming the majority of dissolved oxygen within the enclosure structure.

As respiration releases CO₂, this in turn can lower pH to drive or reduce to carbonate. By creating an increase in carbonic acid in the seawater, the water results in a more acidic condition, thus a lower pH measure. Organisms quickly respond to a decrease in dissolved oxygen, specifically when dissolve oxygen starts to reach levels of 3 mg/L or 2 mg/L. This difference in the water may cause organisms to not produce a shell or produce a thinner shell. Furthermore, this difference may cause organisms not to settle or swim and/or move to a different location if the oxygen difference is too great.

Carbonate chemistry also appears to be modified within the enclosure structure device confines, with the entrained water becoming more corrosive to calcium carbonate mineralization over time. To enable a comparison of the open waters and enclosed waters that were sampled during the experiment, a NOAA CO2 Sys program which evaluates changes in carbonate water chemistry can be used to generate a single integrated measure, the saturation index for aragonite, (Omega—Ω) for each water mass sampled at a particular time point. The aragonite (aragonite is a crystallized form of calcium carbonate mineral) saturation index (0) is a dimensionless number which indicates the degree of super saturation of calcium carbonate in seawater. A value greater than 1 denotes super saturation (aragonite will grow in size) and a value less than 1 denotes under saturation (aragonite will dissolve). Chemical oceanographers rely on Omega values to ascertain the magnitude and trend of ocean acidification for a given oceanic water mass. A declining Ω trend is considered to be a corrosive threat for calcium carbonate formation. The determination of Ω is dependent on following parameters; salinity, water temperature, depth (as pressure), phosphate, silica, ammonium, alkalinity and pH. The integration of all these parameters into a single unified measure enabled direct comparison of the water mass samples taken over the duration of the settlement experiment (shown in FIG. 12B).

The Redfield ratio or Redfield stoichiometry was analyzed to understand the atomic ratio of carbon, nitrogen and phosphate found in the marine phytoplankton within the waters inside the enclosure structure and in open waters. With this theory, the ratio of Carbon:Nitrogen:Phosphate=106:16:1, nutrient limitations were studied in saltwater. Based on increased concentration levels of ammonium (i.e. nitrogen) and phosphate within the waters inside the enclosure, it was determined that in some embodiments there may not be any nutrient limitations within the waters of the enclosure compared to open waters.

In one embodiment, the enclosure may serve as a substratum for bacterial colonization and macrofouling settlement. Free exchange of dissolved oxygen, ammonia, nitrite and nitrate may occur across the permeable enclosure. In one embodiment, the respiration of macrofoulers and/or bacterial biofilm may account for much of the oxygen and/or chemical nutrient uptake across the permeable enclosure. An oxygen, nitrogen, phosphate and other nutrient consumption may occur by the biofilm as the water passes or exchanges into the permeable enclosure. Bacterial biofilm may begin to participate in the oxygen uptake rate (OUR) of the enclosure until the enclosure waters reach steady state with respect to the biofilm OUR. In one example, steady state of nutrients in the water inside the enclosure with respect to the biofilm may occur within less than 12 months, less than 6 months, less than 3 months, between 1 and 60 days, between 1 and 30 days, or at day 58. The bacterial biofilm growing within or on the surface of the enclosure and the invertebrate macrofoulers growing on the external surface of the enclosure may be responsible for establishing and maintaining the fixed film barrier in many embodiments, which can provide significant antifouling protection. In some embodiment the film barrier can be a mechanism that prevents biofouling from occurring within the water compartment that enclosed by the fabric structure.

In general, un-ionized ammonia as NH3-N is highly toxic at levels approaching 100 μg/L (ppb) to both aquatic and marine species. NH3-N concentrations observed after day 7 from within the device were approaching 20% of the toxic level and may have been higher. Another potential contributor of toxicity from within the device is nitrite (NO2), which is considered toxic at the 1 ppm level. During the saltwater experiment, dissolved oxygen in the device did not drop to hypoxic levels (hypoxia occurs at less than 2 mg/L dissolved O2) however it was trending downward. Since this water chemistry mechanism of action is not dependent on any particular microbial biofilm, it is also relevant for freshwater applications.

In another example, water chemistry and water quality freshwater samples were collected and analyzed from experiments at University of Wisconsin at Milwaukee (UWM). Enclosure structures were deployed to protect a valve and boat from fouling in the Great Lakes. After 1-month of immersion, water samples were collected within the enclosure and open waters. These results are presented in Table 9E-9G. As shown in Table 9E, Ammonium, Nitrite, N+N, TDN, DON, Phosphate and Silica differed significantly in freshwater, where most of the chemistry differed significantly between the two separate locations in the Great Lakes. The freshwater at the marina (M) demonstrated a significantly higher ammonium, TDN and Phosphate concentrations within the waters inside of the enclosure structure compared to open waters. Nitrite, N+N, Phosphate and Silica concentrations were all significantly higher within the water inside the enclosure compared to open waters at UWM's sea wall. These results may be an indication of greater biological activity outside the enclosure structures, with bacteria, cyanobacteria and phytoplankton using available nutrients for growth.

TABLE 9E
Water chemistry results for freshwater within enclosures and open water.

| | Ammo- | | | | | Phos- | | | Alkalinity |
|---|---|---|---|---|---|---|---|---|---|
| Treat- | nium | | N + N | TDN | DON | phate | Silica | Alkalinity | (mgCaCo₃/ |
| ment | (μM) | Nitrite | (μM) | (μM) | (μM) | (μM) | (μM) | (Meq/L) | L) |
| Valve | 6.31 | 0.27 | 27.95 | 49.04 | 14.77 | 0.34 | 37.54 | 2.21 | 110 |
| M | (±1.38) | (±0.04) | (±0.22) | (±0.72) | (±1.4) | (±0.04) | (±0.86) | (±0.04) | (±2.15) |
| Boat M | 3.21 | 0.21 | 27.29 | 41.84 | 11.34 | 0.3 | 35.66 | 2.25 | 112 |
| Open | 1.75 | 0.2 | 26.68 | 40.25 | 11.83 | 0.22 | 35.29 | 2.25 | 113 |
| M | (±0.16) | (±0) | (±0.12) | (±0.89) | (±0.69) | (±0.01) | (±0.08) | (±0.03) | (±1.54) |
| Boat | 5.86 | 1.11 | 48.58 | 76.76 | 22.32 | 1.21 | 101 | 3.79 | 190 |
| UWM | (±0.15) | (±0.03) | (±1.39) | (±0.93) | (±1.91) | (±0.01) | (±0.25) | (±0.02) | (±0.95) |
| Open | 6.31 | 0.74 | 46.01 | 78.72 | 26.39 | 1.17 | 97.71 | 3.67 | 184 |
| UWM | (±0.52) | (±0.01) | (±0.37) | (±1.94) | (±1.7) | (±0.01) | (±0.03) | (±0.05) | (±2.44) |

TABLE 9F
Additional water chemistry for freshwater
within enclosures and open water.

| | | Temperature | Conductivity | DO | DO | |
|---|---|---|---|---|---|---|
| Treatment | Replicates | (C.) | (μS/cm) | (mg/L) | (%) | pH |
| Valve M | 3 | 16.2 | 364.6 | 7.01 | 71.4 | 7.97 |
| Boat M | 1 | 16.0 | 361.4 | 7.53 | 79.6 | 8.01 |
| Open M | 1 | 16.7 | 362.9 | 9.19 | 94.6 | 8.01 |
| Boat UWM | 2 | 17.15 | 442.55 | 7.18 | 74.65 | 7.84 |
| Open UWM | 1 | 16.9 | 418.4 | 6.97 | 72.1 | 7.76 |

TABLE 9G
Additional water chemistry for freshwater within
enclosures and open water

| | West (1) | Middle (2) | East (3) | |
|---|---|---|---|---|
| | Valve Bag | Valve Bag | Valve Bag | Ambient |
| Depth m | 0.5 | 0.5 | 0.5 | 1 |
| Temperature C ° | 14.6 | 14.4 | 14.5 | 14.4 |
| Conductivity μS/cm | 321.3 | 319.7 | 318.9 | 319.5 |
| Specific Conductivity μS/cm | 400.9 | 400.8 | 399 | 400.7 |
| ODO % Sat | 53.1 | 45.4 | 58.5 | 68.2 |
| ODO mg/L | 5.39 | 4.64 | 5.96 | 6.97 |
| pH | 7.38 | 7.39 | 7.50 | 7.6 |
| Turbidity FNU | 32.27 | 27.86 | 44.02 | 2.84 |
| Chlorophyll RFU | 1.18 | 1.06 | 3.72 | 0.67 |
| Chlorophyll μg/L | 4.8 | 4.31 | 15.04 | 2.77 |
| BGA-PC RFU | 0.34 | 0.061 | 1.04 | 0.13 |

Table 9F shows 1-month freshwater temperature, conductivity, dissolved oxygen and pH results for the two locations in the Great Lakes: marina (M) and UWM's sea wall (UWM). The dissolved oxygen concentration within the water inside of the enclosure structure is different than the dissolved oxygen in open freshwater at each location. In another freshwater experiment, water chemistry samples were analyzed for entrained waters inside of an enclosure protecting a metal valve and open waters at a similar location of the Great Lakes after 2-months. The testing results of freshwater temperature, conductivity, dissolved oxygen (OD), pH, turbidity and chlorophyll are presented in Table 9G. Dissolved oxygen, pH and chlorophyll show to have a significant difference between waters within the enclosure and open waters. Dissolved oxygen and pH are lower in the local aquatic environment (waters within the enclosure) compared to open waters. Chlorophyll readings are significantly higher in the local aquatic environment compared to open waters. The dissolved oxygen, pH and chlorophyll differences may be accounted for based on the understanding that respiration of bacteria in the oxic environment is greater or more prominent than photosynthesis or nutrient uptake for algae. Similar conclusions are made for freshwater testing as the saltwater testing.

In another exemplary embodiment, shown in Tables 10A and 10B below, water chemistry results were obtained for various enclosures incorporating spun polyester fabric coated with 154 (3500 cP, original formula) or 153 (3500 cP, no acrylic formula) water-based biocidal coatings using a commercial printing process with a 30 or 40 screen (with or without vacuum) and open water samples. Overall, a total of 8 treatments: 154-30 v, 154-30 nv, 154-40 v, 154-40 nv, 153-30 v, 153-30 nv, 153-40 v & 153-40 nv and open water samples (control) were tested. The permeability for each fabric type was collected using disclosed methods, and the following sample key provided:

TABLE 10A
Sample Key

| | |
|---|---|
| 153 or 154 | sample formulation |
| 30 or 40 | screen identifier |
| v or nv | vacuum or no vacuum |

Example: 154-30v is formula 154, applied with the 30
screen using a vacuum

TABLE 10B
Water Chemistry and Permeability

| | Pre- | Perme- | | | | Dis- | | |
|---|---|---|---|---|---|---|---|---|
| | immersion | ability | | | Total | solved | | |
| | Permeability | (30 days, | Ammo- | Nitrate + | Dissolved | Organic | Phos- | |
| Sample | (mL/cm²/s) | multiwell) | nium | Nitrate | Nitrogen | Nitrogen | phate | Silica |
| 154-30nv | 0.9 (±0.32) | 0.92 (±0.28) | 7.61 | 19.4 | 65.7 | 38.69 | 0.93 | 55.2 |
| 153-40nv | 1.11 (±0.18) | 1.3 (±0.15) | 2.89 | 4.78 | 23.3 | 15.63 | 0.81 | 33 |
| 153-30nv | 2.36 (±0.41) | 2.95 (±0.28) | 4.13 | 7.73 | 32.5 | 20.64 | 1.21 | 69.7 |
| 153-40v | 9.43 (±0.49) | 8.54 (±0.77) | 3.17 | 1.03 | 17.8 | 13.6 | 0.98 | 87.1 |
| 154-40v | 11.27(±0.45) | 7.99 (±0.58) | 3.21 | 1.1 | 17 | 12.69 | 0.89 | 81 |
| Open | n/a | n/a | 2.25 | 1.24 | 19.9 | 16.41 | 0.73 | 76.5 |
| Column | | | | | | | | |

Water samples were collected from lower permeable enclosures, 154-30 nv, 153-40 nv and 153-30 nv, higher permeable enclosures, 153-40 v and 154-40 v, and open water (control) using a water chemistry core sampler. Testing results demonstrated an observable difference in nutrient levels between the water samples collected from within the enclosures and open water samples. The less permeable enclosures show a greater difference in nutrient content compared to the open water samples. In general, the water nutrient content levels were higher inside of the enclosure compared to open waters. Additionally, the pH of the water within the enclosure compared to pH of open waters was observed. Depending upon enclosure design, substrate composition and/or other objectives, as well as various environmental and/or water conditions, the pH within the enclosure could be higher than that of the open environment, or the water contained within the novel enclosure could reflect a lower pH or a more acidic pH than the open water, which can constitute a key water chemistry “difference” of the differentiated environment that contributes to the biofouling effectiveness of some enclosure designs.

Water Exchange Rate

In various embodiments, an optimal, desired and/or average “water exchange rate” may be determined for protecting a given substrate in a given aqueous environment using a given enclosure design, which may include a range or ranges of desired water exchange rate(s) that may vary due to a wide range of water and/or other environmental conditions. For example, the desired water exchange rate may be optimized to protect a certain type and/or shape of substrate material, may be designed and/or particularized for a specific size, shape and/or volume of enclosure and/or enclosure wall material, may be designed and/or particularized fora specific region or depth of water, may be dependent upon seasonal variation and/or temperature and/or tidal activities, and/or may vary due to water salinity, dissolved oxygen, nutrients, wastes, water velocity, specific applications and/or a host of other considerations. In various embodiments, the water exchange rate will desirably be sufficient to generate a desired gradient in conditions between the external open environment and the internal environment within the enclosure (i.e., dissolved oxygen, wastes, available nutrients, etc.) to protect the underlying substrate surface from an undesirable level of biofouling without creating conditions that could unacceptably damage the substrate—for example, avoiding the detrimental effects of anoxic conditions (i.e., approximately 0.5 mg/L or lower dissolved oxygen levels in some embodiments) over an extended period of time that may lead to unacceptable levels of substrate corrosion.

In various embodiments, it will be highly desirable to allow a metered inflow of “open” environmental water to induce the desirable water chemistry changes within the enclosure (which can include a desired concentration of metabolic wastes and/or detrimental, inhibitory and/or toxic byproducts within the enclosure), and a metered outflow of enclosure water such that the various detrimental compounds—including various known and/or unknown microbial “toxins” and/or inhibitory compounds—and/or other water chemistry factors may elute through the enclosure walls and protect the external surfaces and/or pores of the enclosure from excessive fouling (which in some embodiments and waterflow conditions may create a “cloud” of such compounds which substantially surrounds some or all of the enclosure's outer walls). In these embodiments, the presence of the enclosure may provide biofouling protection to both the substrate and the enclosure walls to differing degrees, even in the absence of a supplemental biocide or other fouling protective toxin supplementally provided to the enclosure. For example, when various enclosure embodiments are placed around a substrate and creates the disclosed differentiated environment, this differentiated environment may also develop an increased concentrations of a variety of metabolic wastes, and the various processes and/or metabolic activities occurring within the enclosure may generate one or more substances (such as hydrogen sulfide or NH₃—N, for example) having a detrimental and/or negative effect on fouling organisms. These detrimental compounds can then increase in concentration and reside in and/or elute through the walls of the enclosure, potentially creating a localized “cloud” of detrimental compounds that protects the outer walls of the enclosure from fouling organism to some degree. However, once the detrimental compounds leave the enclosure, these detrimental compounds quickly become diluted and/or broken down by various natural processes—many of which utilize the abundant dissolved oxygen outside of the enclosure—thus obviating any concern about the longer-term effects of these substances. In addition, because the processes creating these detrimental compounds within the enclosure are continuous and/or periodic, the enclosure can potentially generate a renewed supply of these compounds at a relatively constant level on an indefinite basis.

In various embodiments, a desired water exchange rate of at least 0.5% (inclusive) of the total water volume within the enclosure per minute that is exchanged between a protective enclosure and the surrounding aqueous environment can provide a wide variety of the anti-fouling and/or anti-corrosive effects for a protected substrate as described herein, although exchange rates of less than, equal to and/or greater than 0.5% per minute can desirably provide various anti-fouling and/or anti-corrosive benefits such as described herein. This exchange rate can optionally be determined as an average rate over a specific period of time, such as per minute, per hour, per day and/or per week, as well as during periods of water movement and/or non-movement such as slack water and/or during a tidal ebb or flow). In other embodiments, a desired water exchange rate of up to 5% of the total water volume within the enclosure per minute that is exchanged between a protective enclosure and the surrounding aqueous environment can provide a wide variety of the anti-fouling and/or anti-corrosive effects for a protected substrate as described herein, although exchange rates of less than, equal to and/or greater than 5% per minute can desirably provide various anti-fouling and/or anti-corrosive benefits such as described herein.

In one exemplary embodiment, an enclosure allowing a water exchange rate of approximately 0.417% of the enclosed or bounded water volume per minute (i.e., approximately 25% of the total enclosed or bounded volume per hour) has been shown to provide superior biofouling resistance to a substrate. The enclosed or bounded water volume within an exemplary enclosure can be calculated as the total enclosed or bounded volume of the enclosure minus the volume of the substrate within the enclosure. In other embodiments, the water exchange rate can be approximately 25% of the total enclosed or bounded volume of the enclosure per hour, without accounting for the volume of the substrate within the enclosure.

In various embodiments, a water exchange rate of less than 0.1% per minute may provide a desired level of antifouling and/or anti-corrosive effects, while in other embodiments a desired water exchange rate of at or between 0.1% to 1% of the total water volume per minute may be effective. In other embodiments, a water exchange rate of 1% to 5% of the total water volume may provide a desired level of antifouling and/or anti-corrosive effects, while in other embodiments a desired water exchange rate of 5% to 10% of the total water volume per minute may be effective In other embodiments, the desired exchange rate could range from 1% to 99% of the total water volume per minute, from 5% to 95% of the total water volume per minute, from 10% to 90% of the total water volume per minute, from 15% to 85% of the total water volume per minute, from 25% to 75% of the total water volume per minute, from 30% to 70% of the total water volume per minute, from 40% to 60% of the total water volume per minute, or approximately 50% of the total water volume per minute. In other embodiments, the water exchange rate can vary from 10% to 50% or from 10% to 15%, from 15% to 25%, and/or from 25% to 50% per minute, or various combinations thereof (i.e., 1% to 10% per minute or 5% to 25% per minute, etc.).

It should also be understood that, where local water conditions provide higher velocities of water flow on and/or away from the enclosure and/or where the enclosure may be subject to movement (i.e., by being attached to a moving and/or moveable object, for example), a lower permeability of the enclosure material may be more desirous in that the higher velocity water contacting and/or impacting upon the enclosure wall(s) may cause a sufficiently larger quantity of liquid to permeate through the fibrous matrix and/or permeable fabric than would normally occur in relatively quiescent waters, thereby causing the desired rate of water exchange to provide biofouling protection as described herein. In a similar manner, where local water conditions provide lower velocities of water flow on and/or away from the enclosure, a higher permeability of the enclosure material may be more desirous in that the lower velocity water contacting and/or impacting upon the enclosure wall(s) may cause a sufficiently lesser quantity of liquid to permeate through the fibrous matrix and/or permeable fabric than would normally occur in more active waters, thereby causing the desired rate of water exchange to provide biofouling protection as described herein.

TABLE 11
Exemplary Surface Area to Volume Ratios

| | | | | | | Enclosure Surface Area: Volume Ratio (feet²) | | | |
|---|---|---|---|---|---|---|---|---|---|
| | Enclosure | | | Surface | | Volume | Volume | Volume | Volume |
| Protected | Length | Width | Depth | Area | Volume | with no | with 50% | with 95% | with 99% |
| Substrate | (feet) | (feet) | (feet) | (feet²) | (feet³) | Substrate | Substrate | Substrate | Substrate |
| Underwater | | | | 3.1 | 0.4 | 8.0 | 16.0 | 160.0 | 800.0 |
| sensor | | | | | | | | | |
| Boat Stern | 4.0 | 3.0 | 3.0 | 54.0 | 36.0 | 1.5 | 3.0 | 30.0 | 150.0 |
| 18″ Pump | 1.5 | 1.5 | 1.5 | 11.3 | 3.4 | 3.3 | 6.7 | 66.7 | 333.3 |
| 50′ Boat | 50.0 | 12.0 | 5.0 | 1220.0 | 3000.0 | 0.4 | 0.8 | 8.1 | 40.7 |

In various embodiments, it may be desirous to employ an enclosure design which contains sufficient amounts and/or volumes of the “aqueous medium” to allow the described differentiation of the enclosed environment to occur, and which also contains a sufficient “reservoir” of fluid to allow the “build up” of sufficient concentrations of toxic and/or detrimental chemicals and/or compounds to maintain a desired concentration of such chemicals/compounds during periods of desired water exchange. In some instances, the enclosed volume of the aqueous medium (i.e., water) within the enclosure may be a multiple of the volume of the enclosed substrate, especially for relatively smaller substrates such as sensors and/or water intakes, while in some other embodiments the enclosed volume of the aqueous medium within the enclosure may be a fraction of and/or equal to the volume of the enclosed substrate (i.e., for ship hulls and/or other large structures in some cases). In various embodiments, a surface to volume ratio may be utilized to describe various enclosure designs, which can include three exemplary enclosure embodiments having surface to volume ratio ranging from 0.4 to 800 inverse feet, such as a pumping cube enclosure design having a 0.4 inverse foot or less surface to volume ratio, a boat hull enclosure design (for a 50 foot or longer vessel) having an 800 inverse foot or greater surface to volume ratio, and a stern mimic enclosure design having a 350 inverse foot (or lesser or greater) surface to volume ratio, as shown in Table 11.

In other embodiments, an enclosure may be designed having a specific surface area ratio and/or ratio range as compared to a surface area of the enclosed substrate, which can greatly vary depending upon the enclosure design and/or the surface texture and/or fully or partially submerged and/or other features of the substrate. For example, a given enclosure design and/or size may be utilized to protect a generally smooth surface of a substrate and a more complex substrate surface (i.e., a valve and/or propeller), with the surface area ratio being approximately 1:1 or 1.1:1 for the enclosure/smooth substrate or approximately 1:2 or greater for the enclosure/complex substrate. In a similar manner, a complex enclosure design may have a ratio of 1.1:1 or greater to a less complex substrate. In various embodiments, the enclosure will have a surface area ratio ranging from 1:1.1 to 1.1:1 for a given protected substrate, and this range can expand to 1:2 to 2:1 or greater in both directions for varying degrees of substrate and/or enclosure complexity. In general, the enclosure design is expected to be at least slightly larger than the substrate (to enclosure some volume of water) and the enclosure surface features are expected to be somewhat less complex than the substrate surface features, so in many embodiments the surface area ratio of the enclosure to the substrate will approximate 1:1 or 2:1 or 3:1 or 10:1 or 50:1 or 100:1 or higher. In other embodiments, the surface area of the enclosure design is expected to be less than the surface area of the substrate. This could occur when the substrate is only partially submerged, whether the substrate is submerged 1%, 5%, 10%, 20%, 25%, 50%, 60%, 75%, 80%, 95%, 99% or less. In some embodiments the surface area ratio of the enclosure to the substrate will approximate 1:1 or 1:2 or 1:3 or 1:10 or 1:50 or 1:100 or lower.

Conditioning of Aqueous Environment and Modification Compounds

In some embodiments, it may be desirous to provide supplemental modification of the aqueous environment proximate to the substrate/object to be protected, including such modification prior to, during and/or after the enclosure has been placed about the object as previously described. In some embodiments, such modification may include the use of natural and/or artificial mechanisms and/or compounds to alter various components of the water chemistry, such as by causing an accelerated depletion and/or replacement of the dissolved oxygen or other change in water chemistry in the aqueous environment within the enclosure by the introduction of one or more aerobic microbes, chemicals and/or compounds (including oxygen depleting compounds) into the aqueous environment proximate to the substrate. For example, in one embodiment an object to be protected from biofouling could comprise the underwater hull portion of a boat, wherein an enclosure such as described herein is placed around the hull, and then a supplemental oxygen depleting compound or substance comprising one or more species of aerobic bacteria, such as aerobic bacteroides, can be artificially introduced into the aqueous environment of the enclosed or bounded space in large numbers and/or quantities, desirably accelerating the reduction in dissolved oxygen levels induced by the enclosure. Such introduction could be by way of liquid, powdered, solid and/or aerosolized supplement thrown or deployed into the seawater and/or enclosed/bounded aqueous environment, or alternatively the oxygen depleting bacteria or other constituents could be incorporated into a layer or biofilm formed in or on an inner surface of the enclosure walls prior to deployment. Desirably, the aerobic bacteroides could comprise a bacterial species already present in the aqueous environments, wherein eventual release of such bacteria through the bottom and/or walls/openings in the sides of the enclosure would not be detrimental and/or consequential to the surrounding environment. In other embodiments, a chemical compound may be introduced into the aqueous environment within the enclosure to desirably absorb dissolved oxygen from the water within the enclosure, such as powdered iron (i.e., zero-valent iron FeO or partially oxidized ferrous iron Fe2+), nitrogen gas or liquid nitrogen, or additives such as salt may be added to the aqueous environment to reduce the amount of dissolved oxygen the water can hold for a limited period of time.

In various embodiments, the modification compound could comprise a solid, a powder, a liquid, a gas or gaseous compound and/or an aerosol compound which is introduced into the enclosed or bounded aqueous environment with the enclosure and/or separately (including prior to, concurrent with and/or after enclosing the substrate). In some embodiments, the modification compound may be positioned within the enclosed or bounded aqueous environment for a limited or desired period of time, and then removed from the environment after the desired modification and/or conditioning of the water has occurred (i.e., creation of the “differentiated” aqueous environment). In other embodiments, the modification compound may be distributed into the enclosed or bounded aqueous environment, with some embodiments of the compound potentially dissolving and/or distributing into the water while other compounds may remain in a solid and/or granular state. If desired, the modification compound may include buoyancy features which desirably maintain some or all of the compound within the enclosure and/or at a desired level within the water column (i.e., at the surface and/or at a desired depth within the enclosure, such as at a position deeper than the submerged depth of the protected object), while other embodiments may allow the compound to exit from the bottom and/or sides of the enclosure and/or rest on the bottom of a harbor or other seafloor feature within and/or proximate to the enclosure. In still other embodiments, the modification compound may alter the density and/or salinity of the water or other liquids within the differentiated environment, which may reduce and/or eliminate the natural tendency for liquids within and/or outside of the differentiated environment to mix together and/or otherwise flow.

In at least one alternative embodiment, a modification compound or compounds may be released into the external, non-enclosed waters adjacent or near the enclosure, which may flow into and/or through the enclosure, if desired. In still other embodiments, the modification compound and/or constituents thereof may be deployed in combination, with some components placed outside of the enclosed or differentiated environment, which other components could be placed within the enclosed or differentiated environment.

In some embodiments, the modification compound may be attached to and/or integrated into the walls of the enclosure and/or pockets formed therein, including within the material construction and/or any coatings therein/thereon. If desired, the compound could include a water and/or salt-activated and/or ablative material which reacts with the aqueous medium, having a limited duration such as 10 minutes, 1 hour, 12 hours and/or 2 days for which the compound affects the dissolved oxygen level and/or other water chemistry level(s) within the enclosure, or could be effective for longer periods of time such as 1 week or 1 month or 1 year. If desired, the modification compound or other material could be positioned within replaceable bags that can be positioned within and/or outside of the enclosure, with the material in the bags “depleting” over time and potentially requiring replacement as needed.

In one exemplary embodiment, the modification compound could comprise a crystalline material that absorbs oxygen from the aqueous environment within the enclosure, such as a crystalline salt of cationic multi-metallic cobalt complexes (described in “Oxygen chemisorption/desorption in a reversible single-crystal-to-single-crystal transformation,” published in CHEMICAL SCIENCE, the Royal Society for Chemistry, 2014). This material has the capability of absorbing dissolved oxygen (O₂) from air and/or water, and releasing the absorbed oxygen when heated (i.e., such as being left out in ambient sunlight) and/or when subjected to low oxygen pressures. If desired, this oxygen absorptive material could be incorporated into the wall material of the enclosure such that oxygen is immediately absorbed when the enclosure is placed within the water in proximity to the protected substrate, but such oxygen absorption would taper off after a period of time after placement. Subsequently, the enclosure walls could be removed from the water (such as after protection is no longer desired), and the enclosure walls left in the sunlight to release the absorbed oxygen and “recharge” for the next use.

In another exemplary embodiment, the modification compound could comprise a gas or gaseous compound such as nitrogen or carbon dioxide (or some other gas or compound) that could be introduced into the enclosure in gaseous form or which could be released from a pellet or other liquid or solid compound (including potentially the “dry ice” form of CO2) after introduction into the enclosure. Such introduction or “sparging” could comprise injection of nitrogen and/or N2 bubbles into the water inside the enclosure, or within/along the walls of the enclosure. Injection may be accomplished at the surface of the enclosure and/or at any depth within the water column. Desirably, such injection will not induce significant convective currents within the enclosure to bring significant amounts of outside water and/or dissolved oxygen into the system. In some embodiments an enclosure such as described herein can be combined with an installed nitrogen dosing system and monitoring probe for oxygen levels that controls the periodic renewal of the nitrogen flush when needed. In various embodiments, nitrogen injection may be accomplished using a small nitrogen tank with a porous weighted dispenser (i.e., an aquarium aeration stone) while other embodiments may utilize an on-site nitrogen generator to purify nitrogen from the air, and then dispense this nitrogen through a pumping system. If desired, the nitrogen dispensing system could include a bubble dispensing system that releases bubbles of a single range of sizes or of varying size ranges, if desired. In at least one embodiment, a nitrogen nanobubble infusing system may be utilized.

In at least one alternative embodiment, a gaseous compound injection suitable for use in the various systems described herein could comprise an ozone injection system such as the Ozonix® system, commercially available from Ecosphere Technologies, Inc. of Stuart Fla., USA.

In various embodiments, the modification compounds described herein will desirably induce a reduction in the dissolved oxygen levels of the enclosed or bounded aqueous environment (i.e., within the enclosure as compared to dissolved oxygen levels outside of the enclosure) within/after a few seconds or application and/or within/after a few minutes of application (i.e., 1 minute to 5 minutes to 10 minutes to 20 minutes to 40 minutes to 60 minutes of applied nitrogen bubbling) and/or within/after a few hours of application by at least 10%, by at least 15%, by at least 20%, by at least 25%, by at least 50%, by at least 70%, and/or by at least 90% or greater. In some instances, the environment within the enclosure may have already altered to some degree to a “differentiated” aqueous environment as described herein prior to addition of the modification compound (i.e., where the compound may simply alter, supplement, reverse, retard and/or accelerate some of the various chemical changes that may be already in progress), while in other embodiments the environment within the enclosure may possess similar chemistry to the surrounding open aqueous environment prior to addition of the modification compound.

In various alternative embodiments, the modification compound could comprise a material or materials that alter one or more constituents of the water chemistry within the enclosure other than the dissolved oxygen levels, or the modification compound may comprise a material that alters one or more additional constituents of the water chemistry within the enclosure in combination with some level of modification of the dissolved oxygen levels within the enclosure. Such additional constituents of the water chemistry could include pH, total dissolved nitrogen, ammonium, nitrates, nitrites, orthophosphates, total dissolved phosphates, silica, salinity, temperature, turbidity, as well as others described in various locations herein. In another embodiment, a secondary preconditioning/dousing agent, chemical, powder, or similar may be used to precondition the waters.

In various embodiments, the amount and/or type of modification or “preconditioning” compound (or compound combinations) or “conditioning” or “continuous conditioning” or “post-conditioning” desirable for a given enclosure may be determined (1) based on the cross-sectional (i.e., lateral and/or vertical) size of the enclosure, (2) based on a volume of the aqueous medium contained within the enclosure, (3) based on the wetted surface area and/or depth of the protected object, (4) based on the chemical and/or environmental characteristics of the aqueous environment within and/or outside of the enclosure (5) based on the size of opening(s) and/or depth of the water outside of the enclosure, (6) based on the amount of water exchange between the enclosed or bounded environment and the surrounding aqueous environment, and/or (7) various combinations thereof.

In various embodiments, the employment of an oxygen “scavenger” and/or modifier and/or increaser and/or absorber and/or or “displacer” or similar physical, chemical and/or biologic process (which may affect dissolved oxygen or alternatively some other element and/or compound within the enclosed or bounded environment) as an initial means of altering the water chemistry within the enclosure at or directly before/after the time of enclosure placement and/or substrate placement may be desirous to reduce and/or eliminate biofouling which may occur within the enclosure when dissolved oxygen or other water chemistry levels are at undesirable levels, including during initial enclosure deployment, in situations where the initial enclosure deployment may have been sub-optimal (i.e., due to human error), where the enclosure has been intentionally “breached” by opening or closing the enclosure or portions thereof, where the enclosure has been damaged in some manner during use, and/or where the natural environmental conditions may be particularly amenable to the occurrence of biofouling (i.e., where water movement increases the water exchange rate between the differentiated and external environments to undesirable levels and/or during periods of particularly heavy biofouling occurrence such as during daylight hours in spring or summer or “heavy biofouling season”). Desirably, the scavenger can quickly reduce the dissolved oxygen levels or create other targeted water parameters within the enclosure so as to initiate the inhibition and/or reduction in biofouling caused by the enclosure for a limited period of time, allowing for the enclosure to be correctly deployed and/or repaired at a later period of time and/or to allow the artificial conditions within the enclosure to stabilize to desired levels due to slower natural processes. In various embodiments, such employment may alternatively be undertaken a significant amount of time after the enclosure has been placed, if desired, to “refresh” or otherwise alter water conditions to a desired degree and/or for a limited period of time, after the enclosure has been opened for a period of time (such as to allow an object to enter or leave the enclosure) and/or to allow for repair and/or replacement of enclosure components when necessary and/or desired. In contrast to oxygen reduction actions, in some embodiments the dispersion of an oxygen source or other modification compound (i.e., direct injection of gaseous oxygen and/or introduction of a chemical which may release oxygen directly or through some chemical reaction), or some other oxygen addition activity (i.e., manually agitating a water surface of the enclosure) might be useful in some embodiments to transiently increase the dissolved oxygen level in an enclosure experiencing undesirable anoxic conditions.

In various embodiments, the modification compound may affect other water chemistry features in a desired manner, which may include effects which are directly induced by the modification compound as well as effects which may “cascade” from initial effects caused by the modification compound. In some cases, other water chemistry may be minimally affected and/or “untouched” in comparison to those of the surrounding open aqueous environment. Some exemplary water chemistry features that could potentially be “different” and/or which might remain the same (i.e., depending upon the type and amount of the modification compound, the dosage method and/or the frequency of dosing, as well as various aspects of the enclosure design and/or other environmental factors such as location and/or season) can include dissolved oxygen, pH, total dissolved nitrogen, ammonium, nitrates, nitrites, orthophosphates, total dissolved phosphates, silica, salinity, temperature, turbidity, etc. For example, an oxygen scavenger, absorber and/or displacer could potentially affect other water chemistry characteristics that may directly affect or be used to target or modify other conditions (and/or including the extension of biofouling effects long after the oxygen scavenger has been depleted and/or utilized).

In still more alternative embodiments, the modification compound may include substances that alter various water chemistry features in a variety of ways, including substances that may increase and/or decrease one of more of the water chemistry levels described herein. For example, where an enclosure may experience some fouling or other incident that potentially reduces the permeability and/or water exchange rate below a desired threshold level, it may be desirous to supplement the dissolved oxygen levels within the enclosure to some degree (i.e., to avoid anoxic conditions), which may include the addition of chemicals and/or compounds that release some level of dissolved oxygen into the differentiated environment. Alternatively, a physical mixing apparatus and/or other aeration source might be utilized to directly increase the dissolved oxygen level within the water of the enclosure for a desired period of time.

In some cases, it may be desirous to construct an enclosure that supplies significantly less than a single day or even a few hours of water usage, especially where design constraints may be limited by the amount of available real estate, environmental concerns and/or other concurrent uses of the aqueous medium. In such cases, it may be desirous to provide a continuous and/or periodic water conditioning treatment, such as previously described, which may artificially induce and/or accelerate the various water chemistry factors described herein. In such a case, the water chemistry within the enclosure may be monitored on a periodic and/or continuous basis, with one or more water conditioning treatments being applied to the water within the enclosure on an as-needed basis. For example, it can be possible to determine a desired minimum enclosure size by comparing an amount of anticipated needs in a day or so and the required “dwell time” to allow the water chemistry to reach a desired and/or acceptable level. But where the minimum enclosure size cannot be attained, or where the water chemistry changes require an excessive amount of time to attain, it may be desirous to condition the water on an as-needed basis, which may include periodic “refresher” treatments as the water within the enclosure is drained and replaced. Moreover, where the use of a large enclosure is not desired, the various water conditioning treatments described herein may be utilized in smaller enclosures and/or even within the suction piping of the facility on a continuous basis, if desired. In such a case, the various water conditioning treatments described herein could be used to condition the water continuously (such as in a water plant) with Nitrogen or other gases and/or chemicals. Such treatments may be particularly useful where there is not enough dwell time within a given enclosure to accomplish batch processing, or where a closed loop processing technique to continuously treat water may be desirous (i.e., with a closed testing and treatment loop to determine and/or maintain a desired water chemistry level (oxygen level, etc.) within certain ranges. In various embodiments, the various enclosures and/or water conditioning treatments described herein may be utilized separately and/or together on an as-needed basis, which could include the sole use of the enclosure during low water demand periods, and the use of both techniques concurrently during periods of higher water demand, if desired. In a similar manner, the water conditioning treatments described herein may be utilized alone during low water demand periods, with the use of both water conditioning with a concurrent enclosure during periods of higher water demand. It should also be understood that different environmental conditions may necessitate different treatments for the aqueous medium, including seasonal and/or other differences in temperature, sunlight, salinity, high/low water levels, high/low fouling season, etc.).

If desired, a modification compound or compounds may be released into one or more of the enclosures, or could alternatively be released and/or placed in the external, non-enclosed waters adjacent or near one or more of the enclosures.

In some instances, such as during periods of relatively higher water flow and/or greater water exchange %, it may be desirous to utilize a preconditioning material to augment, supplement and/or replace the various enclosure features and/or anti-fouling protective mechanisms described herein. For example, where increased water flow and/or increased water exchange may alter the differentiated environment within the enclosure to a degree to permit significant fouling to occur, it may be desirous to dispense or apply a preconditioning material into and/or adjacent to the enclosure to alter the water chemistry to reduce fouling during the increased flow period. Depending upon the duration and/or extent of such flow occurrence(s), multiple applications of preconditioning material may be desired, with such application suspended once water flow and/or the differentiated environment have returned to their desired more-normal conditions.

Fouling Weight/Mass Control

In various embodiments, it may be desirous for an enclosure to reduce, minimize and/or prevent certain types and/or species or fouling organisms from attaching to the enclosure and/or protected substrate. For example, it may be desirous to prevent bivalves or other “heavier” fouling organisms (i.e., those having high fouling biomass and/or causing significant drag) from attaching to an enclosure, while fouling by “lighter” organisms such as bacterial colonies, neutrally buoyant organisms and/or “slimes” may be acceptable and/or desirous. In such a case, the enclosure, any optional biocide and/or other enclosure elements may be selected and/or designed to reduce, minimize and/or prevent colonization by one or more specific types of such unwanted organisms.

Enclosure Assembly

In various embodiments, an enclosure may be constructed in a single piece or may comprise multiple modular pieces that can be assembled in a variety of enclosure shapes. For example, an enclosure design can desirably comprise a plurality of wall structures, with each wall structure attached and/or assembled to one or more adjacent wall structures (if any) by stitching, weaving, hook and loop fasteners, Velcro, and/or the like, which may include the coating and/or encapsulation of any seams and/or stitched/adhered areas. Various stitching techniques may be used to construct various enclosures of the present invention, including where the threads and/or related irregular surfaces of the seam or overlapping fabric folds are desirably not exposed to the outer environment, and thus desirably do not provide an externally facing surface amenable to biofouling of the enclosure (although a slight crevice formed along the outer surface of the enclosure may not be optimal, but might be acceptable in various embodiments). Alternatively, other connecting techniques such as heat bonding, ultrasonic welding and/or other energy-based bonding techniques, gluing or adhesives, as well as other stitching and/or two-dimensional weaving/knitting techniques, may be utilized as desired. In other alternative embodiments, three-dimensional fabric forming techniques may be used to create a “tube” or bag of material for the enclosure which has no external facing seams on the sides and/or which only has one or more seams and/or openings at the top and/or bottom. In some particularly desirable embodiments, the attachment and/or adhering of various wall section of the enclosure will preferably be accomplished such that some level of flexibility in the attachment region is maintained.

In a similar manner, various embodiments of the enclosure will desirably incorporate permeable and/or flexible attachment mechanisms and/or closures, such that relatively hard, unbroken and/or impermeable surfaces will desirably not be presented externally to the surrounding aqueous environment by the enclosure. In many cases, biofouling entities may prefer a hard, unbroken surface for settlement and/or colonization, which can provide such entities a “foothold” for subsequent colonization on adjacent flexible fabric sections such as those of the enclosures described herein. By reducing the potential for such “foothold” locations, many of the disclosed enclosure designs can significantly improve the biofouling resistance of various of the disclosed embodiments and/or the substrate protection provided thereof. In at least one embodiment, an enclosure can be particularized for a substrate that is made as a single construction with no seams and/or no impermeable wall sections.

In the case of hook and loop or “Velcro” fasteners, the employment of such connecting devices may be particularly well suited for various enclosure embodiments, in that such fasteners can be permeable to the aqueous medium in a manner similar to the permeable enclosure walls. Such design features may allow liquid within the enclosure to elute through the fastener components and/or enclosure walls in a similar manner, thereby inhibiting fouling of the fastener surfaces as described herein. Alternatively, the connective “flap” of a flexible hook and loop fastener may be placed over a corresponding flexible or non-flexible attachment surface to provide additional protection to the attachment surface.

In various embodiments, the enclosure can incorporate one or more features that desirably reduce, mitigate, inhibit and/or prevent the effects of hydrostatic pressure from damaging the enclosure, various enclosure components, the protected substrate and/or any connected objects and/or anchoring systems. For example, much of the enclosure may desirably comprise a flexible fabric material, which desirably can mitigate, reduce and/or eliminate many of the effects of external water movement (i.e., currents, wave and/or tidal action) on the enclosure and/or components thereof (as compared to an inflexible, solid enclosure or enclosure wall). In a similar manner, the presence of perforations and/or the permeability of the enclosure walls desirably reduces and/or mitigates hydrostatic forces acting on various portions of the enclosure and/or support structures thereof, in that at least a portion of any hydrostatic effect will desirably “pass through” the enclosure (typically resulting in a desired level of fluid exchange between the enclosure and the surrounding aqueous environment) and other portions of the enclosure will flex, bend and/or “flap” in the moving water. Moreover, the employment of flexible, pliable cloth fabrics and/or other materials throughout much of the enclosure desirably reduces the potential for work hardening and/or fatigue failure of various enclosure components, increasing the durability and functional life of the enclosure. Accordingly, at least one exemplary embodiment of an enclosure can included one or more wall components (or the entirety of the enclosure design) that can move and/or flex with tidal, current and/or wave movement in the vicinity of the enclosure.

In various embodiments, fabric permeability may be affected and/or altered by a variety of techniques, including mechanical processing, such as by the use of piercing devices (i.e., needles, laser cutting, stretching to create micropores, etc.), abrading materials and/or the effects of pressure and/or vacuum (i.e., water and/or air jets), or chemical means (i.e., etching chemistry). In a similar manner, a low permeability fabric could be treated to desirably increase permeability of the fabric to within a desired range, while in other embodiments a higher permeability fabric could be modified (by using a paint, coating, clogging or clotting agent, for example) to lower permeability a desired amount.

In many embodiments, the type and/or level of permeability of a selected enclosure wall material or materials will be a significant consideration in the design and placement of the enclosure and/or various enclosure components. At the time of initial placement of the enclosure in the aqueous medium, the permeable material will desirably allow sufficient water exchange to occur between the open environment and the enclosed and/or bounded environment to allow the differentiated environment which protects against biofouling to form. However, because various fouling pressures and/or other factors can potentially alter and/or otherwise affect the permeability and/or porousness of a given enclosure wall material over time in the aqueous medium, it is often important that the permeable material continues to allow a desired level of water exchange that maintains the differentiated environment—and which also desirably avoids long term anoxia from occurring within some enclosure embodiments. In accordance with these concerns, it may be desirable to select a higher level of permeability for an enclosure wall material, such that clogging and/or closure of some of the pores in the material should not significantly affect the anti-fouling performance of the enclosure, even though the rate of water exchange may decrease, increase and/or remain the same at different time during the useful life of the enclosure.

Enclosure Placement and Spacing

In use, an enclosure embodiment will desirably be applied around a substrate prior to immersion of the substrate in the aqueous medium. This could include the protection of an object before the object is initially immersed in the aqueous medium for the first time (i.e., an object's “virgin” immersion into the aqueous environment), as well as the protection of a previously immersed object that was removed from the aqueous medium and cleaned and/or descaled, with the enclosure applied to the object prior to subsequent immersion. In other embodiments, the enclosure may be applied to an object already immersed in the aqueous environment, including objects that may have been previously immersed for extended periods of time and/or already having significant amounts of biofouling thereupon. Once the enclosure is applied to the object, the enclosure can be secured in some manner around one or more exposed surfaces of the substrate, thereby partially and/or fully isolating the aqueous environment within the enclosure from the surrounding aqueous environment to varying degrees. It should also be understood that in various embodiments the enclosure may not “fully” enclose the substrate, such as where the enclosure may have relatively large gaps and/or openings therethrough. In such cases, the enclosure may still be sufficiently “closed” enough to create the desired environmental changes within the enclosure that reduce and/or prevent biofouling of the substrate and/or portions of the substrate as described herein.

Non-limiting examples of substrates include, but are not limited to, the surfaces of sport, commercial and military vessels, ships, vessels, and marine vehicles, such as, jet-skis; civilian boats, ships, vessels, and marine vehicles, such as, jet-skis; propulsion systems of boats, ships, vessels, and marine vehicles; drive systems of boats, ships, vessels, and marine vehicles and components thereof, such as stern drives, inboard drives, pod drives, jet drives, outboard drives, propellers, impellers, drive shafts, stern and bow thrusters, brackets, rudders, bearings; and housings; thrusters of boats, ships, vessels, and marine vehicles, such as, bow thrusters and stern thrusters; inlets of boats, ships, vessels, and marine vehicles, such as, cooling water inlets, HVAC water inlets, and propulsion system inlets; marina operations support equipment, such as, docks, slips, pilings, piers, rafts, floating paint platforms, floating scaffolding platforms, and floating winch and towing equipment platforms; binding and retention equipment, such as, anchors, ropes, chains, metal cables, mooring fixtures, synthetic fiber cables, and natural fiber cables; marine instrumentation, such as, pH measurement instruments, dissolved oxygen measurement instruments, salinity measurement instruments, temperature measurement instruments, seismic measurement instruments, and motion sensor instruments and associated arrays; mooring equipment, such as, anchor chains, anchor cables, attachment chains, attachment cables, mooring chains, mooring cables, fittings, floats, bollards, and associated attachments; buoys, such as, marker buoys, channel marker buoys, inlet marker buoys, diver buoys, and water depth indicator buoys; marine pilings, such as, wooden pilings, metal pilings, concrete dock pilings, wharf pilings, pier pilings, pilings for channel markers, and pilings for subsurface structures; marine subsurface structures, such as, seawalls, oil and gas rig exploration and production structures, municipal-use structures, commercial-use structures, and military-use structures; industrial filtration system equipment, such as, marine filtration systems, membrane filters, water inlet filters, piping and/or storage tanks; marine lifts and boat storage structures; irrigation water storage tanks and irrigation piping and/or equipment; and/or any portions thereof, including water management systems and/or system components, such as locks, dams, valves, flood gates and seawalls. Other mechanisms impacted by biofouling that may be addressed using the present disclosure include microelectrochemical drug delivery devices, papermaking and pulp industry machines, underwater instruments, fire protection system piping, and sprinkler system nozzles. Besides interfering with mechanisms, biofouling also occurs on the surfaces of living marine organisms, when it is known as epibiosis. Biofouling is also found in almost all circumstances where water-based liquids are in contact with other materials. Industrially important impacts are on the maintenance of mariculture, membrane systems (e.g., membrane bioreactors and reverse osmosis spiral wound membranes) and cooling water cycles of large industrial equipment and power stations. Biofouling can also occur in oil pipelines carrying oils with entrained water, especially those carrying used oils, cutting oils, oils rendered water-soluble through emulsification, and hydraulic oils.

In various embodiments, the substrate(s) to be protected may be a surface or subsurface portion made of any material, including but not limited to metal surfaces, fiberglass surfaces, PVC surfaces, plastic surfaces, rubber surfaces, wood surfaces, concrete surfaces, glass surfaces, ceramic surfaces, natural fabric surfaces, synthetic fabric surfaces and/or any combinations thereof.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

All references, including publications, patent applications and patents, cited herein are hereby incorporated by reference to the same extent as if each reference were individually and specifically indicated to be incorporated by reference and were set forth in its entirety herein.

The various headings and titles used herein are for the convenience of the reader and should not be construed to limit or constrain any of the features or disclosures thereunder to a specific embodiment or embodiments. It should be understood that various exemplary embodiments could incorporate numerous combinations of the various advantages and/or features described, all manner of combinations of which are contemplated and expressly incorporated hereunder.

The use of the terms “a” and “an” and “the” and similar referents in the context of describing the invention are to be construed to cover both the singular and the plural, unless otherwise indicated herein or dearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., i.e., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover any combination of the above-described elements in all possible variations thereof is encompassed by the invention unless otherwise indicated herein or otherwise clearly contradicted by context.

What is claimed is:

1. A device for reducing biofouling on a substrate at least partially submerged in an aqueous environment, the device comprising:
a structure comprising at least one vertically extending flexible sheet layer which is or becomes water permeable during use, said at least one vertically extending flexible sheet layer substantially surrounding at least a portion of a periphery of the substrate in the aqueous environment, the at least one vertically extending flexible sheet layer having an upper end at or near a surface of the aqueous environment and a lower end which extends downward into the aqueous environment to a first depth;
the structure defining a bottom which is at least partially open to the aqueous environment;
wherein said structure separates the aqueous environment into a local aqueous environment and an open aqueous environment, wherein the local aqueous environment extends from a surface of the substrate to at least an inner surface of the at least one vertically extending flexible sheet layer,
wherein said structure provides an average water exchange of about 0.1% to 500% of a volume of water each hour between the local aqueous environment and the open aqueous environment.

2. The device of claim 1, wherein a lowest point of the substrate extends a second depth into the aqueous environment, and the first depth is greater than the second depth.

3. The device of claim 1, wherein the substrate extends into the aqueous environment to a second depth, and the first depth is less than or equals the second depth.

4. The device of claim 1, wherein the at least one vertically extending flexible sheet layer comprises a water permeable fabric.

5. The device of claim 1, wherein the at least one vertically extending flexible sheet layer comprises a 3-dimensional flexible material selected from the group consisting of natural and synthetic fabrics, natural and synthetic membranes, natural and synthetic sheets, and fabrics, membranes, films and sheets made from a combination of natural and synthetic materials.

6. The device of claim 1, wherein the structure maintains a dissolved oxygen content of a liquid within the local aqueous environment of at least an average of 10% or greater.

7. The device of claim 1, wherein water chemistry within said local aqueous environment is different than water chemistry within said open aqueous environment.

8. The device of claim 1, wherein a ratio of a surface area of said structure to a volume of water within said local aqueous environment is about 0.4 feet-1 to about 800 feet-1 upon positioning the structure about the substrate.

9. The device of claim 1, wherein said at least one vertically extending flexible sheet layer comprises biocide.

10. The device of claim 1, wherein the structure defines a top which is at least partially open.

11. The device of claim 1 further comprising an aqueous flow mechanism that is positioned within the local aqueous environment, wherein the aqueous flow mechanism is configured to at least one of disturb the local aqueous environment or add or remove liquid, compounds, or other materials to or from the local aqueous environment.

12. The device of claim 1 further comprising a modification compound that is positioned within the local aqueous environment, wherein the modification compound is configured to condition the local aqueous environment by applying a change in water chemistry of the local aqueous environment.

13. A device for reducing biofouling on a substrate at least partially submerged in an aqueous environment, the device comprising:
a structure comprising a plurality of vertically extending flexible sheets, the plurality of vertically extending flexible sheets surrounding a periphery of the substrate in the aqueous environment, each of the plurality of vertically extending flexible sheets having an upper end at or near a surface of the aqueous environment and a lower end which extends downward into the aqueous environment;
wherein the structure is open to the aqueous environment at a bottom end of the structure;
wherein a surface area of the structure is at least equal to or greater than a surface area of the substrate.

14. The device of claim 13, wherein the lower end of at least one of the plurality of vertically extending flexible sheets extends downward into the aqueous environment to a first depth, wherein a lowest point of the substrate extends a second depth into the aqueous environment, and the first depth is greater than the second depth.

15. The device of claim 13, wherein the lower end of at least one of the plurality of vertically extending flexible sheets extends downward into the aqueous environment to a first depth, wherein the substrate extends into the aqueous environment to a second depth, and the first depth is less than or equals the second depth.

16. The device of claim 13, wherein each of the plurality of vertically extending flexible sheets comprise a 3-dimensional flexible material selected from the group consisting of natural and synthetic fabrics, natural and synthetic membranes, natural and synthetic sheets, and fabrics, membranes, films and sheets made from a combination of natural and synthetic materials.

17. A device for reducing biofouling on a substrate at least partially submerged in an aqueous environment, the device comprising:
a structure comprising at least one vertically extending flexible sheet layer which is or becomes water permeable during use, said at least one vertically extending flexible sheet layer substantially surrounding at least a portion of a periphery of the substrate in the aqueous environment, the at least one vertically extending flexible sheet layer having an upper end at or near a surface of the aqueous environment and a lower end which extends downward into the aqueous environment to a first depth,
the structure defining a bottom which is at least partially open to the aqueous environment,
wherein the at least one vertically extending flexible sheet layer comprises a 3-dimensional flexible material selected from the group consisting of natural and synthetic fabrics, natural and synthetic membranes, natural and synthetic sheets, and fabrics, membranes, films and sheets made from a combination of natural and synthetic materials.

18. The device of claim 17, wherein the structure is configured to attach to a floatable device to extend downwardly into the aqueous environment.

19. The device of claim 18 further comprising one or more connection features configured to attach to the floatable device, wherein the structure is connected to the one or more connection features so as to extend downwardly into the aqueous environment below the floatable device.

20. The device of claim 19, wherein the structure forms a skirt for the floatable device.

21. The device of claim 17, wherein the structure is configured to attach to and surround a floatable device to reduce biofouling on the floatable device.

22. The device of claim 17, wherein the structure is fluid permeable and comprises at least one of mesh, lattice, fenestration, or holes that enable fluid flow therethrough, wherein the structure is flexible and defines a first side and a second side,
wherein, when the structure at least partially surrounds the substrate in the aqueous environment such that the first side of the structure faces the substrate, the structure enables fluid exchange through the structure to the substrate while preventing or limiting biofouling on the substrate such that a first chemistry of the aqueous environment on the first side of the structure is different than a second chemistry of the aqueous environment on the second side of the structure.

23. The device of claim 22, wherein, when the structure at least partially surrounds the substrate in the aqueous environment, the structure modulates dissolved oxygen content between the second side and the first side.

24. The device of claim 17, wherein the structure further comprises at least one removeable vertically extending flexible sheet layer, wherein the at least one removeable vertically extending flexible sheet layer is configured to collect biofouling thereon and is positioned proximate to an outer surface of the at least one vertically extending flexible sheet layer, wherein the at least one removeable vertically extending flexible sheet layer and biofouling thereon can be removed from the structure to leave the at least one vertically extending flexible sheet layer substantially surrounding the portion of the periphery of the substrate in the aqueous environment.

25. The device of claim 17, wherein the at least one vertically extending flexible sheet layer comprises biocide.
